(19) United States
(12) Patent Application Publication
(10) Pub. No.: US 2014/0032427 A1
(43) Pub. Date: Jan. 30, 2014

(54) Invoice and Freight Statement Matching and Dispute Resolution

(71) Applicant: Inttra Inc., Parsippany, NJ (US)

(72) Inventor: Tim GANNON, Parsippany, NJ (US)

(73) Assignee: Inttra Inc., Parsippany, NJ (US)

(21) Appl. No.: 13/896,315

(22) Filed: May 16, 2013

Related U.S. Application Data
(60) Provisional application No. 61/647,790, filed on May 16, 2012.

(51) Int. Cl. G06Q 50/18; G06Q 10/08

(52) U.S. Cl. CPC G06Q 50/182; G06Q 10/083
USPC 705/309

(57) ABSTRACT

A system and method for receiving, validating, and managing disputes for freight shipments is disclosed.

### RELATIONSHIP TO OTHER APPLICATIONS

This application claims priority to U.S. Provisional Application No. 61/647,790, filed May 16, 2012, whose contents are expressly incorporated herein by reference.

### TECHNICAL FIELD

The features described herein generally relate to electronic data processing systems, in particular to an automated data processing system for shipping.

### BACKGROUND

Today, shipping goods is a complicated business. Carriers have a finite amount of cargo space, and accordingly, shippers often negotiate with multiple carriers to coordinate the movement of just one container. Typically to limit the uncertainty and cost of moving goods, shippers contract with multiple carriers to provide a predetermined volume of business to each carrier at an agreed upon rate. This gives shippers the flexibility to choose from a number of different carriers to transport goods between different ports and increases the likelihood of moving a container when the shipper needs the container moved while guaranteeing individual carriers a volume of business. In practice, a shipper sequentially contacts carriers to check availability. For example, refrigeration may be required for a number of containers. Certain carriers may not have the cargo space available to move the refrigerated goods by a given day. Accordingly, even if the shipper and carriers have executed a contract prior to negotiations to move goods, shippers are still effectively required to negotiate with multiple carriers when securing the transport of cargo.

Since shippers typically contract with multiple carriers, the shipper is required to learn and understand a variety of different carrier idiosyncrasies. The differences between carriers are compounded as each carrier attempts automation and/or direct booking over the internet. Each carrier booking system (or platform) may be different in the look and feel as well as in the process that one requests the transport of goods. This forces each shipper to learn each carrier's platform to effectively and efficiently book a shipment of goods. The entire process is both confusing and time consuming for shippers. Carriers are then faced with incorrect or irreconcilable booking reports leading to more lost resources.

Freight forwarders add yet another level to this complicated business. Freight forwarders generally coordinate the transportation of goods on behalf of the shippers. For example, if the shipper desires goods be shipped from Chicago to Tokyo, the freight forwarder, on behalf of the shipper, negotiates and/or coordinates with the carriers to arrange for the goods to be moved.

Since shippers or freight forwarders typically move goods using a variety of carriers, tracking and tracing goods across different carriers is also costly. Because shippers or freight forwarders often coordinate transportation of goods with multiple carriers, they are required to learn how to track and trace goods according the specific carrier's platform. Since shippers may have hundreds of containers being shipped by many different carriers at any given time and want to know the status and related info for their shipments, both shippers and carriers devote large amounts of resources to tracking and tracing containers. It is not uncommon for carriers to devote an entire workgroup to handling phone calls from shippers requiring information on the location of their goods.

In recent years developers have used the internet to create virtual marketplaces that bring together buyer and sellers, run negotiations and give companies and their suppliers the ability to readily share information. Some attempts have been made to reduce the cost to the shipper by using the internet. One attempt was to give carriers the ability to post published rates and discount information for land, sea and air bearing cargo vessels allowing customers to evaluate prices prior to booking. Another attempt to use the internet, give shippers the ability to receive a plurality of bids from a plurality of participating cargo transportation entities. These systems merely identify the cost of doing business with a select carrier and no more. This does not solve the problem of having to use multiple carrier platforms to submit the booking request to different carriers. This also does not permit easy exchange of goods between carriers where multiple carriers are used for a single shipment.

Finally, warehousing goods, transporting goods, customs brokerage and trade finance are complicated pieces of a very complicated business. Accordingly, a need exists for a more efficient system for handling logistics and transportation of goods.

Accounts Payable (A/P) is a process employed by virtually every business in America. In its simplest form, A/P is the creation and distribution of a payment to settle an obligation (typically represented by an invoice) and the associated accounting entries to recognize the expense. While in small businesses A/P might be handled by an accountant or bookkeeper with ledgers or spreadsheets, A/P in larger businesses has evolved into a highly specialized application involving Enterprise Resource Planning (ERP) systems that link together previously disparate systems like Purchasing, Inventory, General Ledger (G/L), and Accounts Payable into a single, integrated system.

Using a manufacturing company as an example, Purchasing acquires the materials necessary to maintain targeted inventory levels in support the manufacturing process. To document the purchase, establish the exact nature of the items desired and their respective quantities, set prices, etc., a Purchase Order (P.O.) is created by the Buyer and is sent to the Seller either electronically or on paper. The Seller fills the order, completely or partially (in accordance with the requirements of the P.O.) and delivers the material(s) to the Buyer's designated location. Once received by the Buyer, the material is recorded in an inventory control system. The Seller, meanwhile, prepares and delivers to the Buyer an invoice that represents the amount due and payable in exchange for the materials provided. The Accounts Payable department of the Buyer compares the invoice to the original P.O. to ensure the purchase was properly authorized and to confirm that the terms on the invoice are consistent with those documented in the P.O. The A/P department also confirms through the inventory control process that the materials represented by the invoice have been received in a satisfactory condition.

### SUMMARY

This summary is not intended to identify critical or essential features of the inventions claimed herein, but instead merely summarizes certain features and variations thereof.

One or more aspects of the disclosure relate to enhanced automated matching systems that assist in matching of vendors' invoices against previous estimates from those vendors is provided to clients. In a first aspect, the automated matching system permits collapsing of multiple line items into one or two groups of fees to assist in matching estimated and actual charges. In a second aspect, the automated matching system permits execution of business rules based on intricacies of the various vendors and clients.

In one aspect, there is provided a method of a dispute resolution processing using electronic data exchange, comprising: linking an electronic invoice to an electronic freight statement; comparing the invoice to the freight statement; determining a dispute of the values associated with the invoice to the values associated with the freight statement; transmitting an EDI dispute message; and receiving an EDI dispute response message.

The various features described above may be implemented using a computer or processing device, which may operate by executing computer-executable instructions for performing the various features described. Accordingly, some embodiments herein include the computer-readable media storing those instructions. Other details and features will also be described in the sections that follow.

### BRIEF DESCRIPTION OF THE DRAWINGS

Some features herein are illustrated by way of example, and not by way of limitation, in the figures of the accompanying drawings and in which like reference numerals refer to similar elements.

FIG. 1 shows a common carrier system through which shippers and carriers interact with each other.

FIG. 2 shows an illustrative hardware example of components at the common carrier system.

FIG. 3 shows an illustrative computing environment in which features described herein may be implemented.

FIG. 4 shows an illustrative operational relationship between carriers, an intermediary, and shippers and related entities.

FIG. 5 shows illustrative automatch operations with dispute resolution periods.

FIG. 6 shows the passing of invoices and statements between entities.

FIG. 7 shows handling of invoices and freight statements.

FIGS. 8-17 show illustrative examples of how the automatching system attempts to correlate invoices and freight statements.

FIG. 18 shows a state diagram for the automatching process.

FIG. 19 shows a state diagram for the handling of invoices in an invoice matching portal.

FIG. 20 shows a state diagram for payer invoice/credit note processing.

FIG. 21 shows a state diagram for the automatching process with linked credit notes.

FIG. 22 shows a state diagram for an invoice portal.

FIG. 23 shows a message state diagram for the automatch process for freight statements.

FIG. 24 shows a state diagram for the automatch process for freight statements.

FIG. 25 shows a state diagram for the automatch process for freight statement line transitions.

FIG. 26 shows a state diagram for dispute status state transitions.

FIG. 27 shows a process for initial processing of invoices and freight statements.

FIG. 28 shows a process for handling business rules and saving execution results.

FIG. 29 shows a process for receiving and processing invoices and other documents.

FIG. 30 shows a process for handling freight statements.

FIG. 31 shows a process for checking and presenting invoices on the invoice portal.

FIG. 32 shows a process for handling duplicate invoices.

FIG. 33 shows a process for handling disputes.

FIG. 34 shows an additional process for handling disputes.

FIG. 35 shows a process for matching invoices and freight statements.

FIG. 36 shows a process for managing dispute responses.

FIG. 37 shows a process for addressing remaining issues on invoices.

FIG. 38 shows another process for addressing remaining issues on invoices.

FIG. 39 shows another process for processing a freight statement.

FIG. 40 shows a process for matching an export freight statement.

FIG. 41 shows a process relating to processing of invoices and credit statements.

FIG. 42 shows another process relating to processing of invoices and credit statements.

FIG. 43 shows a process relating to automatching.

FIG. 44 shows a process relating to automatching invoices and freight statements.

### DETAILED DESCRIPTION

The automatch system attempts to match invoices and freight statements from carriers and freight forwarders/shippers, respectively, to reduce manual reviewing operations are formed by each entity's personnel. To permit electronic review of invoices, the automatch system may use electronic invoicing via predefined standards (including, for instance, the Electronic Data Interchange (EDI) formats developed by the United Nations (EDIFACT) and further adopted and enhanced by INTTRA Inc., of Parsippany, N.J.). Other known electronic invoicing standards may be used as well and are not described further. Further, image invoices may be OCRed (optical character recognition) to generate textual content for subsequent processing.

Through the automatch system, billers (carriers in the above example) benefit from timely invoice reviews and timely notification of detected discrepancies. Payers (freight forwarders in the above example), likewise, benefit from automated invoice review for a number of received invoices.

It is noted that various connections are set forth between elements in the following description. It is noted that these connections in general and, unless specified otherwise, may be direct or indirect and that this specification is not intended to be limiting in this respect.

To assist with understanding various aspects described here, the following description is organized as follows:

### I. Overview

A. Parties
B. Submission Interval and Dispute Resolution Interval

### II. Submission Interval

A. Parties Submissions
   a. Invoices and Credit Notes and
   b. Estimated Invoices
B. Linking Invoices and Credit Notes to Estimated Invoices
C. Collapsing Common Charge Items
   1. Resolving to Standard Charge Codes
   2. Collapsing Methods and Processes
   3. Collapsing Exceptions
   4. All-in-Charge Codes and Flat Fees
   5. Invoices/Credit Notes that contains only unexpected charges, or a mix of Unexpected Charges and Normal Charges.

### III. Dispute Resolution Interval

A. Validating/Matching Invoices
   1. Business Rules
      a) A Business Rule Driven Automatch
      b) Alpha and Numeric Comparison Rules
      c) Date & Time Comparison Rules
      d) List Values Comparison Rules
      e) Comparison Using Thresholds
      f) Handling Exchange Rate Comparisons
      g) Party-specific variations
   2. Automatching Invoice Header Items
      a) Matching by Header Fields
      b) Matching Special Header Fields
   3. Automatching Charge Line Items
      a) Matching by Charge Codes or Charge Codes and Other Information (e.g. container size type)
      b) Business Rules for Any Charge Codes
      c) Detecting Missing & Additional Charges
      d) Direction Checking of Export Invoice Charges
      e) Uncollapsible Charges
      f) Manual Processing Required Emails and EDIFACT Messages
B. Disputing Invoices and Resolving Disputes
   1. Generating Disputes and Discrepancies
      a) Raising Disputes and Holding Back Invoices
      b) Dispute Resolution Period and Check Time Intervals
      c) Responding to a Dispute
      d) Limiting Automatch Dispute Cycles
      e) Manual Disputes vs. Automatch
   2. Interpreting Results
      a) General Dispute Information
      b) Overall Dispute Details
      c) Discrepancy Details
      d) Header Item Invoice Discrepancies
      e) Charge Line Item Invoice Discrepancies
      f) Invoice Dispute Count
   3. Applying Full Linked Credit Notes

### IV. Other Considerations

A. Setting up Biller/Payer Companies
B. Enabling EDI Subscriptions
C. Subscribing to Email Notifications
D. Configuring Preferences and Business Rules Options
   1. Defining Header Rules
   2. Defining Charge Line Rules
      a) Business Rules for a Specific Charge
      b) Business Rules for All Charges
   3. Maintaining Business Rules

The following terms are used in the description.
a. Shipper—Any entity with goods to be transported. The entity may desire the goods be transported or may be transporting the goods for a different entity.
b. Carrier—Any entity that transports goods from an origin to a destination. The carrier may transport goods domestically and/or internationally. For example, a carrier may transport goods for a shipper from Chicago to Seattle or the same carrier may transport goods from Chicago to Paris. The carrier may transport goods using trucks, trains, planes, ships, and/or the like.
c. Carrier Platform—A carrier's computer system supporting an interface that enables exchange of information with the carrier.
d. Common Carrier System—Infrastructure that supports the common carrier interface including data storage through one or more hardware devices (including dynamic storage (e.g., hard disks, optical disks, and the like), static storage (e.g., solid state memories and the like), and other known storage mediums.
e. Common Carrier Interface—An interface that enables multiple shippers and multiple carriers to communicate.
f. User—Any entity that uses the common carrier system. All users may have various levels of interest in using the common carrier system. The main users of the common carrier system may be shippers, third-party logistics providers, freight forwarders, consignees, brokers, trading portals, carriers and the like.
g. AM—Automatch process
h. CN—Credit Note
i. COMDIS—Dispute and dispute response
j. EDI—Electronic data interchange
k. FS—Freight Statement
l. IFTFCC—Inbound invoice via edifact or credit note
m. IFTCCA—Freight statement via edifact
n. TCC—Transport charge/rate calculations
o. FLCN—Full linked credit note
p. PLCN—Partially linked credit note
q. LCN—Linked credit note

Aspects of the present invention may be described in the general context of computer-executable instructions, such as program modules, executed by one or more computers or other devices. A computer or processing device, which may operate by executing computer-executable instructions for performing the various features described. Accordingly, some embodiments herein include the computer-readable media storing those instructions. Generally, program modules include routines, programs, objects, components, and data structures that perform particular tasks or implement particular abstract data types. Typically the functionality of the program modules may be combined or distributed as desired in various embodiments.

### I. Overview

The following describes the various parties and timing intervals during which invoices are submitted, matched, and resolution of disputes addressed.

A. Parties

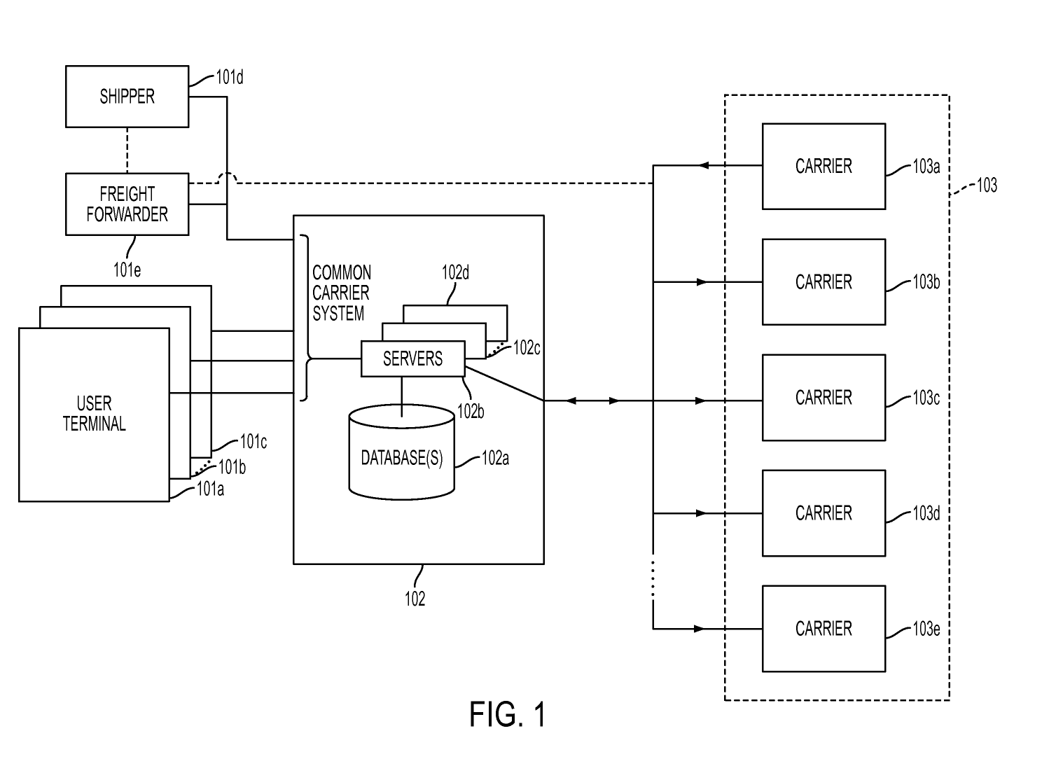

FIG. 1 illustrates an example of representative infrastructure according to one or more embodiments of the present invention. The user 101a-101e, via terminals, communicates with a plurality of different carriers 103 through the common carrier system 102 including server(s) 102b-102c and database(s) 102a. In one embodiment, users use terminals to exchange information with the common carrier system 102. These terminals may be standard personal computers as are known in the art. In alternative embodiments, the users may use hand-held or other portable devices as known in the art to communicate with the common carrier system 102. Further, the communications from multiple users may be batched together at a user's location prior to transmission to the common carrier system 102. Although FIG. 1 shows five users, five carrier terminals, one database and three servers, FIG. 1 is merely illustrative and the number of, users and/or user terminals, carriers and/or carrier terminal, servers and databases is not in any way limited. Furthermore, although various embodiments are described in the context of a single system, one of ordinary skill in the art may appreciate that the described functionality may be implemented across multiple systems. Moreover, a web site may be mirrored at additional systems in the network and, if desired, one or more management systems or other computer resources may be used to facilitate various functions. The computer program at the system includes appropriate screen routines for generating a set of screens that together comprise a user interface for the site.

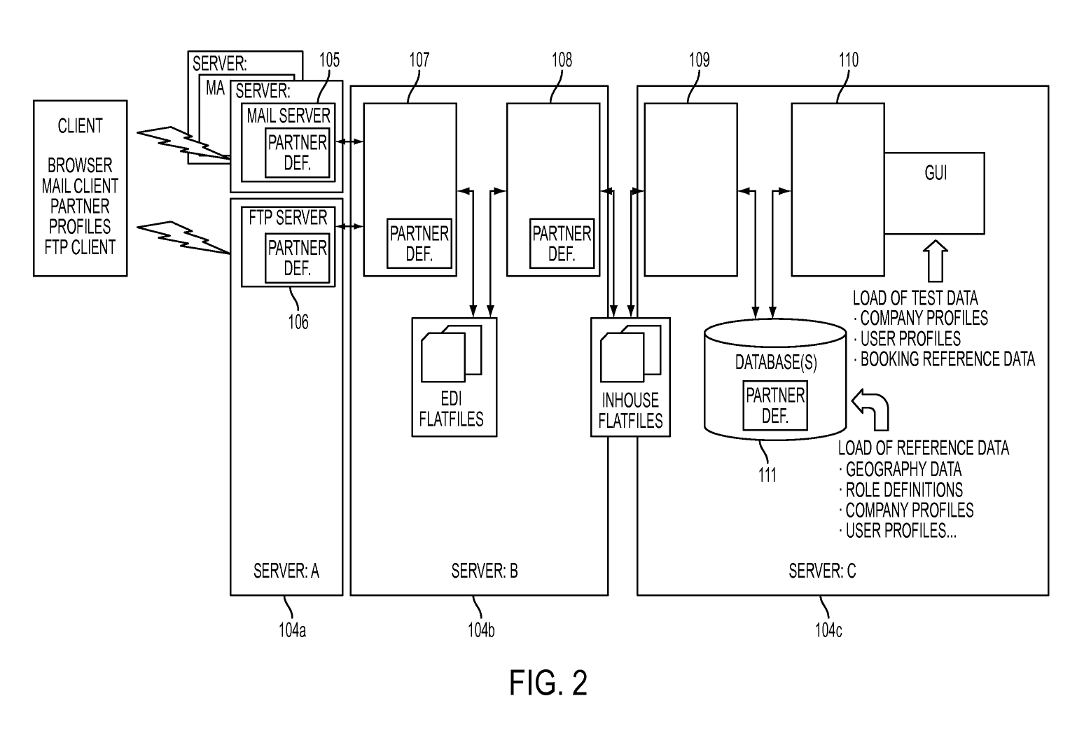

FIG. 2 illustrates, in more detail, the common carrier system 102. The common carrier system includes, for example and without limitation, servers 104a-104c. Server 104a includes mail server 105 which may be used to receive and send data via email. Server 104a also includes server 106 for receiving and sending data over the internet. Server 104b includes server 107 as a communication bridge between server 108 and servers 105 and 106. Server 107 polls servers 105 and 106 for new messages, unpacks and sends the messages to server 108. For outbound polls from server 107, server 108 adds the receiver's address and triggers the transfer of the message. When server 107 fails to process an EDI message, an email will be sent to a predefined email address.

Server 108 processes EDI messages by validating the data when called by server 107 and translating the data into the common carrier system for processing. For outbound EDI messages, server 108 is called by server 109 and server 109 feeds server 108 with the outbound EDI message in the common carrier system processing. Server 104b includes servers 109 and 110. Server 109 converts and loads common carrier system layout to a set of database tables, or vice versa. Server 109 also polls server 108 for any new messages, opens a connection to the database and populates the database tables corresponding to the EDI message type. For outbound EDI messages, server 109 scans the database tables populated by an EDI processor and converts the message and then triggers server 108 to process the common carrier layout format. Referring to Server 110, the EDI processor is part of the server 110 that processes the EDI messages deposited into the database tables by 109. Server 110 scans the header of the database table for the first unprocessed message being marked for example as submitted. The status is then change from submitted to processing in the database 111 and if successful the status is then change to complete.

In the past, both Carriers (Billers) and Shippers/Forwarders/Consignees (Payers) spend a great deal of time on invoice review, approval, and dispute resolution which incur high costs due to the manual and labor-intensive nature of these efforts. As a result, the lack of timely and accurate invoice settlement process eventually impacts both Billers' and Payers' operations in terms of credit positions, working capital optimization, cargo delays, and the necessity to incorporate incremental business processes designed to audit, correct, and improve historical transactions. In accordance with the concepts presented in this application, a computer implemented matching tool, through its implemented processes, advantageously addresses the concerns surrounding the high frequency of invoice inaccuracy in the freight industry, for example.

Some of the advantages of the automatching system for invoices described herein are the introduction of efficiency, accuracy, and transparency to the process of ocean freight settlement; specifically around the capability of streamlining the verification of ocean freight invoices. This is done by leveraging a Payer's existing in-house data in the form of invoice accruals (or freight statements). The automatch system automatically verifies the accuracy of a freight invoice by comparing it against the freight statement provided using predefined business rules that govern the verification process. Upon detection of invoice data failing a business rule, the automatch system automatically raises a dispute to the Biller and correspondingly informs the Payer.

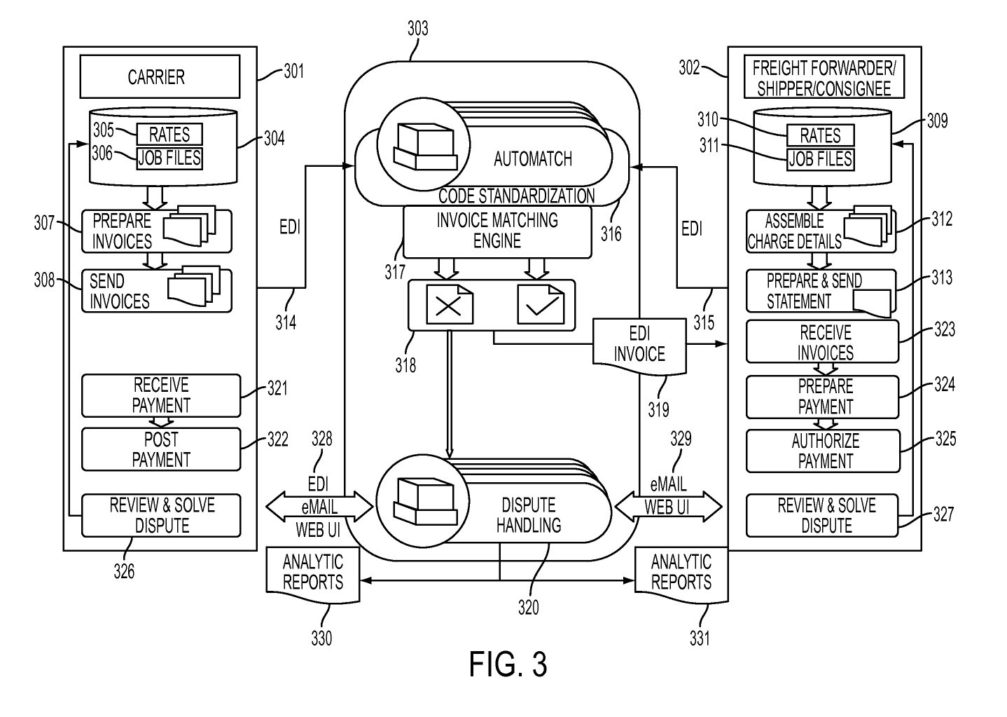

FIG. 3 shows an illustrative example of the automatching system including a biller (referred to as carrier 301), a payer (referred to as a freight forwarder/shipper/consignee 302), and an automatch portal 303. Automatch portal 303 includes one or more hardware webservers as known in the art that access one or more databases as provided on one or more computer storage devices (hard drives, optical drives, Flash memory, and other known storage devices). The entity communicating with portal 303 and having received (or in the process of receiving services from carrier 301) shown in FIG. 1 as a freight forwarder 302.

Each of carrier 301 and freight forwarder 302 includes one or more conventional computers and storage devices connected to the Internet to communicate with portal 303. Carrier 301 includes database 304 with various shipping rates 305 for packages/containers and collections of job files associated with various jobs performed for freight forwarder 302 (or any other entity at 302). Through interactions with database 304, the carrier 301 prepares invoices 307 and sends the prepared invoices 308 to portal 303 via an electronic data messaging system 314 (for example, EDI). The carrier 301 receives and posts payments (at 321 and 322). If any disputes occur, they are handled and resolved at 326. The carrier 301 may be notified by portal 303 of the disputes via EDI, email, and/or a user interface of a webpage or the like as shown as message exchange 328.

Freight forwarder 302 (used herein for simplicity but may refer to the shipper or consignee as appropriate) includes a database 309 that includes rates information 310 (possibly generic or specific to various carriers) and job files 311 relating to shipping operations. Through interaction with database 309, the freight forwarder 302 assembles charge details 312 and prepares and sends a freight statement 313 via an electronic data messaging system 315 (e.g., EDI) to portal 303. Upon receiving (in step 323) an approved invoice 319 (e.g., via EDI), freight forwarder 302 prepares payment (in step 324) and authorizes the payment (in step 325) to settle invoice 319. If an invoice is disputed, the freight forwarder 302 may be notified by portal 303 of the disputes via email and/or a user interface of a webpage or the like (possibly including EDI) as shown as message exchange 329. The freight forwarder reviews and resolves the dispute in step 327.

Portal 303 receives electronic invoices 308 from carrier 301 and freight statements 313 from freight forwarder 302. Portal 303 performs various automated matching operations at step 316 including code standardization. Next, in step 317, portal 303 attempts to match invoices 308 and statements 313. For invoices 308 and statements 313 that are matched without disputes, invoice 319 is generated and transmitted to freight forwarder 302 for instance, via EDI. For invoices 308 and statements 313 that have one or more disputes associated with them, they are forwarded to dispute handling as shown in step 324 for resolution between carrier 301 and freight forwarder 302. Finally, analytic reports 330 and 331 are generated from the dispute handling step 320 and forwarded to the carrier 301 and freight forwarder 302, respectively, as needed or desired.

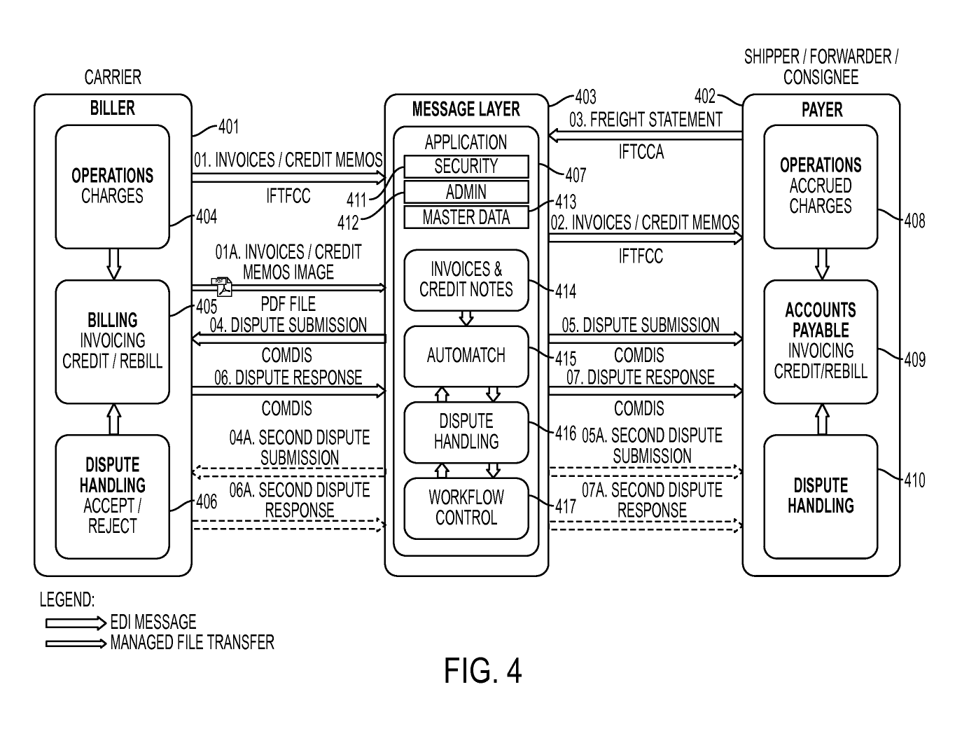

Various aspects of the operations performed in FIG. 3 are described below with respect to FIG. 4. FIG. 4 shows the three entities: biller 401, payer 402, and portal 403. Biller 401 is the entity performing a service. For example, biller 401 may be a carrier that will, is, or has performed a service (for instance, transporting a container from one port to another). Biller 401 includes computer systems as known in the art that manage its operations 404 (where charges occur are documented) and billing 405 (where invoicing is performed, credits applied and rebilling occurs for services rendered).

Payer 402 may be the shipper, forwarder or consignee as relevant. Payer 402, similar to Biller 401, includes a conventional operations system 408 (managing accrued charges) and accounts payable system 409 managing invoicing and credit/rebilling operations) as currently known in the art. Dispute handling system 410 is used to accept or reject dispute responses from the Biller 401.

Invoicing portal 403 manages the receiving, matching, generation of disputes, and transmission of responses to disputes between the biller 401 and payer 402. Invoicing portal 403 includes an application layer 407 including, for instance, a security/authentication layer 411, an administration layer 412, and a master data layer 413. The master data layer 413 may include one or more tables pertaining to the nuanced differences between each Biller 401 and payer 402 relating to how each designates information in its invoices, credit memos, and freight statements.

Application layer 407 performs the following four primary processes: receiving invoices and credit notes 414, automatching invoices/credit notes/freight statements 415, dispute handling 416, and workflow control 417.

FIG. 4 shows various messages being exchanged between Biller 401 portal 403 and payer 402. These messages are identified as follows in the following table 1:

| ID | Message Flow | Description | Type | From | To |
|---|---|---|---|---|---|
| 01 | Inbound | Invoices and Credit Memos sent by the Billers. | IFTFCC | Biller | Portal |
| | invoices and | | | | |
| | credit memos | | | | |
| 01a | Inbound | Billers can optionally send Invoice and Credit Memo | Image (e.g., | Biller | Portal |
| | invoices and | Images in the form of image files; these images are loaded | PDF, PNG, | | |
| | credit memos | into the portal and linked to inbound IFTFCC Invoice/ | GIF, JPEG, | | |
| | image file | Credit Memo EDIFACT messages using the following | etc.) | | |
| | | keys: Invoice/Credit Memo Reference Number; Invoice/ | | | |
| | | Credit Memo Issue Date; and Biller Company ID. | | | |
| 02 | Outbound | Upon completion of the automatch process, the portal may | IFTFCC | Portal | Payer |
| | invoices and | send the Invoices and Credit Memos to the Payer | | | |
| | credit memos | containing results from Automatch. Note: Automatch may | | | |
| | | hold back (and not send to the Payer) invoices which have | | | |
| | | outstanding and unresolved disputes. Credit memos may | | | |
| | | also be held back depending on certain Automatch | | | |
| | | processing. | | | |
| 03 | Inbound | The Freight Statement represents the charges that the | IFTCCA | Payer | Portal |
| | Freight | Payer is expecting to pay. It also contains information that | | | |
| | Statements | would enable Automatch to properly associate a | | | |
| | | corresponding invoice from the Biller to enable | | | |
| | | autoverification and dispute submission. | | | |
| 04 | Outbound | Any invoice dispute found as a result of Automatch | COMDIS | Portal | Biller |
| | dispute | processing will be sent to the Biller. The dispute message | | | |
| | submission (to | will also contain information on the discrepancies detected | | | |
| | biller) | on the invoice. Automatch Dispute Submissions are based | | | |
| | | upon Business Rules that were previously defined in the | | | |
| | | system. Note: An invoice may be limited to have one | | | |
| | | active dispute at any point in time. A dispute will contain | | | |
| | | all discrepancies detected on the invoice. Alternatively, an | | | |
| | | invoice may be permitted to have multiple active disputes. | | | |
| 05 | Outbound | Similar to the Biller, the Payer can also receive a copy of | COMDIS | Portal | Payer |
| | dispute | the dispute message containing any invoice discrepancies | | | |
| | submission (to | found as a result of Automatch processing. Automatch | | | |
| | payer) | Dispute Submissions are based upon Business Rules that | | | |
| | | were previously defined in the system. | | | |
| 06 | Inbound | The Biller will investigate the dispute raised on an invoice | COMDIS | Biller | Portal |
| | dispute | and correspondingly respond to the dispute either by | | | |
| | responses | Accepting or Rejecting the dispute. The dispute response | | | |
| | | message will also contain information from the Biller | | | |
| | | indicating the reason for the response. Note: A dispute | | | |
| | | response does not indicate any amount adjustments to the | | | |
| | | invoice. If the Biller accepts the dispute, they are expected | | | |
| | | to issue a credit note to cancel the original invoice and | | | |
| | | correspondingly issue a new invoice with the correct | | | |
| | | charges. | | | |
| 07 | Outbound | The dispute response sent by the Biller will be forwarded | COMDIS | Portal | Payer |
| | dispute | to the Payer to inform them of the Biller's decision with | | | |
| | response | regards to the invoice dispute that was raised. Note: A | | | |
| | | subsequent Automatch processing can take place | | | |
| | | depending on the dispute response received from the | | | |
| | | Biller, as well as, updated documents that attempt to | | | |
| | | correct or resolve the outstanding dispute. | | | |
| 04a | Second | See above. | COMDIS | Portal | Biller |
| | outbound | | | | |
| | dispute | | | | |
| | submission (to | | | | |
| | biller) | | | | |
| 05a | Second | See above. | COMDIS | Portal | Payer |
| | outbound | | | | |
| | dispute | | | | |
| | submission (to | | | | |
| | payer) | | | | |
| 06a | Second | See above. | COMDIS | Biller | Portal |
| | inbound | | | | |
| | dispute | | | | |
| | responses | | | | |
| 07a | Second | See above. | COMDIS | Portal | Payer |
| | outbound | | | | |
| | dispute | | | | |
| | response | | | | |

Referring to FIG. 4, with respect to message flow 01, invoices and credit memos sent by the Billers are uploaded onto the processing matching tool. With respect to message flow 01a, Billers can optionally send Invoice and Credit Memo Images in unalterable formats. For instance, the formats may include TIFFs, PDFs, PNGs, JPGs, GIFs, and any known format in which textual alteration of the content is prohibited. These files can be loaded onto the matching tool and linked to the inbound invoices. For message flow 02, upon completion of matching tool processing, the tool may electronically send invoices and credit memos to the Payer containing results. For message flow 03, any invoice dispute found as a result of the matching tool processing will be sent to the Biller via an EDI message. The dispute message will also contain information on the discrepancies detected on the invoice. For message flow 04, the Payer can also receive a copy of the dispute message containing any invoice discrepancies found as a result of matching tool processing. For message flow 05, Biller will investigate the dispute raised on an invoice and correspondingly respond to the dispute either by Accepting or Rejecting the dispute. The dispute response message will also contain information from the Biller indicating the reason for the response. For message flow 06, he dispute response sent by the Biller will be forwarded to the Payer to inform them of the Biller's decision with regards to the invoice dispute that was raised.

B. Submission Interval and Dispute Resolution Interval

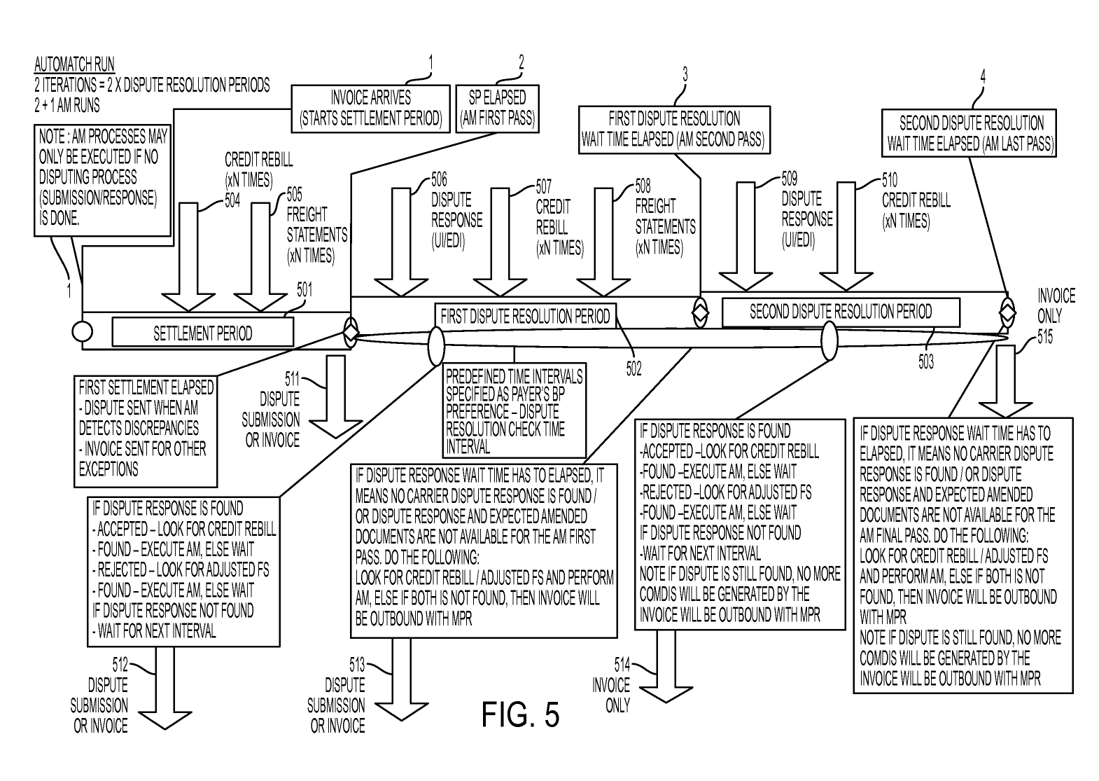

FIG. 5 shows an illustrative operational relationship between carriers, an intermediary, and shippers and related entities.

In general, dispute resolution process involves the Biller replying to the Payer's Dispute, and Payer in return taking the appropriate action as a result of the Biller's reply. If the Biller acknowledges that there was an invoicing mistake, they will cancel the wrong invoice and reissue a new one with the appropriate correction. Payer will cross check the new invoice to ensure that all appropriate changes are done correctly. On the contrary, if Biller believes the invoicing was correct and Payer's Dispute is invalid, Payer would need to recheck their accruals, or sometimes refer to their original agreements with the Biller, in order to recheck the invoice. The dispute resolution process can be repeated multiple times until both parties finally agree on the correct invoice.

A dispute is sent into the first dispute resolution period when the automatch process detects discrepancies between the subject invoice and a freight statement. For dispute raised in the matching tool, an outbound COMDIS Dispute Submission EDI message is transmitted to the Biller (and optionally to the Payer for information). For the automatch process, a dispute resolution period may be tied uniquely to the disputed invoice and any of its subsequent related invoices. If a dispute is found by the automatch process, the Biller may response to the EDI message by sending an Response EDI message to accept the dispute or reject the dispute. In such a case of an accepted dispute, Biller transmits, using EDI messaging, a Linked Credit Note to cancel the previous Invoice (Disputed). Then, the Biller issues a new related Invoice to correct the previous invoice's discrepancies. This process is generally referred to as a credit-rebill.

Alternatively, in the dispute process, if the Biller does not accept the dispute (e.g., rejects the disputes), Payer transmits an EDI message of a corrected Freight Statement replacing the previous freight statement. If no dispute response is received from the Biller, the matching tool proceeds to the elapsed period, regardless if Biller issued a “Credit-Rebill” or Payer sends in a corrected Freight Statement. Within the first dispute resolution period and the second resolution period predefined intervals specified as the payer's preference. These time intervals sequentially executes from the start of the first dispute resolution period until the end of the period 304 as a predefined wait time.

If dispute response wait time has elapsed, it means a No Carrier Dispute Response (NCDR) is issued or Dispute Response (DR) and expected amended documents are not available to the matching tool. After the predefined wait time expires without a resolution of dispute of the invoices to the freight statements, the process extending into a second dispute resolution period. The automatch process may execute by comparing the Latest Active Invoice (as a result of the “Credit-Rebill”) against the Latest Active Freight Statement (sent either previously during the Settlement Period or during a preceding Dispute Resolution Period, such as first dispute resolution period).

Specifically, in FIG. 5, three periods are shown: a settlement period 501, first dispute resolution period 502, and a second dispute resolution period 503. For easy description, these three periods are described with relation to four points in time: time 1—the beginning of settlement period 501; time 2—the end of the settlement period 501 and the beginning of first dispute resolution period 502; time 3—the end of first dispute resolution period 502 and the beginning of the second settlement dispute resolution period 503; and time 4—the end of the second dispute resolution period 503.

Time period 1 begins with the arrival of an invoice (the settlement period 501). This begins the automatch process. It is possible that, if a user submits a submission or sends a response that frustrates the operation of the automatch process, the automatch be canceled. The settlement period 501, there may be multiple credit memos and/or rebilling invoices as shown by the receipt of documents 504. Also, during the settlement period 501, there may be multiple freight statements received from the payer as shown by the receipt of documents 505.

Next, after a predetermined amount of time from the first submission or subsequence missions (for instance, one month, three months, etc.) or upon request of one of the parties or upon occurrence of an event identified in business rules (for instance, delivery of a container to a port), the first settlement period 501 ends and the first pass of the automatch process is executed at time interval 2.

At time interval 2, the automatch process either sends disputes 511 when discrepancies are detected or sends the invoice to the payer based on other exceptions.

During the first dispute resolution period 502, if a dispute is identified and sent to the parties as shown by dispute 511, dispute responses 506 are received by the portal. The dispute responses may be part of a user interface of a web-based portal (e.g, a server providing a webpage for display on a user's browser the server populates the webpage with information relevant to permit the user to respond to the dispute 511) or as a predefined form or other content transmitted by EDI. Next, the payer may also submit multiple credit memos and/or rebilled invoices as shown by the receipt of documents 507. Similarly the payer may submit multiple freight statements as shown by the receipt of documents 508.

During the first dispute resolution period 502, the automatch process may be reexecuted as follows:
A. If a dispute response is found then check the response,
   1. If the dispute was accepted, then look for a credit rebill from the biller. If found, then execute the automatch process again, otherwise wait for the credit memo or rebill or the next dispute response or interval.
   2. If dispute was rejected, then look for an adjusted freight statement.

If found, then execute the automatch process again, otherwise wait for the credit memo or rebill or the next dispute response or interval.
B. If no dispute response was found, then wait for the next interval.

Based on the steps, the dispute submission or invoice may be sent 512 from the portal to the payer and/or the biller.

The first dispute resolution period 502 ends after a waiting time has elapsed. For instance, the duration of the first dispute resolution period 502 (as well as the duration of settlement period 501 and a second dispute resolution period 503) may be specified by the payer's business practices.

If a Dispute Response Wait Time has elapsed (the duration of the first dispute resolution period 502), it means that no biller dispute response was found or that the dispute response and the expected amended documents were not available for the first execution of the auto match process (e.g., AM First Pass). If either of these is true, then the system looks for a credit rebill and/or an adjusted freight statement and performs the auto match process again. If both are false, then the portal sends the invoice to the payer with an identification that manual processing is required. For purposes herein the sending of the invoice from the portal is referred to as being “outbound” and the indication that manual processing required is referred to as MPR. For instance, the dispute submission or invoice may be sent as shown by arrow 513.

During the second dispute resolution period 503, dispute responses 509 may be received through a Web portal-based user interface or via EDI. Also, credit memos and/or rebills may be received a number of times 510.

During the second dispute resolution period 503, the portal reviews the received content from the biller and/or payer as follows:
A. If a dispute response is found, then check the response,
   1. If the dispute was accepted, then look for a credit rebill from the biller. If found, then execute the automatch process again, otherwise wait for the credit memo or rebill or the next dispute response or interval.
   2. If dispute was rejected, then look for an adjusted freight statement.

If found, then execute the automatch process again, otherwise wait for the credit memo or rebill or the next dispute response or interval.
B. If no dispute response was found, then wait for the next interval.

If a dispute is still found, then no more dispute details (referred to herein as COMDIS) will be generated and the invoice will be outbound with an indication that manual processing is required.

Finally, the second dispute resolution period 503 ends and the final automatch process is executed.

If this period ended by the dispute response wait time having expired, it means no carrier dispute response was found or that the dispute response and expected amended documents were not available for the automatch final pass. In this situation, the following steps are taken:
A. Look for a credit memo or rebill or adjusted freight statement and then perform automatch.
B. If none was found, then send the invoice 515 to the payer with a notation that manual processing is required.

If a dispute is still found, then no more dispute details will be generated and the invoice will be outbound with an indication that manual processing is required.

The dispute resolution process involves an electronic two way communication between the Biller and the Payer using EDI. The Payer is responsible for checking the invoice issued by the Biller and correspondingly raise a dispute should there be any discrepancies. While the Biller is responsible for responding to the Payer's dispute after looking into all the details. The settlement periods allow Payers enough time to send in a Freight Statement in order to allow invoice validation to take place. Within the first settlement period, if no discrepancies are found, then the invoice is correctly linked to the freight statement.

### II. Submission Interval

A. Parties Submissions

Each of the parties (the biller and payer) submits one or more documents to the invoicing portal, which then matches them, adjusts for changes, and attempts to resolve disputes.
1. Invoices and Credit Notes

Invoices and credit notes are generated by the billing entity. Often the invoices, credit notes, and reissued/corrected invoices (rebilled invoices) are submitted numerous times prior to being considered final by billing entity.
2. Estimated Invoices

Estimated invoices are what the payer expects to pay. The estimated invoices are sometimes referred to as freight statements.

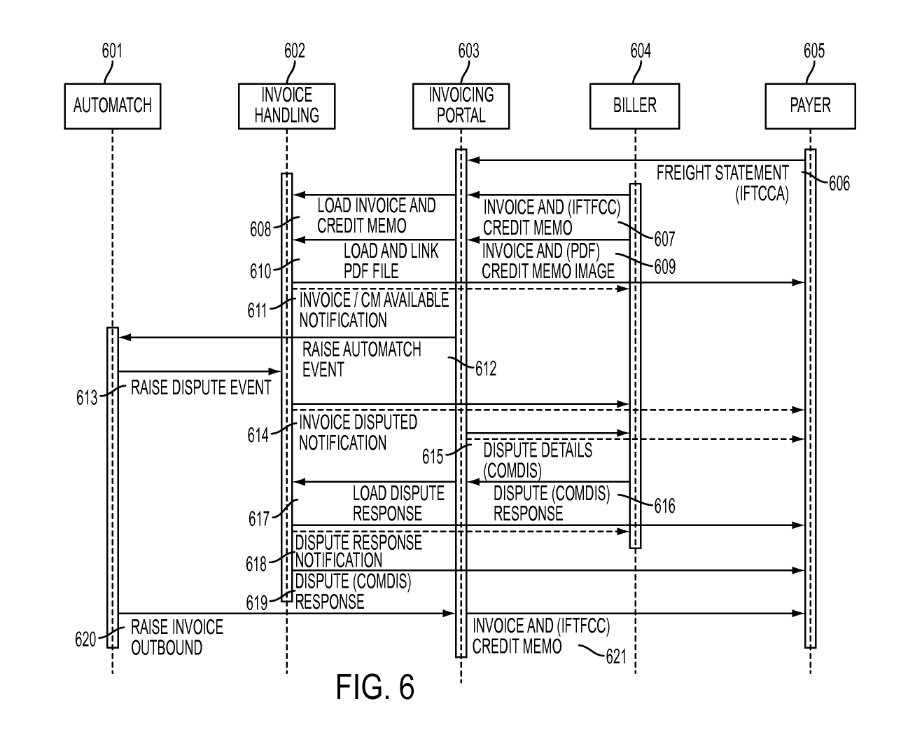

FIG. 6 includes the following entities: The automatch process 601 automates validation and dispute escalation of freight invoices. Invoice handling process 602 handles electronic invoicing of the payer. Invoicing portal 603 is an internet-based platform that coordinates interactions between the automatch process 601 and invoice handling process 602 and interactions between those processes and biller 604 and payer 605. Payer 605 that receives invoices and eventually pays for the goods and services charged within those invoices. Biller 604 is an entity sending invoices containing charges for goods and services delivered and expects payment in return.

The following identifies various messages identified in FIG. 6:

Freight Statement (IFTCCA) 606. From payer to invoicing portal. A Payer sends a Freight Statement to Invoicing portal using the inbound IFTCCA Freight Statement EDIFACT message format to provide the necessary information to enable Automatch to auto-validate invoices from the Biller. Note: The Freight Statement contains the expected charges that the Payer is expecting to pay, potentially extracted from the Payer's accrual system, contract management system, purchase order system, BL rating system, etc.

Invoice and Credit Memo (IFTFCC) 607. From biller to invoicing portal. A Biller sends Invoices or Credit Memos to Invoicing portal using the inbound IFTFCC Commercial Invoice EDIFACT message format.

Load Invoice and Credit Memo 608. From invoicing portal to invoicing process. Invoicing portal will validate the IFTFCC message and eventually process it for loading onto the Invoice handling process platform. Processing an invoice includes running it through security screenings and translating certain data to allow for further processing.

Invoice and Credit Memo Image (PDF) 609. From biller to invoicing portal. A Biller can optionally send a PDF image file of their Invoices or Credit Memos to the invoicing portal.

Load and Link PDF File 610. From invoicing portal to invoice handling process. Using a specified PDF filename format (e.g., invoice number or credit memo number as the file name), the invoice handling process will be able link the PDF file to its corresponding Invoice or Credit Memo. Note: The PDF filename format used is IFTFCC_PDF.Reference number.YYYYMMDD Issue Date.Biller Company ID.ID Code.pdf

Invoice/Credit Memo Available Notification 611. From invoice handling process to payer or biller. Once an Invoice or Credit Memo has been loaded successfully, Invoice handling process platform will automatically send an e-mail notification to the Payer (and optionally to Biller) informing them that an invoice is now available. This notification is optional and can be configured based on the customer's preference. Note: If a PDF file has been provided by the Biller, it can be included with the e-mail notification.

Raise Automatch Event 612. From Invoicing portal to automatch process. Invoicing portal will check if automatch service is subscribed for the Biller-Payer combination and automatically trigger Automatch processing by sending the corresponding Invoice and Freight Statement to the automatch service.

Raise Dispute Event 613. From Automatch to invoice handling. Automatch validates the Invoice based on the Business Rules that were previously defined in the system; if any discrepancies are detected, a dispute will be automatically raised. Note: Steps 614-619 would not occur if there are no discrepancies (or dispute) detected by the invoice handling process.

Invoice Dispute Notification 614. From invoice handling process to Biller or Payer. Invoice handling process platform will automatically send an e-mail notification to the Biller (and optionally to Payer) informing them that an Invoice has been disputed. This notification is optional and can be configured based on the customer's preference.

Dispute Details (COMDIS) 615. From Invoicing portal to Biller or Payer. Invoicing portal will send the dispute details (discrepancies) for the Invoice to the Biller (and optionally to Payer) using the outbound COMDIS Commercial Dispute Submission EDIFACT message format.

Dispute Response (COMDIS) 616. From Biller to Invoicing portal. After reviewing any invoice dispute, a Biller sends their dispute responses to Invoicing portal using the inbound COMDIS Commercial Dispute Response EDIFACT message format. A dispute response can be positive (Acceptance of the dispute) or negative (Rejection of the dispute). A Dispute Response can also be submitted through the Invoice handling process web portal.

Load Dispute Response 617. From Invoicing portal to invoice handling process. Invoicing portal will validate the COMDIS message and eventually process it for loading onto the Invoice handling process platform.

Dispute Response Notification 618. From invoicing portal to Payer or Biller. Invoice handling process platform will automatically send an e-mail notification to the Payer (and optionally to Biller) informing them of the response from the Biller. This notification is optional and can be configured based on the customer's preference. Note: Dispute Response Notifications can be triggered when the dispute was originally raised from the web interface or when raised from any interface.

Dispute Response (COMDIS) 619. From invoicing portal to Payer. Invoice handling process platform will send the dispute response that was received from the Biller to the Payer using the outbound COMDIS Commercial Dispute Response EDIFACT message format. Note: The Dispute Response sent to the Payer may not necessarily be exactly the same as the one received from the Biller as the invoicing portal may perform additional processing (e.g. aliasing) before it sends the Dispute Response to the Payer. Dispute Responses can also be viewed online via the Invoice handling process web portal.

Raise Invoice Outbound 620. From Invoice handling process to Invoicing portal. If Automatch does not detect any discrepancies on the Invoice based on the previously defined Business Rules, it will automatically process the Invoice for delivery to Payer via EDI (if subscribed) or e-mail (if subscribed). Note: Any Credit Notes associated to an Invoice that was already sent to the Payer will also be sent out.

Invoice and Credit Memo (IFTFCC) 621. From Invoicing portal to Payer. Invoicing portal will send the Invoices or Credit Memos to Payer using the outbound IFTFCC Commercial Invoice EDIFACT message format. Note: Invoices and Credit Notes can also be viewed online via the Invoice handling process web portal.

B. Linking Invoices and Credit Notes to Estimated Invoices

This section details how the Automatch process links an Invoice to its corresponding Freight Statement and how it utilizes configurable Business Rules to validate an invoice and potentially raise Disputes to the Biller. This section also covers information on how Automatch results are presented on the outbound COMDIS dispute submission EDIFACT message as well as, the outbound IFTFCC invoice EDIFACT message. Dispute management and resolution as it relates to Automatch processing is also explained below.

Before an Invoice can be validated by the Automatch process, it has to be linked in some way to the correct Freight Statement. Similar to how a Payer's clerk would pick-up a paper invoice from the Biller, and using some key information (such as Bill of Lading) search through order or job files to determine the correct information to begin invoice validation; the Biller and Payer must provide the necessary key information that enable the Automatch process to correctly link an invoice to a corresponding freight statement.

The following keys may be used when linking an invoice to a freight statement:
Carrier ID—a unique identifier (Company ID) stored in the invoicing portal and used in identifying an ocean carrier. The ocean carrier is the one engaged by the Shipper/Forwarder/Consignee to ship goods, which is different from the Biller who may usually be a regional or operations office of the ocean carrier that actually issues the invoice.
Payer ID—a unique identifier (Company ID) stored in the invoicing portal and used in identifying a Payer who is responsible to pay for the items shipped. The Payer ID can either be the Prepaid or Collect Payer ID depending on whether it is the Import or Export Invoice being linked.
Bill of Lading Reference Number—the reference number of the bill of lading document issued by the ocean carrier as a contract to deliver goods.
Shipper's Identifying Number (SID)—a reference number used by the shipper to identify a particular shipment.
Booking Number (BN)—a reference number used by the ocean carrier to identify a particular booking for shipment of goods.

Invoice to freight statement linking follows a set of rules. These rules are needed to provide consistency and audit-ability in the invoice validation process. It is important to note that trading partners should ensure that key reference numbers to be utilized for linking are identified and will be available at the correct points in the business process.

This section provides a description of the linking rules, as well as, examples to better illustrate the linking logic.

Invoices and Freight Statements can be classified as either being an Export or Import document depending on the direction of trade. An Export Invoice is always linked to an Export Freight Statement; whereas, an Import Invoice, in general, is linked to an Import Freight Statement. There are situations where an Import Invoice may be linked to an Export Freight Statement.

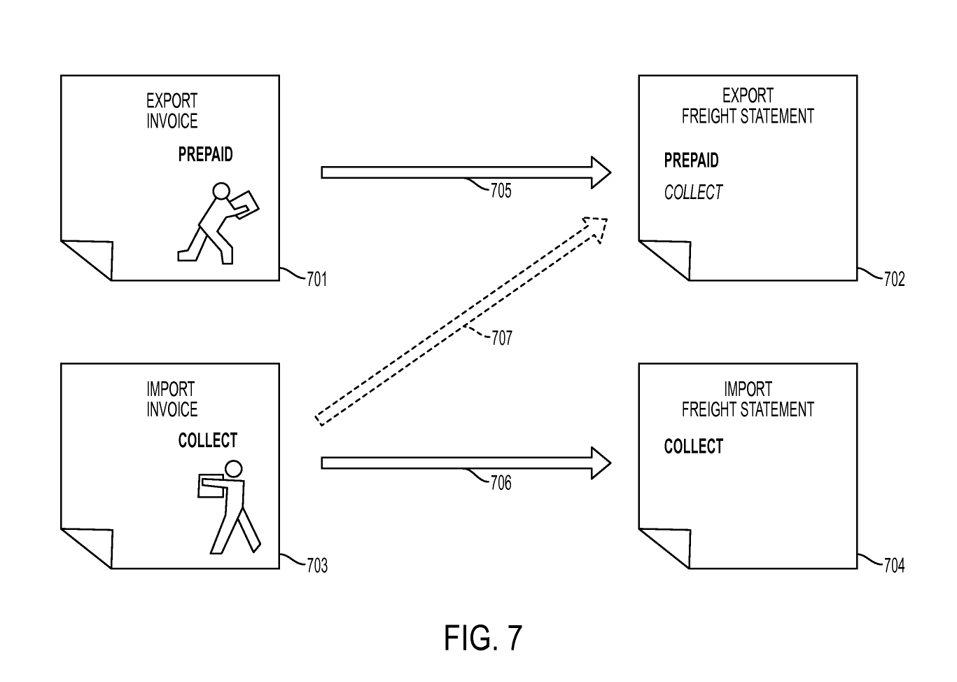

FIG. 7 shows handling of invoices and freight statements. A prepaid export invoice 701 only contains prepaid charges. An export freight statement 702 will always contain Prepaid Charges and optionally may contain Collect Charges as well.

An Import Invoice 703 and an Import Freight Statement 704 will always only contain Collect Charges. As shown in FIG. 7, export invoice 701 is to be linked to the export freight statement 702 by link 705 and the import invoice 703 is to be linked to the import freight statement 704 by link 706. Also, the import invoice 703 may be linked to the export freight statement 702 by link 707.

For purposes herein, the link between the statements, invoices, and the like may be data stored in a database, table, or in the file name or additional contents field of each entry.

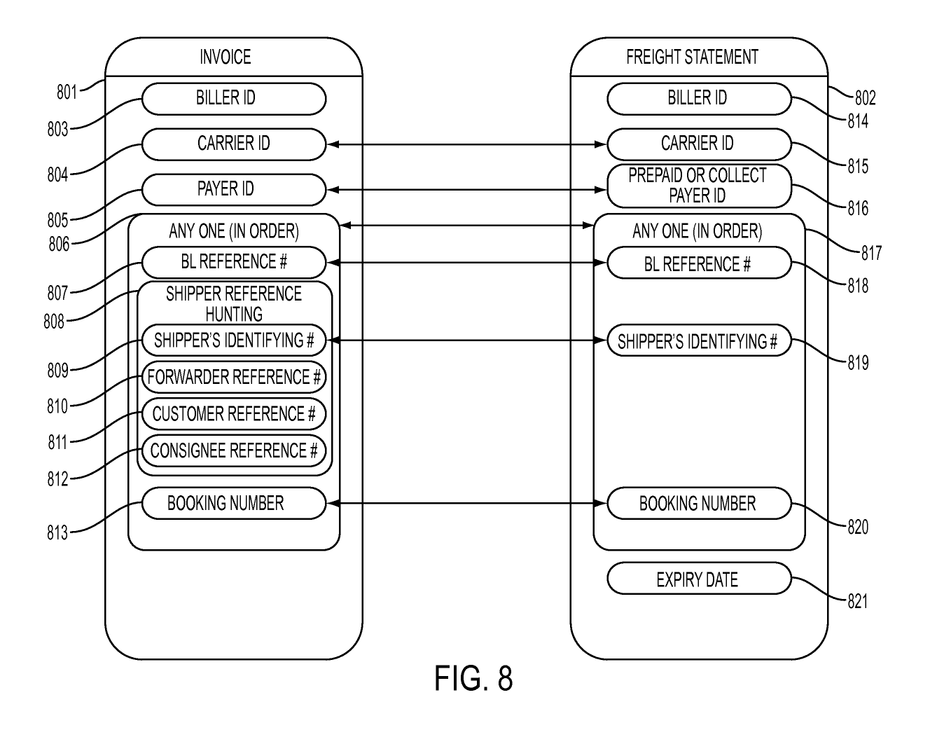

FIGS. 8-17 show illustrative examples of how the automatching system attempts to correlate invoices and freight statements.

FIG. 8 shows an invoice 801 including, for instance, a biller ID 803, a carrier ID 804, a payer ID 805, and any one of a bill of lading reference number 806, a shipper identifying number 808, a forwarder reference number 809, a customer reference number 811, a consignee reference number 812, and a booking number 813. The freight statement 802 includes a biller ID 814, a carrier ID 815, a prepaid or collect payer ID 816, a bill of lading reference number 818, a shipper identification number 819, a booking number 820, and an expiry date 821.

The following provide rules used by the automatch system to link an invoice to its corresponding freight statement. All rules must be satisfied before linking can occur:
1. The Carrier ID on both the Invoice and the Freight Statement must exactly match.
2. The Payer ID on both the Invoice and the Freight Statement must exactly match.
   a. Export Invoice: the Payer ID on the Invoice must match the Prepaid Payer ID on the Freight Statement
   b. Import Invoice: the Payer ID on the Invoice must match the Collect Payer ID on the Freight Statement
3. At least one of the references (BL Reference#, Shipper Identifying#, Booking#) must match between the Invoice and the Freight Statement.
   a. References from the Freight Statement are checked in the following sequence: BL Reference#, followed by Shipper's Identifying#, followed by Booking#.
   b. Once a pair of references matches, the system does not proceed to check for the next reference number.
   c. When matching the Shipper's Identifying# from the Freight Statement, it is matched against any of the following references from the Invoice: Shipper's Identifying#, Forwarder Reference#, Customer Reference#, and Consignee Reference#.
   d. References are matched using case insensitive comparison and must be a full value match. This means if the invoice has multiple references of the same type (i.e. multiple Shipper's Identifying#), the corresponding freight statement must also contain the same exact number of references with the same values.
4. The freight statement being linked must not have an expiry date less than the current date. Payers are allowed to provide freight statement expiry dates to dynamically disable linking of outdated documents.
5. Both invoice and freight statement must pass OFAC (Office of Foreign Assets Control) screening.
6. The Freight Statement being linked to the Invoice must not have been Replaced, Cancelled, or Used in a previous Automatch execution.
7. An Invoice can only be linked to 1 Freight Statement. Likewise, a Freight Statement can only be linked to 1 Invoice at any point in time.

The following apply to the above rules:
1. The Biller ID, which is used to identify an ocean carrier's regional or operations office that issues the invoice, is not used in the linking process. The rationale behind this is that Payers usually are not 100% sure which carrier's office will be issuing them the invoice.
2. The Biller ID, although not part of the linking process, is used in determining which set of Automatch business rules to execute. More specifically, it is the Biller ID on the invoice (not the freight statement) that is used to determine such business rules.
3. The Payer ID that issues the Freight Statement is not used in the linking process. A Freight Statement contains 3 types of Payer: Freight Statement Issuer, Payer for Prepaid, and Payer for Collect; it is possible that the latter two are used in the linking process.
4. The rationale behind searching for the Shipper's Identifying# from the Freight Statement across different references on the Invoice is that Billers usually are not 100% sure which reference the Payer has used in their own internal systems and have historically placed the Shipper's Identifying# in one of these four reference categories.

In general, an Import Invoice is linked against an Import Freight Statement. This is because both documents contain Collect charges that are matched and compared using business rules defined in Automatch. An Export Invoice is always linked against an Export Freight Statement for the same reason that both documents contain Prepaid charges.

However, the Automatch process allows the flexibility for Payers to provide both their Prepaid and Collect charges on the Export Freight Statement. The rationale behind this is twofold:
This allows a Payer to be able to provide Collect charges (and not just Prepaid charges) during Export document processing if they are already known. The Payer is not required to send an Import Freight Statement should there be no changes to the Collect charges that they expect.
This also enables advanced checking of charges on the Export Invoice to determine if there are Prepaid charges that should actually be meant for Collect (or Import) side.

The following are the additional linking rules used by Automatch specifically for Import Invoice (rules stated above still apply):
1. Only Export Freight Statement containing Collect charges can be linked against an Import Invoice. These Collect charges must not have been Used in a previous Automatch execution. See also sections Understanding Invoice & Freight Statement States and Automatch Invoice Validation Process for more information.
2. An Import Freight Statement always takes precedence over an Export Freight Statement when linking an Import Invoice. This is regardless if the Import Freight Statement can be used by Automatch (e.g. due to OFAC noncompliant, etc.)
3. If an Import Invoice was already previously linked to an Import Freight Statement, subsequent Automatch execution should link the same Import Invoice only to Import Freight Statements.
4. If an Import Invoice was already previously linked to an Import Freight

Statement, any subsequent related Import Invoices should also be only linked to Import Freight Statements (see section on Relating Invoices for Automatching).

The following may also apply:
1. It is possible that an Export Freight Statement may have its Prepaid charges already Used, but its Collect charges are still not Used. Such Export Freight Statement can still be linked to an Import Invoice.
2. The rationale behind linking subsequent Import Invoices only to Import Freight Statement (should the Import Invoice or a previous Import Invoices were already linked to an Import Freight Statement) is because the Export side would not be able to know or properly provide corrections for the Import side.

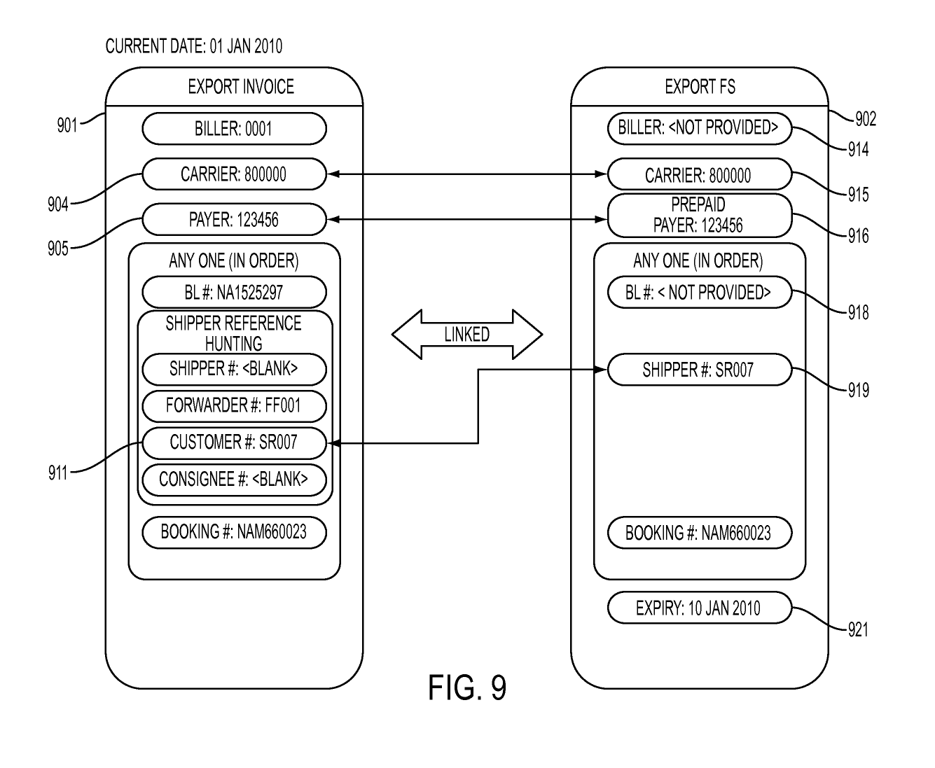

FIG. 9 shows an example of an export invoice and export freight statement being linked. For this and the following examples, the fields in the invoices are generally the same as those shown in FIG. 8 and are not listed in detail. Here, linking was based on the freight statement's Shipper's Identifying Number 919 against invoice's Customer Reference Number 911 since Bill of Lading Reference Number 918 was not provided on the freight statement 902. The freight statement expiry date is also after the current date and both documents are OFAC compliant.

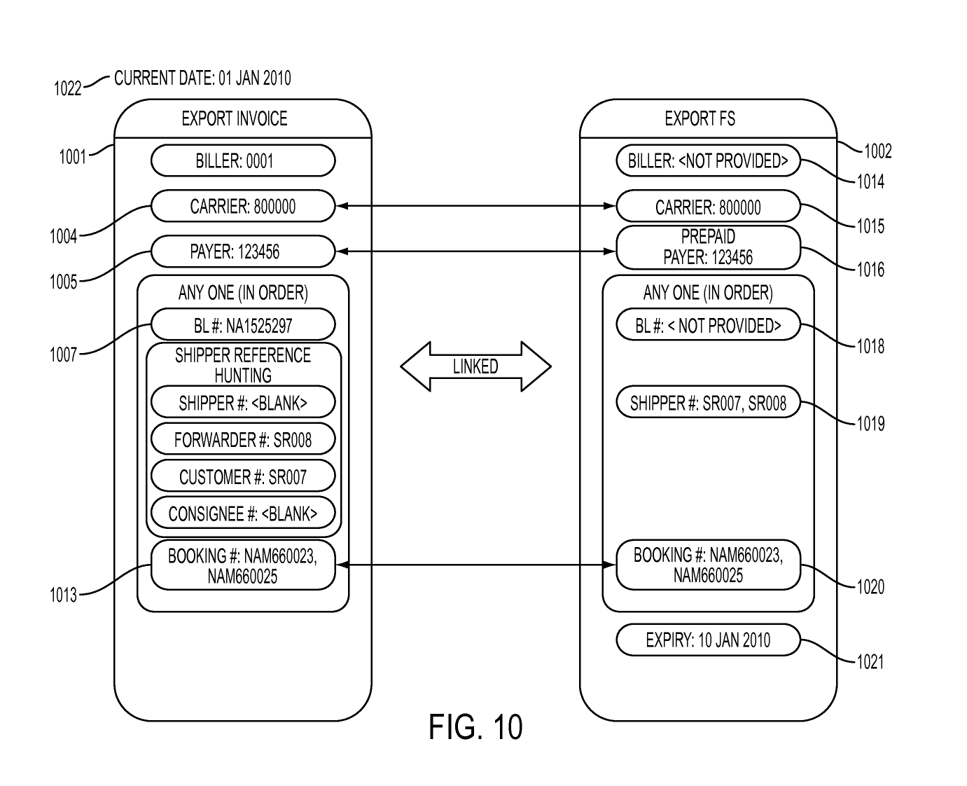

FIG. 10 shows another example of attempted linking. Export invoice and export freight statement are linked. Linking was based on the Booking Number (BN) which has 2 exactly matching Booking Numbers for both documents. The freight statement's Shipper's Identifying Number was not used for linking since the invoice's references only had 1 value each: SR007 or SR008, while the freight statement had 2 references SR007 and SR008; this is considered as not a full value match.

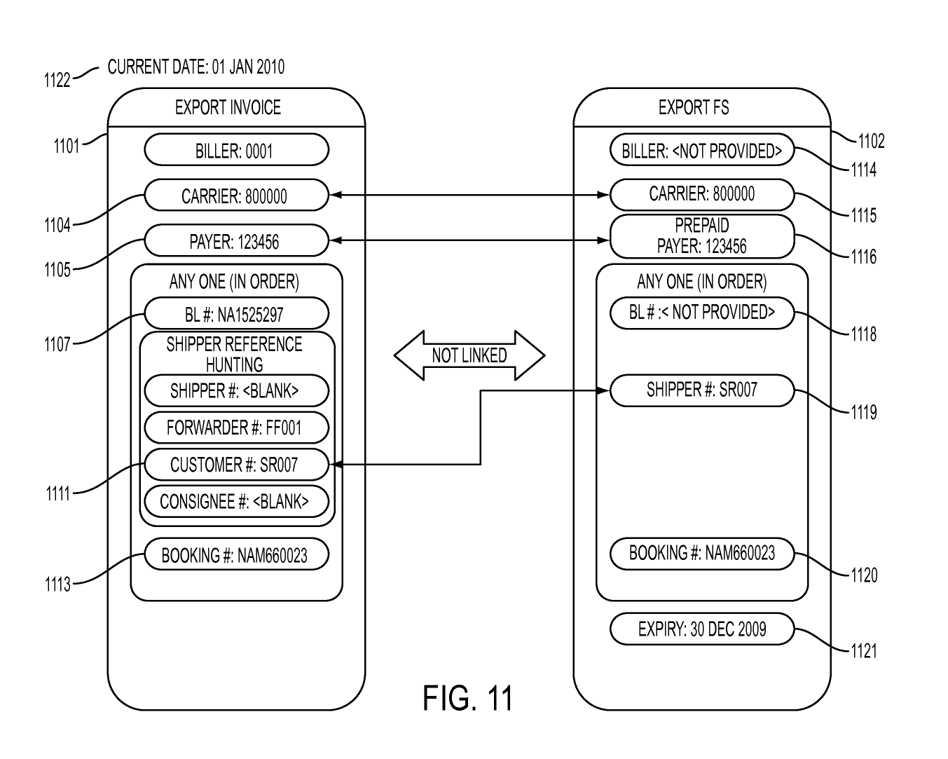

FIG. 11 shows another example of attempted linking. Here, however, the export invoice and export freight statement cannot be linked. The freight statement had already expired and linking does not occur despite all references being valid and OFAC compliance.

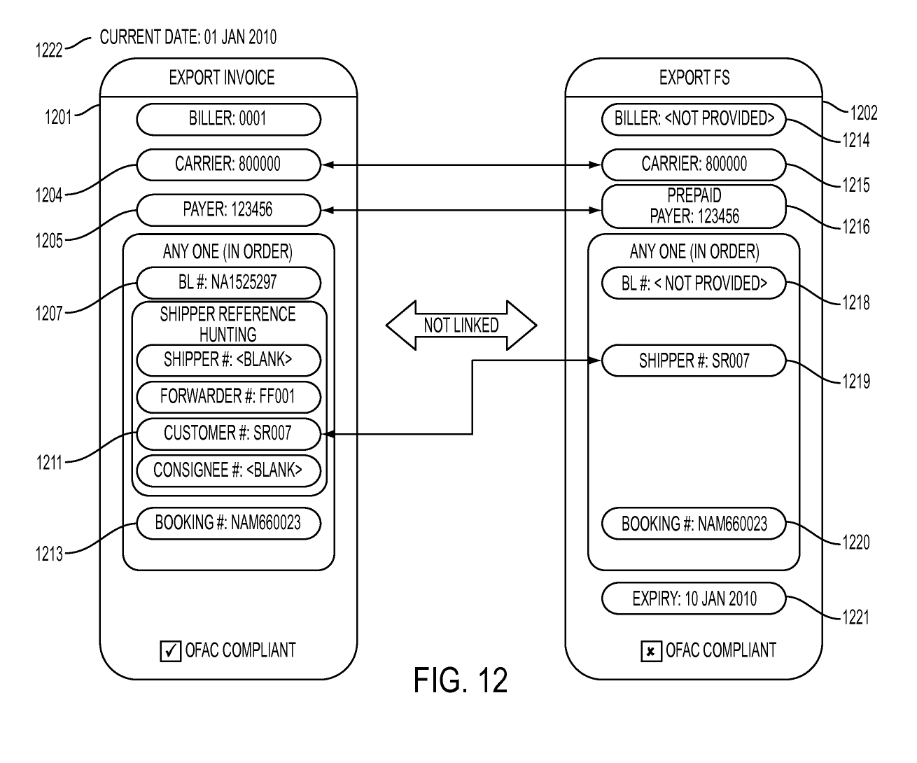

FIG. 12 shows another example of attempted linking. Export invoice and export freight statement cannot be linked. The freight statement was not OFAC compliant and linking does not occur despite all references being valid and despite the freight statement having a valid expiry date.

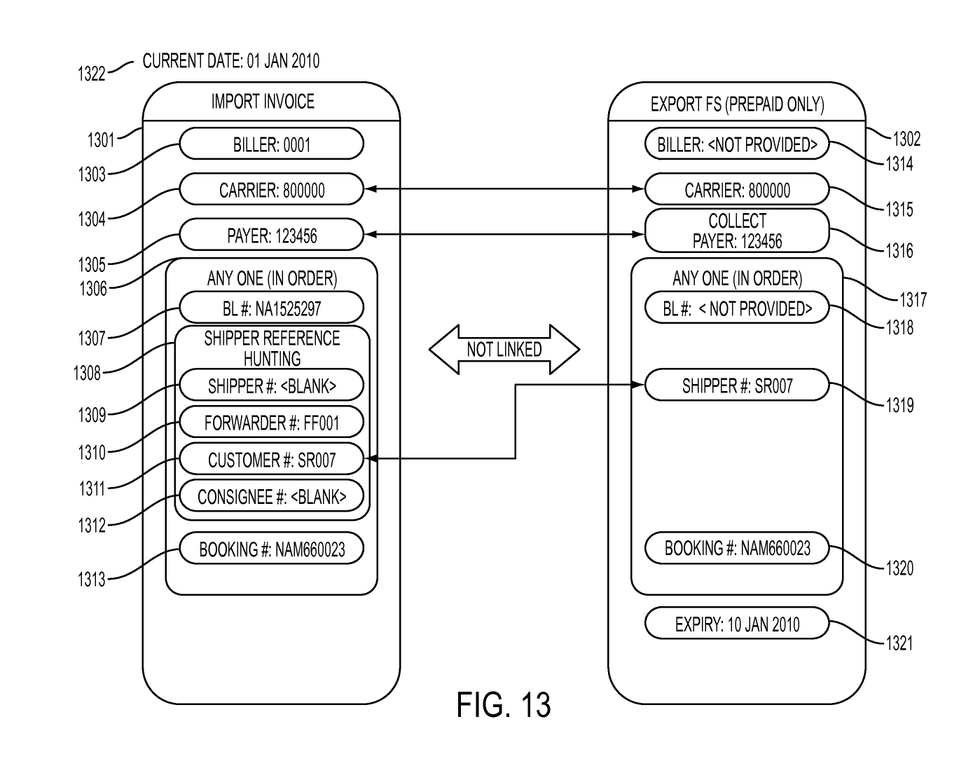

FIG. 13 shows another example of attempted linking. The import invoice was not linked against the export freight statement because the freight statement did not contain any collect charges. The linking does not occur despite all references being valid and despite the freight statement having a valid expiry date and OFAC compliance.

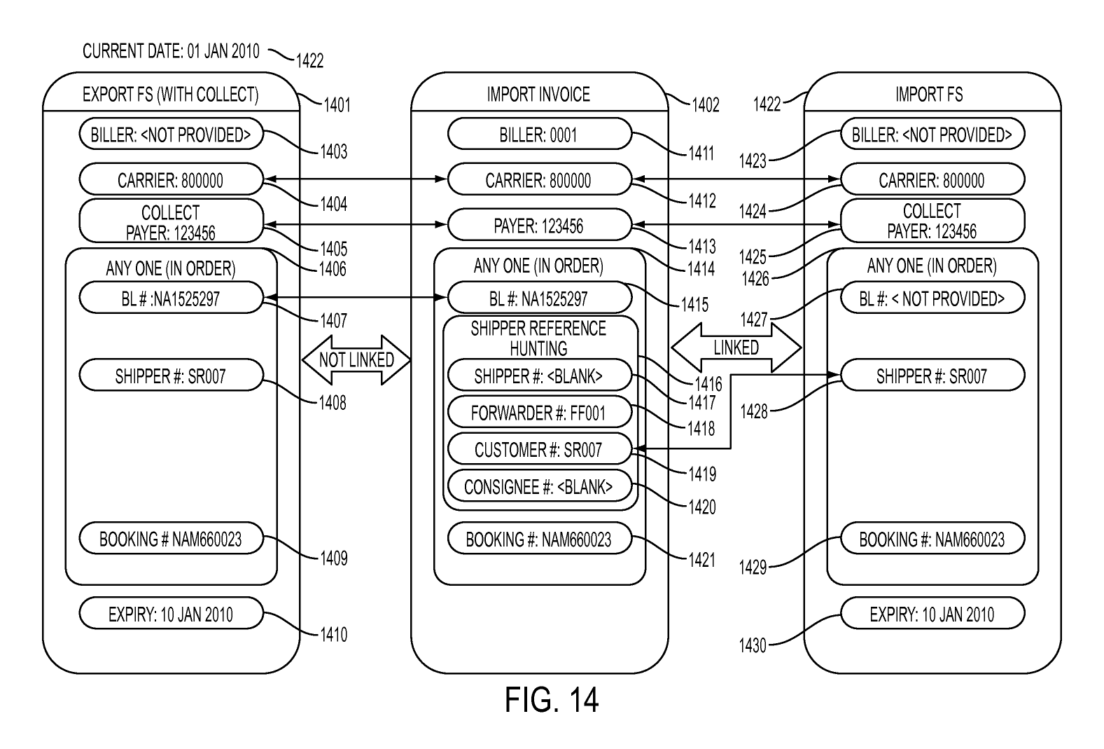

FIG. 14 shows another example of attempted linking. The import invoice was linked against the import freight statement, even though the export freight statement contained collect charges with all references, OFAC, and expiry date being valid. Import freight statement collect charges take precedence over export freight statement collect charges.

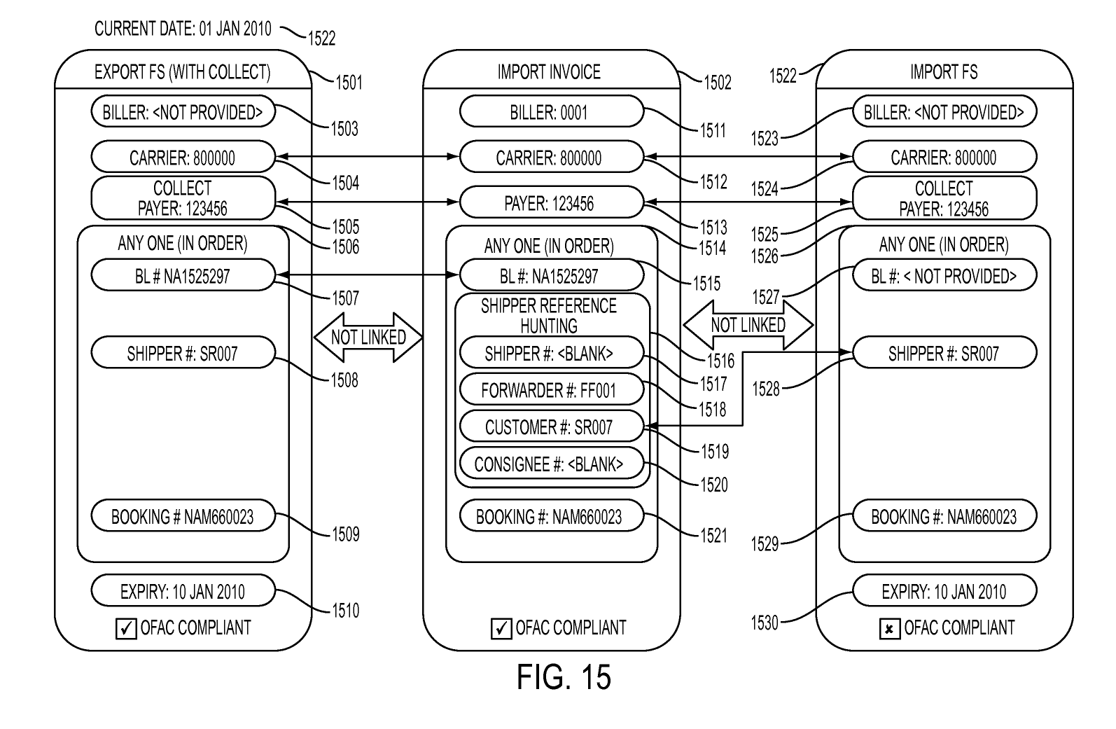

FIG. 15 shows another example of attempted linking. Both import invoice and import freight statement cannot be linked as the import freight statement was not OFAC compliant. The linking does not occur despite all references being valid and despite the import freight statement having a valid expiry date.

In addition, the export freight statement will not be linked against the import invoice, as there was already an import freight statement present. The linking does not occur despite the export freight statement having collect charges with all references, OFAC, and expiry date being valid.

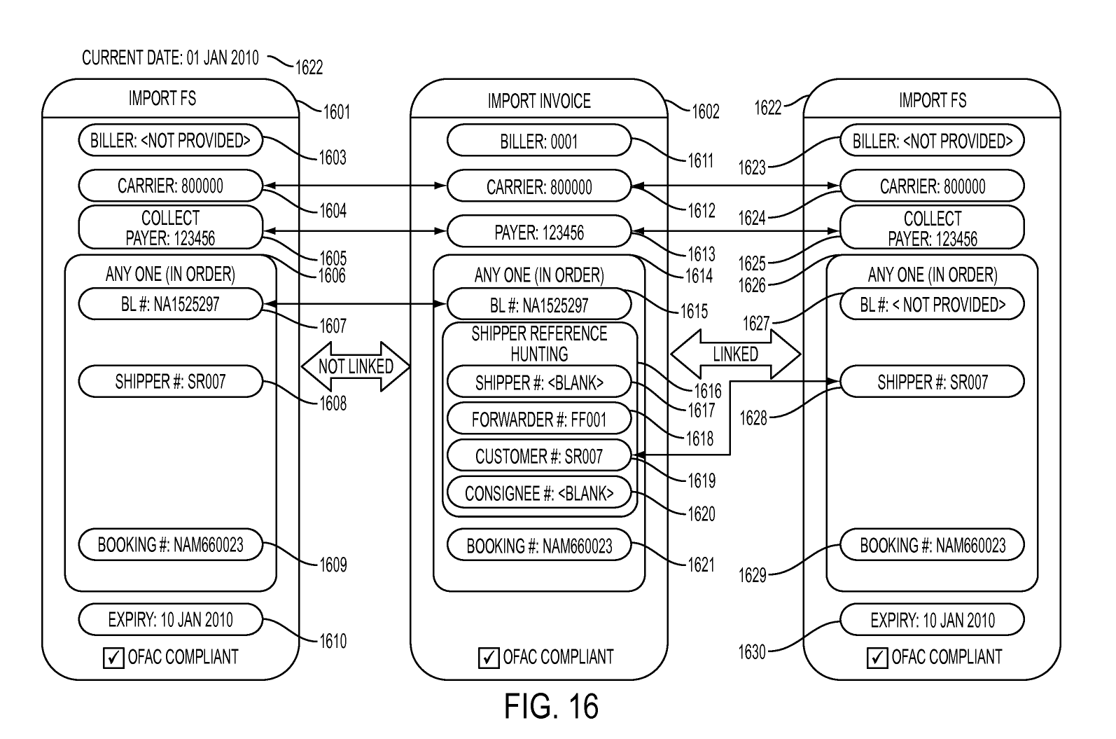

FIG. 16 shows another example of attempted linking. The import invoice cannot be linked to any of the 2 import freight statements. This is despite the 2 import freight statements having valid references, expiry date and OFAC compliance. The reason behind this is that the automatch process will not be able to properly execute as it wouldn't be able to know which freight statement to use in order to check the invoice. An Automatch Exception will be raised and the invoice will be sent out to the Payer.

The following addresses issues where freight statements are not found during document linking. Invoices and freight statements are received by the invoicing portal at different times. Ideally, a Payer would have sent the freight statement ahead of the Biller sending an invoice; that way, the invoice can be immediately Automatched and results issued to the Biller or Payer for further processing or payment execution. However, there are instances that an invoice may be received or processed, by the Portal, hours before the arrival of its related freight statement; this prevents the invoice from being Automatched prior to it being sent to the Payer. The Automatch system provides flexibility to allow invoices and freight statements to ‘wait’ for a predefined period of time before processing begins.

Although such wait time provides flexibility for Payers to send in freight statements after invoices from Billers have been processed, it is still recommended that the freight statements be sent in by the Payers prior to Billers sending in their invoices.

In the event that the Automatch system is unable to find a freight statement to link to an invoice, an e-mail notification from the system can be configured to inform a specific individual from the Payer side that a freight statement could not be found for the processed invoice.

Linked Credit Notes (or credit memos) are documents that a Biller sends to their Payer either to adjust an incorrect charge on an invoice or in some occasions to cancel an invoice completely. A Biller must provide the related invoice number and invoice issue date when sending linked credit notes to the Portal. This provides a means for Automatch to properly identify the invoice that is being corrected by the credit note.

There are two types of Linked Credit Notes: Partial Linked Credit Notes (PLCN) and Full Linked Credit Notes (FLCN). When a Biller sends a partial linked credit note, their intention is mainly to correct certain charge items on the related invoice; the invoice itself has other items that are correct and should remain valid after a PLCN has been applied. When a Biller sends a full linked credit note, their intention is to completely void the related invoice by zeroing out all charges on the invoice. Billers could have different practices when canceling invoices, using FLCN is one means of canceling an invoice; other Billers' may opt to explicitly cancel an invoice without issuing any full linked credit notes.

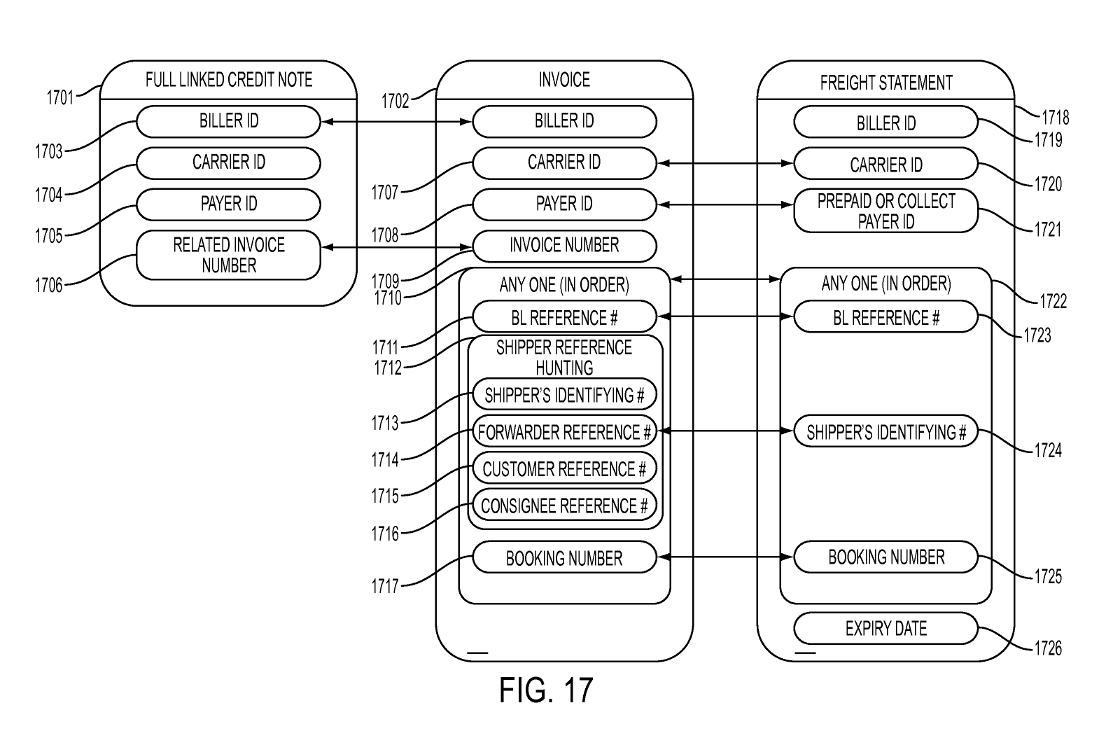

When processing full linked credit notes, Automatch uses it to unset any charges that were previously matched between the related invoice and the corresponding linked freight statement. FIG. 17 shows an example of a full linked credit note being linked to an invoice and freight statement.

As Full Linked Credit Notes are mainly dependent on the related invoice being corrected, linking a full linked credit note to a freight statement is based upon the existing link already present between the related invoice and the freight statement. Similar to the invoice, the full linked credit note must pass OFAC screening for it to be considered as a valid document in the Automatch process.

C. Collapsing Common Charge Items

The heart of Automatch invoice validation process is all about making sure charges on the invoice sent by the Biller is to the expectation of the Payer. These charges, although have the same meaning for both Billers and Payers, are actually represented or stored in various different ways within the Biller's and Payer's own systems. Example: a Biller could represent Basic Freight Charges with a code of BSF in their system, while a Payer could simply store it with a code of BF.

Furthermore, since the Payer may not fully know how their Biller may breakdown their freight charges or surcharges, a Payer may represent certain charges as one single code whereas a Biller may have multiple codes for variations of a similar charge. Example: a Biller could have Gulf Surcharges, Bunker Surcharges, Canal Surcharges, and Reefer Surcharges all represented as difference codes in their system, but to a Payer they may simply represent these as one single code for any transport related types of surcharges.

As such, it is important for Automatch to be able to harmonize charge codes between Billers and Payers in order to correctly match and validate invoice item charges. Collapsing of common charges is also an important feature in Automatch to enable multiway matching of various similar charges between Billers and Payers.

1. Resolving to Standard Charge Codes

Automatch adopted a subset of the UN/ECE CEFACT Trade Facilitation Recommendation N^{o}. 23—Freight Cost Codes to be the list of Standard Charge Codes used in harmonizing charge codes between Billers and Payers. In order to use Automatch to facilitate in the validation of invoice charges, it is helpful for Billers and Payers to map their own codes into Standard Charge Codes (for instance, the industry standard charge codes from INTTRA, Inc. of Parsippany, N.J.); this exercise is called aliasing.

Aliasing allows both Billers and Payers to still maintain their own list of codes for internal system processing while capitalizing on a set of industry recommended standard codes to enable seamless processing across multiple Billers and Payers. Not to mention that using a common set of standard codes also enables automated invoice validation using Automatch.

Once a Biller or Payer has completed the exercise of aliasing their own charge codes to standard codes, they can choose to either send their own internal charge codes or use the standard set of charge codes in the inbound Invoice (IFTFCC) or Freight Statement (IFTCCA) EDIFACT messages.

The invoicing portal may send the Biller's or the Payer's own charge codes in the outbound EDIFACT messages if there is an alias defined. For standard charge codes that do not have an alias, the invoicing portal will send the Standard Charge Code.

The Automatch process will always use the Standard Charge Codes when comparing invoices and freight statements. All charge codes sent by the Biller and Payer in the inbound EDIFACT messages will be translated to Standard Charge Codes first before sending for Automatch.

2. Collapsing Methods and Processes

Collapsing common charge codes enables multiway matching of various similar charges that may be represented differently between the invoice sent by the Biller and the freight statement sent by the Payer. Charge code collapsing can only be done after all Biller and Payer charge codes have been translated into the Standard Charge Codes.

Collapsing also means summing up of numeric fields on a charge line such as quantities and amounts based on a set of key fields (including the Standard Charge Code) that have the same value. Automatch provides two methods or types of collapsing to allow even more flexibility for the Payer when representing line item charges in their freight statements. Depending on the collapsing method chosen by the, Automatch will perform the summation based on different key fields defined by the collapsing method.

The two collapsing methods are: By Charge Code—all container Size/Types are ignored and are not required to be provided by the Payer when specifying charge lines in the Freight Statement and By Charge Code & Container Size/Type—container Size/Types are required to be provided by the Payer when specifying charge lines in the Freight Statement.

The following table shows the fields on a charge line with indications whether a particular field is used as a key during collapsing or as a field that is being summarized.

| | | By | By |
|---|---|---|---|
| | | Charge | Charge |
| Charge Line Field | Sample Value | Code & | Code |
| Prepaid/Collect Indicator | P or C | Key | Key |
| Charge Code | 101000 | Key | Key |
| Container Size Type Code | 40HC | Key | Ignored |
| Quantity | 5 | Sum | Sum |
| Rate | 100.00 | Key | Key |
| Invoice Currency | USD | Key | Key |
| Invoice Amount | 500.00 | Sum | Sum |
| Exchange Rate | 1.34 | Key | Key |

Only when charge lines that are collapsed, or unique charge lines, can the automatch used for processing. Charges lines which cannot be collapsed will be filtered off from Automatch and raised as disputes separately.

Payers who opt for collapsing by Charge Code & Container Size/Type are mainly able to provide more detailed charge lines in their Freight Statements that enables Automatch to more accurately match charges that pertains to each container size or type that was shipped.

Payers who opt for collapsing by only Charge Code are not able to provide detailed charges in their Freight Statements at specific container sizes or types. Even if the container size/type is provided, Automatch will ignore it during collapsing.

3. Collapsing Exceptions

There are instances when Automatch is unable to properly collapse charges on either an invoice or freight statement. These charge lines are referred to as noncollapsible charges.

Invoice charge lines that are part of a non-collapsible charge, either due to the invoice or freight statement, will be raised as “Non-Collapsible” discrepancies and must be checked manually.

On certain instances, Automatch may not even be able to successfully execute due to non-collapsible charges. On such instances, Automatch will raise an exception and send the invoice out to the Payer.

The following are examples of collapsing scenarios:

Case 1: Collapsing method chosen is by Charge Code & Container Size/Type but the freight statement provided by the Payer had at least one charge item that didn't provide container size/type.

Result: Automatch will not be able to proceed with invoice validation because container size/type was not provided for a non-All-in-Charge Code or non-Flat Fee.

Rationale: Automatch will not be able to partially collapse line items with container size/type and simply ignore those of which container size/type have not been provided as this may cause unpredictable and inconsistent automatching results.

Resolution: Either have container size/type provide for all charge lines when collapsing method is by Charge Code & Container Size/Type is chosen; or choose to have collapsing by Charge Code only.

Case 2: Unable to collapse charge lines either on the invoice or freight statement such that there is a unique set of charge codes (for collapsing by Charge Code only) or unique set of charge code and container size/type (for collapsing by Charge Code & Container Size/Type).

Result: Automatch will raise a “Non-Collapsible” discrepancy for those charge line(s) that were non-collapsible. This discrepancy is raised as part of the Automatch results that are sent to the Payer in the outbound COMDIS dispute submission EDIFACT message. Automatch will still be able to proceed with invoice validation for other charge lines that are able to collapse properly.

Rationale: since Automatch validates charge lines between invoice and freight statement by linking them based on charge code (and possibly container size/type depending on the chosen collapsing method), a set of non-unique keys will cause unpredictable and inconsistent automatching results. See section on Matching by Charge Codes for more information on validating change lines.

Resolution: Understanding how Automatch functions and proper mapping of Biller and Payer charge codes to Standard Codes will minimize the chances of non-collapsible charges. Choosing collapsing by Charge Code & Container Size/Type over Charge Codes only may also help to increase uniqueness in the collapsed charge lines.

4. All-in-Charge Codes and Flat Fees

Billers sometimes charge for container shipments as an All-in-Charge which may include port charges, customs clearance, domestic transportation, etc. along with the actual sea freight charge. Instead of breaking down the individual add-on charges necessary to ship the container, the Biller instead would issue one single charge that was previously agreed upon with the Payer.

Biller sometimes may also charge for Flat Fees that are not directly associated to any container shipment, such as documentation fees or postal fees.

Automatch supports the concept of All-in-Charges and Flat Fees and provides standard charge codes that allows Billers and Payers to be able to do automatching of such type of charges (i.e. 101021 “All-in Ocean Freight”, 609079 “Postal charges”).

All-in-Charges and Flat Fees have unique attributes, and due to their nature of being a pre-agreed charge between the Biller and the Payer, or simply a fixed amount charge, sometimes information such as rate, quantity, etc. may not be provided by the Biller on the invoice's charge line. The following table lists the charge line items that can be optionally not provided on the invoice or freight statement if the charge is an All-in-Charge or Flat Fee.

| Charge Line Field | Sample Value |
|---|---|
| Container Size Type Code | 40HC |
| Quantity | 5 |
| Unit of Measure Code | UNI |
| Rate | 100.00 |

During charge line collapsing, should any of the optional charge line fields be provided for an All-in-Charge or Flat Fee, these fields will be used as part of the collapsing keys.

It is relevant to understand how optional charge line fields are treated for All-in-Charges and Flat Fees in both the invoice and freight statements to ensure accurate collapsing and automatching process. There may be instances when Automatch will not be able to collapse the charge lines properly if the optional fields are not provided consistently for All-in-Charges and Flat Fees.

All-in-Charges and Flat Fees must be explicitly indicated on the inbound invoice and freight statement EDIFACT messages. This is done using a charge class indicator “AI” for All-in-Charges and “FF” for Flat Fees in the Transport Charge/Rate Calculations (TCC) segment. If the indicator is not provided, Automatch will take the assumption that the charge code is a non-All-in-Charge or non-Flat Fee even if the charge code itself is mapped to the INTTRA standard charge code (i.e. 101021 “All-in Ocean Freight”). The following are examples of inbound INTTRA Invoice (IFTFCC) and Freight Statement (IFTCCA) EDIFACT messages showing the All-in-Charge and Flat Fee indicator.

INTTRA will also explicitly send the “AI” and “FF” charge class indicator to

Payers should the charge line pertain to an All-in-Charge or Flat Fee. The following are examples of outbound INTTRA Invoice (IFTFCC) EDIFACT messages showing the All-in-Charge and Flat Fee indicator.

The following apply to All-in-Charge or Flat Fees:
1. It is important to always properly specify the charge class indicator when using an All-in-Charge or Flat Fee for a charge line. Using an All-in-Charge or Flat Fee charge code without the indicator implies that the charge code itself is being used for a normal charge (i.e. non-All-in-Charge and non-Flat Fee)
2. It is recommended not to use the same charge code that is used as an All-in-Charge or Flat Fee for a normal charge (non-All-in-Charge and non-Flat Fee) as this can result to unpredictable Automatch results or cause collapsing exceptions.
3. Invoices/Credit Notes that contains only unexpected charges, or a mix of Unexpected Charges and Normal Charges

In some instances, invoices and credit notes may only contain unexpected charges or a mix of unexpected charges and normal charges. The automatch system may attempt to process the invoices/credit notes by ignoring the unexpected charges. In other situations, the automatch system may attempt to look up those unexpected charges against information stored regarding the biller's information and codes specific to that biller. The automatch system may also attempt to check the unexpected charges against other biller's information. If no resolution of the unexpected charges is found, then the invoice/credit note is identified as unresolvable and sent to the payer for manual processing.

### III. Dispute Resolution Interval

Invoice validation is all about approving or disputing charges and items on the Biller's invoice based on what the Payer expects. In order to do this, the Payer would have some set of rules or conditions that they go through to ensure that the Biller's invoice is either exactly matching what they have based on their shipment records, or at least within a certain threshold of what they are willing to pay. If there are items on the invoice that does not match the Payer's records, they would raise these as discrepancies (or dispute) and potentially provide some supporting information to the Biller. The Biller, in turn, would need to investigate and potentially either reissue a new invoice or provide a credit memo to correct any errors.

The Automatch solution works in a similar fashion whereby Business Rules are defined by the Payers to enable automatching of invoices against freight statements. These Business Rules allow the automated checking of invoice items or charges that do not meet the Payer's minimum requirements. Any automatching results are also communicated by Automatch to the Payer using the outbound COMDIS dispute submission and/or IFTFCC invoice EDIFACT messages.

A. Validating/Matching Invoices

The process by which the validating/matching occurs is through the use of business rules.

1. Business Rules

Automatch Business Rules can be defined to check for charge line items (i.e. rates, amounts, etc.), as well as, invoice header items such as transportation details (i.e. Vessel, Voyage, Sail Date, etc). There are various invoice fields available for a Payer to define different business rules depending on their invoice validation practices and requirements.

Various Payers have different invoice validation requirements even if they have the same Biller. Automatch has the flexibility to define a unique set of business rules per Biller-Payer combination. This feature enables a Payer to have one set of business rules for Biller 1 and another set of entirely different business rules for Biller 2.

a) A Business Rule Driven Automatch

The Automatch Engine validates invoice items based on the business rules that were predefined in the system. Invoice fields or charges that do not have business rules will be skipped by the engine as these will be considered as unimportant to the Payer's validation process. Likewise, a defined business rule will be skipped if the field it is checking for does not have a value on either the invoice, or freight statement, or both (also known as insufficient information)

Should the engine encounters a situation whereby all the business rules defined couldn't be executed due to insufficient information, the system will raise an exception to the Payer informing them that there was insufficient data to do automatching. This exception is raised as part of the Automatch results that are sent to the Payer in the outbound IFTFCC invoice EDIFACT message

Each Business Rule defined in Automatch is independent of each other. The system will raise a discrepancy based upon the rule currently being executed. If there are multiple Business Rules defined, each one will separately raise its own discrepancy. Business Rules, by default, uses an “Exact Match” comparison unless otherwise indicated

b) Alpha and Numeric Comparison Rules

Automatch can validate invoice fields or charges that are of type alpha characters or numeric figures. Examples of alpha character fields are: Contract Number, Location Code, Container Number, and Currency Code. Examples of numeric figures are: Total Tax Amount, Number of Containers, Quantity, and Rate

The following rules are used when comparing alpha character fields:
Case Insensitive—comparison between uppercase (capital) and lowercase (small) letters do not make any differences. Example: “AbC” when compared to “aBc” will be treated as equal.
Space Trimming—before any comparison takes place, any leading or trailing spaces and blank lines will be removed. Example: “ABC” when compared to “ABC” will be treated as equal.

The following rules are used when comparing numeric figure fields:
8-Decimals—numeric figures with decimals will be compared up to a maximum of 8 decimal places. Example: 1.123456789 when compared to 1.12345679 will be treated as equal since 1.123456789 will be rounded to 1.12345679

Rounding—rounding of decimal places will follow the “Round half away from zero” rule. The following table shows some examples of positive and negative numeric figures when rounded to 8 decimal places:

| Original | | | |
|---|---|---|---|
| Value | Rounded to | Original Value | Rounded to |
| (Positive | 8 Decimal | (Positive | 8 Decimal |
| Sign) | Places | Sign) | Places |
| 1.123456784 | 1.12345678 | −1.123456784 | −1.12345678 |
| 1.123456775 | 1.12345678 | −1.123456775 | −1.12345678 |
| 1.123456785 | 1.12345679 | −1.123456785 | −1.12345679 |
| 1.123456786 | 1.12345679 | −1.123456786 | −1.12345679 |

c) Date & Time Comparison Rules

Automatch can also validate invoice fields that are of type date and time. For the time being, there is only one field that is of type date and time, that is the Actual Sail Date field. Date and time fields can be sent by Billers and Payers in two different formats:

| Format | Example | Remarks |
|---|---|---|
| CCYYMMDD | 20101224 | Dec. 24, 2010 |
| CCYYMMDDH | 201012241945 | Dec. 24, 2010 |

The following rules are used when comparing date and time fields:
Same Format—date and time fields can only be compared if both invoice and freight statement uses the same format. Example: 20101224 and 201012241945 will be treated as not equal.
Alpha Comparison—date and time fields are treated as alpha characters and will be compared using the rules used for alpha character comparison

d) List Values Comparison Rules

List Values refer to invoice or freight statement items (or fields) that have more than one value. List Values can occur because the invoice or freight statement field allows for multiple values (i.e. Container Numbers).

Automatch allows the flexibility to compare list values between invoices and freight statements. The following rules are used when comparing fields with List Values:
Distinct Values—only one value within the List Values that are duplicated will be used for comparison. Example: if the List Values contain “ABC,ABC,DEF” Automatch will simplify the list to “ABC,DEF”.
Invoice Full Match—All individual values from the invoice's List Values must match a corresponding value from the freight statement's List Values. However, all individual values from the freight statement's List Values need not necessarily match a corresponding value from the invoice's List Values.

| Invoice | Freight Statement(s) | Result |
|---|---|---|
| ABC, XYZ, 123 | ABC, XYZ, 123 | OK |
| ABC, XYZ, 123 | ABC, XYZ, 123, 789 | OK |
| ABC, XYZ, 123 | ABC, XYZ, 789 | Discrepancy |

e) Comparison Using Thresholds

When validating invoices, Payers may not always necessarily be comparing for 100% accuracy. As there may be items on the invoice that the Payer is unable to accurately predict (e.g. exchange rates) or certain known charges that may potentially change during the course of the container shipment, the Payer needs to have the flexibility to decide how much more of a difference he or she is willing to accept or pay. Automatch allows for this flexibility by providing thresholds comparison on numeric figures.

Automatch allows the Payer to defined the following types of threshold business rules:
Greater than x % of original value—the value on the invoice field being compared cannot be greater than the original value on the freight statement plus the provided x percent threshold. The x percentage is calculated off the freight statement's value and the result rounded to 8 decimal places before comparison (see Alpha and Numeric Comparison Rules for more information on 8-Decimals rounding).

Threshold Rule: Greater than 3% of original value

| Invoice | Freight Statement | With Threshold | Result |
|---|---|---|---|
| 11 | 10 | 10.3 | Discrepancy |
| 10.3 | 10 | 10.3 | OK |
| 10.1 | 10 | 10.3 | OK |
| 9 | 10 | 10.3 | OK |

Greater than x of original value—the value on the invoice field being compared cannot be greater than the original value on the freight statement plus the provided x value threshold. The x value is added to the freight statement's value before comparison.

Threshold Rule: Greater than 1.3 of original value

| Invoice | Freight Statement | With Threshold | Result |
|---|---|---|---|
| 12 | 10 | 11.3 | Discrepancy |
| 11.3 | 10 | 11.3 | OK |
| 11 | 10 | 11.3 | OK |
| 9 | 10 | 11.3 | OK |

Less than x % of original value—the value on the invoice field being compared cannot be less than the original value on the freight statement minus the provided x percent threshold. The x percentage is calculated off the freight statement's value and the result rounded to 8 decimal places before comparison (see Alpha and Numeric Comparison Rules for more information on 8-Decimals rounding).

Threshold Rule: Less than 3% of original value

| Invoice | Freight Statement | With Threshold | Result |
|---|---|---|---|
| 9 | 10 | 9.7 | Discrepancy |
| 9.7 | 10 | 9.7 | OK |
| 9.9 | 10 | 9.7 | OK |
| 11 | 10 | 9.7 | OK |

Less than x of original value—the value on the invoice field being compared cannot be less than the original value on the freight statement minus the provided x value threshold. The x value is subtracted from the freight statement's value before comparison.

Threshold Rule: Less than 1.3 of original value

| Invoice | Freight Statement | With Threshold | Result |
|---|---|---|---|
| 8 | 10 | 8.7 | Discrepancy |
| 8.7 | 10 | 8.7 | OK |
| 9 | 10 | 8.7 | OK |
| 11 | 10 | 8.7 | OK |

f) Handling Exchange Rate Comparisons

Automatch provides Payers with the flexibility to track or compare exchange rates between invoices and freight statements. Exchange rates can be provided both at the header or charge line levels in the EDIFACT messages. The following are examples of inbound Invoice (IFTFCC) and Freight Statement (IFTCCA) EDIFACT messages using the Free Text (FTX) segment to denote exchange rates. Since exchange rates are provided as free texts, the following are some guidelines that would help in the automatching process:
Always provide the FromCurrencyRate as 1 since only the ToCurrencyRate is used when comparing exchange rates between invoices and freight statements.
Exchange Rates (or ToCurrencyRate) are up to a maximum of 6 decimal places.
Exchange Rates should always be positive non-zero numeric figures.
Exchange rate direction should be consistent when providing FromCurrencyCode and ToCurrencyCode at charge line level. Example: a charge line having 1:USD:1.306021:SGD versus another charge line with 1:SGD:0.765684:USD will not collapse properly.
Charge lines with different exchange rates will not be collapsed as Exchange Rate is one of the key fields used during collapsing. Example: a charge line having 1:USD:1.306021:SGD versus another charge line with 1:USD:1.306022:SGD will be considered as two separate lines even if all other keys have the same values.
Exchange Rate comparison will only take place if the currency pair between the invoice and freight statement are the same. Example: automatching will not occur if freight statement has charge line with 1:USD:1.306020:SGD while matching invoice charge line has 1:USD:0.718614:EUR.
Automatch will automatically invert the exchange rate on the freight statement should it detect that the currency pair on the matching invoice charge line is of the same currency pair but in the opposite direction. Rounding of the resulting inverted exchanged rate will be up to 6 decimal places. Inverting of exchange rates only occurs after charge lines have been collapsed successfully. Example: freight statement has charge line with 1:USD:1.306020:SGD while matching invoice charge line has 1:SGD:0.765684:USD, the freight statement's exchange rate will be converted to: 1:SGD:0.765685:USD.
When comparing Exchange Rates between invoices and freight statements, it is recommended to use threshold comparisons and avoid exact matches.

The following table provides some scenarios on exchange rate comparisons:

| | |
|---|---|
| Threshold Rule: | Greater than 0.003 of original value |

| Invoice | Freight Statement | Comment |
|---|---|---|
| 1:SGD:0.765684:USD | 1.306022:SGD:1:USD | Discrepancy |
| | | *Recommended: FromCurrencyRate |
| | | should always be 1. |
| 1:SGD:0.765684:USD | 1:USD:1.306020:SGD | OK |
| | | *FS exchange rate converted to |
| | | 1:SGD:0.765685:USD. |
| L1: 1:USD:1.306021:SGD | L1: 1:USD:1.306021:SGD | Charge Lines Non-Collapsible on FS |
| | L2: 1:SGD:0.765684:USD | *Recommended: Provided exchange rate |
| | | direction should be consistent. |
| L1: 1:USD:1.306021:SGD | L1: 1:USD:1.306021:SGD | Charge Lines Non-Collapsible on FS |
| | L2: 1:USD:1.306022:SGD | *Recommended: Different exchange |
| | | rates will not be collapsed. |
| L1: 1:USD:1.306022:SGD | L1: 1:USD:1.306021:SGD | OK |
| | L2: 1:USD:1.306021:SGD | *Charge Lines Collapsed on FS |

g) Party-specific variations

At times, there may be a need to provide party-specific variants to validating and matching operations. In this situation, the automatch process may vary from its standard approaches outlined above and, by identifying the party involved, apply those party-specific variations.

2. Automatching Invoice Header Items

Automatch provides the capability to validate invoice items or fields that are on the header. Items on the header simply mean that these fields are not pertaining to the actual charge lines, example: contract numbers, container numbers, total net amount, etc. The following table lists the Header Fields that can be automatched, as well as, additional information on these fields such as: inbound Invoice (IFTFCC) and Freight Statement (IFTFCA) EDIFACT message positions, data types, whether the fields can have threshold comparisons or List Values.

| | | | | | | |
|---|---|---|---|---|---|---|
| | Invoice | Freight Statement | | | | |
| | Position-Segment- | Position-Segment- | | | | |
| | Element | Element | | Threshold | List | |
| Header Field | (Qualifier) | (Qualifier) | Type | Comparison | Values | Remarks |

References

| | | | | |
|---|---|---|---|---|
| Contract | 0130-RFF-C506-1154 | 0110-RFF-C506-1154 | Alpha | Y |
| Number | (1153 = CT) | (1153 = CT) | | |
| Quote | 0130-RFF-C506-1154 | 0110-RFF-C506-1154 | Alpha | Y |
| Number | (1153 = AGN) | (1153 = AGN) | | |
| Contracts for | 0130-RFF-C506-1154 | 0110-RFF-C506-1154 | Alpha | Y |
| Named | (1153 = NC) | (1153 = NC) | | |
| Accounts/ | | | | |
| Clients | | | | |
| Contract | 0130-RFF-C506-1154 | 0110-RFF-C506-1154 | Alpha | Y |
| Type | (1153 = CTP) | (1153 = CTP) | | |

Locations

| | | | | |
|---|---|---|---|---|
| Place of | 0100-LOC- | 0260-LOC- | Alpha | Utilizes standard UN |
| Receipt | C517-3225 | C517-3225 | | location codes |
| | (3227 = 88) | (3227 = 88) | | |
| Place of | 0100-LOC- | 0260-LOC- | Alpha | Utilizes standard UN |
| Delivery | C517-3225 | C517-3225 | | location codes |
| | (3227 = 7) | (3227 = 7) | | |
| Port of | 0720-LOC- | 0260-LOC- | Alpha | Utilizes standard UN |
| Load | C517-3225 | C517-3225 | | location codes |
| | (3227 = 9) | (3227 = 9) | | *Port of Load provided in |
| | First Main | First Main | | both the Invoice's and |
| | Transport | Transport | | Freight Statement's First |
| | Leg: | Leg: | | Main Transport Leg shall |
| | 0690-TDT- | 0230-TDT- | | be used for comparison. |
| | 8051 = 20 | 8051 = 20 | | |
| Port of | 0720-LOC- | 0260-LOC- | Alpha | Utilizes standard UN |
| Discharge | C517-3225 | C517-3225 | | location codes |
| | (3227 = 11) | (3227 = 11) | | *Port of Discharge |
| | Last Main | Last Main | | provided in both the |
| | Transport | Transport | | Invoice's and Freight |
| | Leg: | Leg: | | Statement's Last Main |
| | 0690-TDT- | 0230-TDT- | | Transport Leg shall be used |
| | 8051 = 20 | 8051 = 20 | | for comparison. |

Transport Details

| | | | | |
|---|---|---|---|---|
| Actual | 0710-DTM- | 0240-DTM-C507- | Date | *Actual Sail Date |
| Sail Date | C507-2380 | 2380 (2005 = | & | provided in both the |
| | (2005 = 186) | 186) | Time | Invoice's and Freight |
| | First Main | First Main | | Statement's First Main |
| | Transport | Transport Leg: | | Transport Leg shall be |
| | Leg: | 0230-TDT-8051 = | | used for comparison. |
| | 0690-TDT- | 20 | | |
| | 8051 = 20 | | | |
| Vessel | 0690-TDT- | 0230-TDT-C222- | Alpha | *Vessel Name |
| Name | C222-8212 | 8212 | | provided in both the |
| | First Main | First Main | | Invoice's and |
| | Transport | Transport Leg: | | Freight Statement's |
| | Leg: | 0230-TDT-8051 = | | First Main |
| | 0690-TDT- | 20 | | Transport Leg shall |
| | 8051 = 20 | | | be used for |
| | | | | comparison. |
| Voyage | 0690-TDT- | 0230-TDT-8028 | Alpha | *Voyage Number |
| Number | 8028 | First Main | | provided in both the |
| | First Main | Transport Leg: | | Invoice's and |
| | Transport | 0230-TDT-8051 = | | Freight Statement's |
| | Leg: | 20 | | First Main |
| | 0690-TDT- | | | Transport Leg shall |
| | 8051 = 20 | | | be used for |
| | | | | comparison. |

Amount Details

| | | | | | |
|---|---|---|---|---|---|
| Total Net | 0160-MOA- | 0080-MOA- | Numeric | Y | |
| Amount | C516-5004 | C516-5004 (5025 = | | | |
| | (5025 = 125) | 125) | | | |
| Total Tax | 0160-MOA- | 0080-MOA- | Numeric | Y | |
| Amount | C516-5004 | C516-5004 (5025 = | | | |
| | (5025 = 124) | 124) | | | |
| Payment | 0230-CUX- | 0070- | Alpha | | Utilizes standard 3- |
| Currency | C504-6345 | CUX- | | | character |
| | (6343 = 11) | C504- | | | ISO currency code |
| | | 6345 | | | (ISO |
| | | (6343 = | | | 4217) |
| | | 11) | | | |
| Exchange | 0050-FTX- | 0090-FTX-C108- | Numeric | Y | |
| Rate | C108-4440 | 4440 (4451 = | | | |
| | (4451 = | AAK) | | | |
| | AAK) | | | | |

Commodity Details

| | | | | | | |
|---|---|---|---|---|---|---|
| HS Code | 0840-PIA-C212- | 0090-FTX- | Alpha | | Y | |
| | 7140 (7143 = | C108-4440 | | | | |
| | HS) | (4451 = AAA) | | | | |
| Hazardous | 0960-DGS-8273 | 0090-FTX- | Alpha | | | *Hazardous Indicator |
| Indicator | (8273 = IMD) | C108-4440 | | | | within a particular HS |
| | | (4451 = AAA) | | | | Code |
| Container | 0990-EQD- | 0940-EQD- | Alpha | | Y | |
| Number | C237-8260 | C237-8260 | | | | |
| | (1131 = 146) | (1131 = 146) | | | | |
| Non Active | 1070-FTX- | 0960-FTX- | Alpha | | | *Non Active Reefer |
| Reefer | C107-4441 | C107-4441 | | | | Indicator within a |
| Indicator | (4441 = NAR) | (4441 = NAR) | | | | particular Container |
| | | | | | | Number |
| Number of | | | Numeric | Y | | *Derived value from the |
| Containers | | | | | | list of Container |
| | | | | | | Number(s) |

a) Matching by Header Fields

Automatch validates header items by using the header field name as the matching key and then compares the actual values provided between the invoice and the freight statement for that field.

The following rules are used when automatching Header Fields:
1. A Business Rule must be defined for a Header Field before Automatch can validate its value.
2. Automatch will only execute the Business Rule defined for the Header Field if values are provided in both the invoice and the freight statement. The Business Rule will be skipped if at least one of the documents (invoice or freight statement) didn't provide any value.

| | |
|---|---|
| Header Rule: | Contract Number, Exact Match |

| Invoice | Freight Statement | Result |
|---|---|---|
| ABC-12345 | ABC-12345 | OK |
| DEF-12345 | ABC-12345 | Discrepancy |
| DEF-12345 | ABC-12345, DEF-12345 | OK |
| Not Provided | ABC-12345 | Rule Skipped |
| ABC-12345 | Not Provided | Rule Skipped |
| Not Provided | Not Provided | Rule Skipped |

b) Matching Special Header Fields

Hazardous Indicator and Non Active Reefer Indicator are both considered Special Header Fields. These fields are heavily dependent on other header fields and require special rules when performing Automatch. The Hazardous Indicator field is dependent on the HS code, and correspondingly, the Non Active Reefer Indicator is dependent on the Container Number. The following rules are used when automatching Special header Fields:
1. A Business Rule must be defined for a Special Header Field before eInvoice Automatch can validate its value (see section 3.6.1 on Defining Header Rules).
2. A Special Header Field can only be validated if its dependent Header Field's value matches between the invoice and the freight statement.

| | |
|---|---|
| Header Rule: | Hazardous Indicator, Exact Match |

| Invoice | Freight Statement | Result |
|---|---|---|
| HS Code: 3602, | HS Code: 3602, | OK |
| Haz Indicator: HAZ | Haz Indicator: HAZ | |
| HS Code: 3602, | HS Code: 3602, | Discrepancy |
| Haz Indicator: Blank | Haz Indicator: HAZ | |
| HS Code: 3602, | HS Code: 3602, | Discrepancy |
| Haz Indicator: Blank, HAZ | Haz Indicator: HAZ | |
| HS Code: 3602, | HS Code: 3602, | OK |
| Haz Indicator: Blank | Haz Indicator: Blank, HAZ | |
| HS Code: 3601, | HS Code: 3602, | Rule Skipped |
| Haz Indicator: HAZ | Haz Indicator: HAZ | |

3. Automatching Charge Line Items

The heart of Automatch invoice validation is all about checking for Charge Lines.

Automatch provides the capability of validating different items or fields on a particular charge line, example: quantity, rate, invoicing amount, etc. The following table lists the Charge Line Fields that can be automatched, as well as, additional information on these fields such as: inbound Invoice (IFTFCC) and Freight Statement (IFTFCA) EDIFACT message positions, data types, and whether the fields can have threshold comparisons.

| | Invoice | Freight Statement | | | |
|---|---|---|---|---|---|
| | Position-Segment- | Position-Segment- | | | |
| Charge Line | Element | Element | | Threshold | |
| Field | (Qualifier) | (Qualifier) | Type | Comparison | Remarks |
| Quantity | 0320-QTY-C186- | 0750-QTY-C186- | Numeric | Y | |
| | 6060 | 6060 | | | |
| Invoicing | 0390-CUX-C504- | 0740-MOA-C516- | Alpha | | Utilizes standard 3- |
| Currency | 6345 (6343 = 17) | 6345 (6343 = 4) | | | character ISO |
| | | | | | currency code (ISO |
| | | | | | 4217) |
| Exchange | 0300-FTX-C108- | 0810-FTX-C108- | Numeric | Y | |
| Rate | 4440 (4451 = AAK) | 4440 (4451 = AAK) | | | |
| Rate | 0340-PRI-C509- | 0710-PRI-C509- | Numeric | Y | |
| | 5118 (5125 = INV) | 5118 (5125 = INV) | | | |
| Invoicing | 0370-MOA-C516- | 0740-MOA-C516- | Numeric | Y | |
| Amount | 5004 (6343 = 4) | 5004 (6343 = 4) | | | |
| Payment | 0370-MOA-C516- | 0740-MOA-C516- | Numeric | Y | |
| Amount | 5004 (6343 = 11) | 5004 (6343 = 11) | | | |

a) Matching by Charge Codes or Charge Codes and Other Information (e.g. container size type)

Automatch validates charge line items by using the following as keys: Prepaid/Collect Indicator, Charge Code, possibly Container Size/Type, and Charge Line Field. Depending on the collapsing method chosen by the Payer, Container Size/Type may or may not be part of the keys.

| | Sample | By Charge Code & | By Charge |
|---|---|---|---|
| Charge Line Field | Value | Container Size/Type | Code |
| Prepaid/Collect Indicator | P or C | Key | Key |
| Charge Code | 101000 | Key | Key |
| Container Size Type Code | 40HC | Key | Ignored |
| Charge Line Field | Quantity | Key | Key |

Charge Line level Business Rules are defined using the combination of Charge Code+Charge Line Field names. The following rules are used when automatching Charge Line Fields:
1. A Business Rule must be defined for a Charge Code+Charge Line Field before Automatch can validate its value.
2. Automatch will only execute the Business Rule defined for a Charge Code+Charge Line Field if:
   a. It was able to find matching charge lines that are properly collapsed on both the invoice and freight statement.
   b. Values for the charge line field are provided in both the invoice and the freight statement.

Note: The Business Rule will be skipped if at least one of the above conditions is not met.

The following table provides some scenarios on automatching Charge Line Fields. Scenarios provided are with the assumption that successful collapsing has already occurred unless otherwise specifically stated. For simplicity, charge line examples are indicated using the following format:
For Invoice: <Prepaid/Collect Indicator>, <Charge Code>, <Charge Line Field Value for Quantity>
For Freight Statement: <Prepaid/Collect Indicator>, <Charge Code>, <Charge Line Field Value for Quantity>

| | |
|---|---|
| Charge Line Rules: | 101000, Quantity, Exact Match |
| | 101021, Quantity, Exact Match |
| | Collapsing Method: By Charge Code |

| Invoice | | | Freight Statement | | | | |
|---|---|---|---|---|---|---|---|
| Charge Line | | | Charge Line | | | Result | Remarks |
| P | 101000 | 1 | P | 101000 | 1 | OK | |
| P | 101000 | 2 | P | 101000 | 1 | Discrepancy | Automatch will raise a discrepancy on |
| | | | | | | | quantity for charge code |
| | | | | | | | 101000 |
| P | 101000 | 1 | P | 101000 | 1 | Non- | Non-Unique Charge line on invoice |
| P | 101000 | 2 | | | | collapsible | Automatch will proceed to look for other |
| | | | | | | Charge | charge lines to match |
| *certain fields caused | | | | | | | |
| invoice charges to be | | | | | | | |
| non-collapsible | | | | | | | |
| P | 101000 | 2 | P | 101000 | 1 | Non- | Non-Unique Charge line on freight statements |
| | | | P | 101000 | 1 | collapsible | Automatch will proceed to look for other |
| | | | | | | Charge | charge lines to match |
| | | | *certain fields caused | | | | |
| | | | freight statement | | | | |
| | | | charges to be non- | | | | |
| | | | collapsible | | | | |
| P | 101021 | | P | 101021 | 1 | Rule Skipped | All-in-Charge Code with Quantity value not |
| | <Blank> | | | | | | provided on invoice |

b) Business Rules for Any Charge Codes

Defining Charge Line Business Rules using the combination of Charge Code+

Charge Line Field allows for detailed automatching of charge line items on the invoice and freight statement. However, there may be instances where a Business Rule is required for all types of charge codes.

Automatch provides the flexibility of defining Business Rules that apply for all types of charge codes. This feature allows Payers to setup Business Rules that need not be specific to a particular charge. These types of Business Rules serve as a wildcard or a catch-all to ensure that such rules are executed regardless of the type of charge that comes through on the invoice.

These types of Charge Line level Business Rules are defined using the combination of the “All Charge Codes” Indicator+Charge Line Field names. The following rules are used when automatching Charge Line Fields with “All Charge Code” Business Rules:
1. All rules that govern Business Rules defined for specific Charge Codes are also applicable to “All Charge Codes” Business Rules.
2. A Business Rule defined for a specific Charge Code+Charge Line Field will override the Business Rule that is defined for “All Charge Codes”+Charge Line Field. This means that Automatch will execute a Business Rule specific to a Charge Code and Charge Line Field, should it encounter a charge line with the exact charge code. The “All Charge Codes” Business Rule for the same Charge Line Field will be skipped for this charge line.

| Business Rule(s) | Matching Charge Lines | Result |
|---|---|---|
| 1. All Charges, Quantity, Exact Match | Charge Code = 101000 | Both Rules Executed |
| 2. 101000, Rate, Exact Match | Quantity = 1 | |
| | Rate = 100.00 | |
| 1. All Charges, Quantity, Exact Match | Charge Code = 101000 | Only Rule 1 Executes |
| 2. 101021, Quantity, >1 of original value | Quantity = 1 | |
| 1. All Charges, Quantity, Exact Match | Charge Code = 101000 | Only Rule 2 Executes |
| 2. 101000, Quantity, >1 of original value | Quantity = 1 | |

c) Detecting Missing & Additional Charges

Invoicing in the ocean freight industry is a complicated process; various steps and procedures involving different departments and disjointed systems, most often requiring manual interventions, are involved to eventually produce or validate a single invoice. Somewhere along this complicated process, mistakes can occur, resulting to charges either being left out of the invoice or accidently being added onto it.

Automatch has the capability to detect such mistakes by automatically checking for charge lines that do not have a corresponding pair on either the invoice or the freight statement. A charge line that only exists on the invoice but not on the freight statement will be raised as an “Additional Charge” discrepancy, while a charge line that only exists on the freight statement but not on the invoice will be raised as a “Missing Charge” discrepancy.

The following rules are used when checking for Additional or Missing Charges:
1. All Charge Lines from the Export Invoice (Prepaid) will be checked against All Charge Lines from the linked Export Freight Statement (Prepaid & Collect).
2. All Charge Lines from the Import Invoice (Collect) will only be checked against Collect Charges from either the linked Import Freight Statement or Export Freight Statement
3. Depending on the collapsing method chosen, Automatch will scan for charge lines using Charge Codes or Charge Code and Container Size/Type pairs that only exist on either the invoice or freight statement.
4. Charges detected as Additional and Missing will no longer have business rules executed on them as they do not have matching charge lines to validate against.

Note: Automatch performs additional and missing charge line detection independently of business rules setup within the system. However, if there are no business rules setup for the Biller-Payer combination, this will raise an Automatch exception and the Payer has to check the invoice manually.

d) Direction Checking of Export Invoice Charges

One of the unique features of Automatch is its capability to detect Prepaid Charges on the Export Invoice that should actually be meant as Collect Charges on the Import Invoice. This can also indirectly mean checking for charges that the Payer is unsure whether it should be paid as prepaid or collect during export invoice processing. This feature is called Direction Checking

The following rules are used when performing Direction Checking on the Export Invoice:
1. Direction Checking is only performed on Export Invoices.
2. Direction Checking is only possible if Payer sends in an Export Freight Statement containing both Prepaid and Collect Charges.
3. Depending on the collapsing method chosen by the Payer, each Prepaid Charge Code or Charge Code and Container Size/Type pair from the Export Invoice will be checked against the Freight Statement:
   a. If there are matching Prepaid Charge Lines from the Freight Statement, the Charge Line on the Invoice is considered to be in the correct charge direction.
   b. If there are no matching Prepaid Charge Lines, but instead matching Collect Charge Lines from the Freight Statement, the Charge Line on the Invoice is considered to be in the wrong charge direction.
4. Prepaid Charge Lines on the Export Invoice that are considered to be in the wrong direction will be raised as “Incorrect Prepaid/Collect Indicator” discrepancies
5. Business Rules will still be executed for Prepaid Charge Lines on the Export Invoice that are already raised as having wrong direction. These Prepaid Charge Lines will be checked against their corresponding Collect Charge Lines from the Export Freight Statement. Any further discrepancies resulting from the Business Rules will also be raised appropriately

e) Uncollapsible Charges

In some situations, charges are not collapsible. In those situations, the invoice is sent outbound and manual processing required.

f) Manual Processing Required Emails and EDIFACT Messages

When manual processing is required, emails and EDIFACT messages may be sent to the various users. The emails may indicate that no automatching is possible and only manual processing will be carried out. Or the users may be invited to resubmit the invoices and freight statements to resolve any uncollapsible charges.

C. Disputing Invoices and Resolving Disputes

Automatch was created with the primary objective of enabling automated checking and disputing of ocean freight invoices. The tedious and complicated task of manually comparing and checking individual invoices and charge lines can now be easily completed simply through defining Business Rules. In the long run, the ultimate goal is to eventually streamline invoicing and dispute resolution, through decreasing errors and process improvements as a result of analyzing the various statistics gathered from the Automatch executions.

As such, it is important to understand the Automatch process and how it goes about generating and resolving disputes. Why in certain situations Automatch is unable to continue with automated invoice validation and why a manual external intervention is required and how should such situations be handled.

1. Generating Disputes and Discrepancies

In general, discrepancies are generated based upon the Business Rules that the Payer has setup in the Automatch system.

However, some discrepancies can be raised, not as a direct result of Business Rules, but because of Automatch's processing or when additional checks are performed as part of Automatch execution.

Discrepancies can also be raised at different levels: invoice header level, as well as, at the charge line item level.

Automatch is designed to capture every single discrepancy raised on an invoice and send these details out to the Biller and Payer using the outbound COMDIS Dispute Submission EDIFACT message. As there is only one single COMDIS Dispute Submission message that goes out to capture all these information, it is important to distinguish individual item discrepancies from the overall reason why the invoice was disputed.

With respect to INTTRA's approach, individual item mismatches are called “discrepancies”, while the overall reason is then called the “dispute”. An invoice can have multiple discrepancies but can only have one overall dispute. Automatch will use the most prevalent “discrepancy” as the overall dispute.

The following are the rules governing how Automatch generates individual item discrepancies and how it determines which discrepancy should be the overall dispute:
1. No Discrepancies or Dispute will be raised if Automatch encounters processing exceptions, such as:
   Invoice or Freight Statement document processing or field validation failures
   Critical collapsing exceptions encountered
   No Business Rules were setup for the matching Biller and Payer pair
   Other internal Automatch processing failures
   Automatch will send out the invoice to the Payer (via outbound IFTFCC EDIFACT message) indicating an Automatch exception has occurred.
2. Header Level Discrepancies: for each Header Field that fails at least one business rule, a separate discrepancy will be raised.
3. Charge Line Discrepancies:
   a. For each Charge Line Field that fails at least one business rule, a separate discrepancy will be raised (see section 2.3.3 on Automatching Charge Line Items).
   b. Charge Lines can contain multiple discrepancies except for:
      i. A Charge Line that was raised with a “Non-Collapsible” discrepancy can no longer have other discrepancies raised (see section 2.2.3 on Collapsing Exceptions Case 2).
      ii. A Charge Line that was raised with an “Additional Charge” or “Missing Charge” discrepancy can no longer have other discrepancies raised (see section on Detecting Missing & Additional Charges).
   c. A Charge Line that was raised with “Incorrect Prepaid/Collect Indicator” discrepancy as a result of Direction Checking can still have other discrepancies raised against it (see section on Direction Checking of Export Invoice Charges).
4. Determining Overall Dispute (based on the most prevalent discrepancy):
   a. If at least one discrepancy code is aliased by the Biller:
      i. The Aliased Discrepancy Code with the highest occurrence will be the Overall Dispute.
      ii. If there are two or more Aliased Discrepancy Codes that are having the highest occurrence the Overall Dispute will be chosen based on the Aliased Discrepancy Code with the highest business rule field priority.
   b. If there are no discrepancy codes aliased by the Biller:
      i. The INTTRA Discrepancy Code with the highest occurrence will be the Overall Dispute.
      ii. If there are two or more INTTRA Discrepancy Codes that are having the highest occurrence the Overall Dispute will be chosen based on the INTTRA Discrepancy Codes with the highest business rule field priority.
   c. A business rule field with the highest priority (lowest number in table below) will be used in breaking a tie among highest Aliased Discrepancy Code or INTTRA Discrepancy Code:

| | Priority |
|---|---|
| Charge Line Field | |
| Rate | 1 |
| Quantity | 2 |
| Invoicing Currency | 3 |
| Invoicing Amount | 4 |
| Exchange Rate | 5 |
| Payment Amount | 6 |
| Header Field | |
| Contract Number | 51 |
| Contract Type | 52 |
| Contracts for Named | 53 |
| Accounts/Clients | |
| Quote Number | 54 |
| Total Net Amount | 55 |
| Number of Containers | 56 |
| Container Number | 57 |
| Total Tax Amount | 58 |
| Exchange Rate | 59 |
| Payment Currency | 60 |
| Place of Receipt | 61 |
| Place of Delivery | 62 |
| Port of Load | 63 |
| Port of Discharge | 64 |
| Actual Sail Date | 65 |
| Vessel Name | 66 |
| Voyage Number | 67 |
| HS Code | 68 |
| Hazardous Indicator | 69 |
| Non Active Reefer Indicator | 70 |

d. Discrepancy codes that are not related to any business rule fields (i.e. “Non-Collapsible”, “Additional Charge”, “Missing Charge”, “Incorrect Prepaid/Collect Indicator”) do not have priorities assigned and will be considered having the lowest priority when breaking a tie among highest Aliased Discrepancy Codes or INTTRA Discrepancy Codes.
e. Discrepancies raised from ALL-DIFF Comparison will not be used in determining the Overall Dispute

The following example illustrates how Discrepancies are raised and how the Overall Dispute is determined by Automatch:

| Invoice | Header | | Biller | |
|---|---|---|---|---|
| Header Field | Discrepancy | Discrepancy Description | Alias | Priority |
| Total Net Amount | DSH-7005 | Incorrect Net Amount | H-NETA | 55 |
| Number of | DSA-1015 | Incorrect Number of Containers | H-CONT | 56 |
| Containers | | | | |
| Invoice | Charge Line | | Biller | |
| Charge Line | Discrepancy | Discrepancy Description | Alias | Priority |
| 01 | DSC-9031 | Non-Collapsible Charge Line on | — | — |
| | | Freight Statement | | |
| 02 | DSC-9031 | Non-Collapsible Charge Line on | — | — |
| | | Freight Statement | | |
| 03 | DSC-9015 | Additional Charge Item | C-LINE | — |
| -- FS Line 03 | DSC-9020 | Missing Charge Item | C-LINE | — |
| 04 | DSA-1010 | Incorrect Prepaid/Collect Indicator | C-LINE | — |
| | DSC-1000 | Incorrect Rate Used or Charged | C-QRTE | 1 |
| | DSC-8015 | Incorrect Invoice Currency Amount | C-CAMT | 4 |
| 05 | DSC-8020 | Incorrect Quantity Charged | C-QRTE | 2 |
| | DSC-1000 | Incorrect Rate Used or Charged | C-QRTE | 1 |
| | DSC-8015 | Incorrect Invoice Currency Amount | C-CAMT | 4 |
| 06 | DSC-8015 | Incorrect Invoice Currency Amount | C-CAMT | 4 |
| Overall Dispute: | DSC-1000 | Incorrect Rate Used or Charged | C-QRTE | |

Note: If Biller did not provide aliases for discrepancy codes, the Overall Dispute for the same example above will be DSC-8015—Incorrect Invoice Currency Amount which is the most prevalent among the INTTRA Discrepancy Codes.

### Handling “Manual Processing Required” (MPR)

The strength of the Automatch product lies in its ability to automatically validate invoices, and correspondingly raise disputes should it find any inconsistencies, all without the need for any human intervention. However, as with any automated systems, there are certain limitations as to how far it can fully automate the whole invoice validation and dispute process.

There are various situations when Automatch is unable to continue with its automated process and thus requiring the Payer to check or process the invoice manually. Such situations are termed as “Manual Processing Required” or MPR.

The following are the rules governing how Automatch handles invoices that in Manual Processing Required (MPR) situations:
1. Invoices that go into MPR will never be processed by Automatch and thus will never have any disputes raised against them.
2. Whenever an invoice goes into MPR the outbound IFTFCC Invoice EDIFACT message needs to be sent out to the Payer to facilitate subsequent manual processing. The related Full Linked Credit Note (outbound IFTFCC EDIFACT message) for this invoice (if available) needs to be sent out to the Payer as well.
3. If an Export Invoice was previously MPR, any subsequent related Export Invoices will also go into MPR. Likewise, if an Import Invoice was previously MPR, any subsequent related Import Invoices will also go into MPR.

Note: The rationale behind why subsequent invoices are forced into MPR is because the Payer or Biller may have already started some manual processes that could potentially cause inconsistencies or confusion should Automatch attempts to validate any subsequent related invoices and automatically raise a corresponding dispute. Forcing subsequent invoices to also go into MPR will prevent Automatch execution.

### Understanding Invoice & Freight Statement States

Whenever Automatch executes to validate invoices, it needs to keep track of various conditions to ensure consistent results and avoid sending out wrong information that may confuse both the Biller and the Payer. One of the many conditions that Automatch checks are invoice and freight statement states; these states enable Automatch to precisely determine which invoices or freight statements can or cannot be used for its execution.

### Invoice States

| Invoice State | Explanation | Impact to Automatch |
|---|---|---|
| New | Invoice that has not yet been | Automatch can potentially use this invoice for |
| | processed by Automatch. | automated validation should it find a Freight Statement |
| | | to link |
| | | Should any prior related invoices are in MPR, |
| | | Automatch will also set this Invoice to MPR |
| Execute | Invoice is currently being processed | Automatch will validate the Invoice against the linked |
| | by Automatch. | Freight Statement and will: |
| | | 1. Raise a Dispute if it finds any discrepancies |
| | | 2. Set the Invoice to Used if no discrepancies are found |
| | | 3. Result in Invoice being in MPR if any exceptions |
| | | occur |
| Disputed | Invoice that Automatch had validated | Automatch can still potentially revalidate a Disputed |
| | and found discrepancies. | Invoice depending on various circumstances |
| Used | Invoice that Automatch had validated | No further automated revalidations from Automatch |
| | and found no discrepancies (also | will take place once an Invoice is in Used state. |
| | known as a “Perfect Match”). | |
| MPR | Invoice that requires Manual | No Automatch execution will take place for Invoices in |
| | Processing either due to | MPR. Any subsequent related invoices will also be in |
| | Automatch Exception or prior related | MPR |
| | Invoices that were already in MPR. | |
| Cancelled | Invoice has been cancelled as a result | No Automatch execution will take place for Invoices |
| | of a Full Linked Credit Note sent by | that are already Cancelled. A subsequent related |
| | the Biller. | Invoice sent by the Biller to correct the Cancelled |
| | | invoice will start from the New state |

### Freight Statement States

Note: For Export Freight Statements with Prepaid and Collect charges: Disputed, Available, and Used states will be tracked separately; that is, Prepaid states will be separate from Collect states. This allows flexibility for an Export Freight Statement to be used by Automatch to validate both an Export and an Import Invoice

| FS State | Explanation | Impact to Automatch |
|---|---|---|
| New | Freight Statement that has not yet | Automatch can potentially use this freight statement for |
| | been processed by Automatch. | automated invoice validation should it find an Invoice |
| | | to link |
| Execute | Freight Statement is currently being | Automatch will validate an Invoice against this linked |
| | used by Automatch for invoice | Freight Statement and will: |
| | validation. | 1. Set the Freight Statement to Disputed if it finds any |
| | | discrepancies on the Invoice |
| | | 2. Set the Freight Statement to Used if no discrepancies |
| | | are found on the Invoice |
| | | 3. Set the Freight Statement back to its prior state |
| | | (New, Replaced, or Available) if any exceptions occur |
| Disputed | Freight Statement that Automatch had used to | Automatch can only reuse a Disputed Freight |
| | validate an Invoice which resulted to | Statement for invoice validation if a Full Linked |
| | discrepancies being found. | Credit Note is used to set it to Available or if it was |
| | | Replaced by the Payer |
| Used | Freight Statement that Automatch had used to | Used Freight Statements can never be reused by |
| | validate an Invoice which resulted to a | Automatch for invoice validation. A New Freight |
| | “Perfect Match” or no discrepancies being | Statement must be sent by the Payer should a |
| | found. | subsequent Invoice requires automated validation; this |
| | | rare scenario only happens if a previous “Perfect |
| | | Match” Invoice was Cancelled and a New related |
| | | Invoice was sent by the Biller |
| Available | Freight Statement that was previously used by | Automatch can potentially reuse this freight statement |
| | Automatch in disputing an Invoice, but now | for automated invoice validation should it find an |
| | can be reused as a result of a Full Linked | Invoice to link |
| | Credit Note being sent by the Biller. | |
| Replaced | Freight Statement was replaced by Payer with | Automatch can potentially use this freight statement |
| | updated information. Only Freight Statements | for automated invoice validation should it find an |
| | that are in New, Replaced, or Disputed state | Invoice to link. Replaced Freight Statement occurs |
| | can be Replaced. | due to Payer correcting mistakes in their original |
| | | expected charges |
| Cancelled | Freight Statement has been cancelled by the | Cancelled Freight Statements can never be used by |
| | Payer. Only Freight Statements that are in | Automatch for invoice validation. A New Freight |
| | New, Replaced, or Disputed state can be | Statement must be sent by the Payer should an Invoice |
| | Cancelled. | requires automated validation. Cancelling a Freight |
| | | Statement is another means for Payer to correct |
| | | mistakes in their original expected charges |
| Expired | Freight Statement that has passed its validity | Expired Freight Statements can never be used by |
| | period. Expiry of a Freight Statement only | Automatch for invoice validation. A New Freight |
| | matters if it can still be previously used for | Statement must be sent by the Payer should an Invoice |
| | Automatch processing. As such, only Freight | requires automated validation. Expiring a Freight |
| | Statements that are in New, Replaced, | Statement ensures that outdated information is not |
| | Disputed, or Available state can be Expired. | used for invoice validation |

### Relating Invoices for Automatching

Checking invoices is a tedious task especially in the ocean freight industry. Sometimes, a Payer may need to check an invoice a couple of times before it is finally correct. Each time the invoice is corrected, the Payer needs to recheck the new invoice to ensure that all errors are corrected properly, and that no new mistakes are made as a result of the correction.

An organized accounts payable clerk would have some form of system to keep track of the chain of related invoices among the pile of invoices that he or she is responsible for. This would help in ensuring that past wrong invoices are properly issued a credit note and that new corrected invoices can be easily rechecked by referencing the previous documents (such as invoice accruals) that were used to dispute the wrong invoice. This tracking mechanism may sometimes be also useful for statistics purposes, or for tracing back previous disputes that may somehow be contributing to the misunderstanding between Billers and Payers

In the same way, Automatch also needs to keep track of the chain of related invoices when it goes about its invoice validation process. Automatch utilizes the Biller Company ID+Payer Company ID+Import/Export indicator+Bill of Lading Reference Number fields to chain related invoices together.

An Export Invoice will never be mixed up with an Import Invoice (for the same Biller-Payer pair) even though they may have the same Bill of Lading Reference Numbers as they refer to the same shipment but in the opposing trade direction.

### Automatch Invoice Validation Process

Invoice validation is a process that involves a series of repeatable steps. Different Billers and Payers may have varying approaches as to how they go about checking invoices, as well as, managing or resolving discrepancies between them. At high level, these different approaches can be summed up to two distinct steps: Checking and Disputing followed by Dispute Resolution.

Checking and Disputing involves the Biller sending an Invoice and the Payer cross checking it against their internal accruals to see if there are any discrepancies against what they expect. Should there be discrepancies; the Payer will raise a Dispute against the Invoice and Biller would need to cross check if the Dispute is valid. Naturally, if there is no Dispute, the Payer is expected to pay the Invoice.

Dispute Resolution involves the Biller replying to the Payer's Dispute, and Payer in return taking the appropriate action as a result of the Biller's reply. If the Biller acknowledges that there was an invoicing mistake, they will cancel the wrong invoice and reissue a new one with the appropriate correction. Payer will cross check the new invoice to ensure that all appropriate changes are done correctly. On the contrary, if Biller believes the invoicing was correct and Payer's Dispute is invalid, Payer would need to recheck their accruals, or sometimes even refer to their original agreements, in order to recheck the invoice. Dispute Resolution can be repeated multiple times until both parties finally agree on the correct invoice (or accrual).

In the same way, Automatch also follows the same two step approach when it goes about validating invoices automatically. In Automatch terminology, Checking and Disputing step is called the “Settlement Period”, while Dispute Resolution step is called the “Dispute Resolution Period”.

### Settlement Period

The purpose of the Settlement Period is to allow Payers enough time to send in a Freight Statement in order to allow automated invoice validation to take place. Ideally, Payers would have sent in their Freight Statements prior to Billers sending in Invoices.

The following rules are used by Automatch during Settlement Period processing:
1. Settlement Period wait time duration can be configured separately for both Import and Export Invoices (see section Configuring Settlement Period).
2. Settlement Period starts when Invoicing Portal successfully processes an Invoice from the Biller that has a Payer subscribed to Automatch Processing. The Settlement Period will be tied uniquely to the Invoice and any of its subsequent related invoices should any be sent before Automatch executes (see section on Relating Invoices for Automatching).
   a. Each group of related invoices will only have 1 Settlement Period at any given point in time if Automatch has not been executed for this Settlement Period
   b. Subsequent related invoices sent will never start a Settlement Period if one already exists
   c. An Invoice that cannot be related to any existing Invoices will start its own Settlement Period
3. An Invoice that has already been Cancelled (due to a Full Linked Credit Note) will never Start a Settlement Period. This only happens if Invoicing Portal completes its processing for a Full Linked Credit Note (due to concurrency) before the corresponding Invoice being cancelled is processed.
4. An Invoice that has its previous related invoices in MPR will never start a Settlement Period. This also implies that no Automatch execution will take place (see section Handling “Manual Processing Required” (MPR)).
5. Anytime within the Settlement Period:
   a. Billers have the option to correct their Invoice by cancelling it using a Full Linked Credit Note and reissuing a New Invoice.
   b. Payers have the option to correct their Freight Statement either through directly Replacing them or Cancelling and reissuing a New Freight Statement.
6. Once Settlement Period elapses, Automatch will check if there is a linked Invoice and Freight Statement set for it to start automated invoice validation. Automatch will only execute if the following conditions are satisfied:
   a. There is only 1 Active Invoice (Invoice State=New) in the entire group of related invoices and the Active Invoice must be the Latest Invoice in the group. This implies that all previous related invoices must have been Cancelled successfully using Full Linked Credit Notes and Latest Active Invoice is not in MPR state.
   b. There is only 1 Active Freight Statement (Freight Statement State=New, Replaced, Available, or Disputed with Full Linked Credit Note that can set it to Available). This implies that the Active Freight Statement must be the latest Freight Statement that can be linked.

The above two points further implies that Automatch will always use the latest documents when it performs automated invoice validation.
7. Once Settlement Period elapses and there is 1 Active Invoice but Automatch is unable to find 1 Active Freight Statement, the Invoice will go into MPR.
   a. If a Freight Statement cannot be found or the linked Freight Statement could not be used (Freight Statement State=Cancelled, Execute, Used, Expired, or Disputed but no Full Linked Credit Note that can set it to Available)—an e-mail notification will be sent to the Payer telling them that a linked Freight Statement could not be found

This same information will be indicated on the outbound IFTFCC Invoice EDIFACT message as Freight Statement does not exist for Invoice
b. If more than 1 Active Freight Statement is found—no e-mail notification will be sent; however, the outbound IFTFCC Invoice EDIFACT message will indicate that there was more than 1 Freight Statement found for this Invoice
8. Once Settlement Period elapses and Automatch is unable to find 1 Latest Active

Invoice, regardless if there was 1 Active Freight Statement, the following may occur:
a. If all related Invoices were Cancelled—no automated validation required since there is no Invoice to validate.
b. More than 1 Active Invoice—Automatch will raise an exception and state in the outbound IFTFCC Invoice EDIFACT message that Automatch was unable to execute due to insufficient documentation (see section on Automatch Exceptions).
c. Active Invoice is not the Latest—Automatch will raise an exception and state in the outbound IFTFCC Invoice EDIFACT message that Automatch was unable to execute due to insufficient documentation (see section on Automatch Exceptions).
d. Invoice Disputed over INTTRA i-Act—Automatch will raise an exception and state in the outbound IFTFCC Invoice EDIFACT message that Invoice was already disputed prior to Automatch (see sections on Automatch Exceptions and Manual Disputes vs. Automatch).
e. Latest Active Invoice in MPR—Automatch will raise an exception and state in the outbound IFTFCC Invoice EDIFACT message that Manual Processing has already started for this Invoice set (see sections on Automatch Exceptions and Handling “Manual Processing Required” (MPR)).
9. Once Automatch executes it can result to:
   a. A Dispute being raised—this is a result of Automatch finding discrepancies between the Invoice and Freight Statement. An outbound COMDIS Dispute Submission EDIFACT message will be sent to the Biller (and optionally to the Payer). The outbound IFTFCC Invoice EDIFACT message to the Payer will be held back and not sent in this case (see section on Raising Disputes and Holding Back Invoices).
   b. A “Perfect Match”—this is a result of Automatch not finding any discrepancies between the Invoice and Freight Statement. The outbound IFTFCC Invoice EDIFACT message will be sent to the Payer.
   c. A MPR Invoice—this is a result of Automatch raising an exception due to various reasons preventing it from being able to complete successfully. The outbound IFTFCC Invoice EDIFACT message will be sent to the Payer indicating that it resulted to MPR. This implies that subsequent related invoices will not be able to execute Automatch as well (see sections on Handling “Manual Processing Required” (MPR) and Automatch Exceptions). There may also be a situation where the biller's invoice was so lacking that it is returned to the biller for correction without forwarding to the payer.
10. Should Automatch successfully completes and raises a Dispute, this will start the Dispute Resolution Period.
11. On certain special scenario, Automatch may not be able to raise a Dispute even if it found discrepancies and was able to complete successfully without raising any exception. This only happens if a directly preceding related Invoice was a “Perfect Match” and previous related Invoices have already reached the maximum Automatch Dispute Cycles (see section on Limiting Automatch Dispute Cycles), and the current Invoice that was validated through Automatch had discrepancies. In such a situation, no outbound COMDIS Dispute Submission EDIFACT message will be sent to the Biller and the Invoice will go into MPR with the outbound IFTFCC Invoice EDIFACT message being sent to the Payer indicating that Invoice/Freight Statement was Automatched more than the set limit (see section on Automatch Exceptions).

a) Raising Disputes and Holding Back Invoices

Automatch is designed in such a way that an outbound IFTFCC Invoice

EDIFACT message is held back (and not sent to the Payer) whenever a Dispute was raised as a result of automated validation. This prevents the Payer's own systems or processes from continuing with any downstream invoice processing whenever there is an outstanding and unresolved automated dispute.

If automated validation has completed successfully without discrepancies or Automatch resulted to an exception being raised, the outbound IFTFCC Invoice EDIFACT message will be automatically sent out to the Payer for further downstream processing.

Whenever the outbound IFTFCC Invoice EDIFACT message was held back, it will only be sent out to the Payer in the following situations:
Automatch revalidates the Invoice during Dispute Resolution Period and results to:
   “Perfect Match”—Invoices are always released to the Payer whenever Automatch didn't find any discrepancies.
   Automatch Exceptions—Invoices are always released to the Payer whenever Automatch encounters an exception requiring manual processing (see sections on Handling “Manual Processing Required” (MPR) and Automatch Exceptions).
   Maximum Automatch Dispute Cycles Reached—Invoices are always released to the Payer whenever the set of related invoices have already reached the maximum Automatch Dispute Cycle Limit. This means that Automatch can no longer raise any further disputes should it find discrepancies during the revalidation process (see section on Limiting Automatch Dispute Cycles).
A manual Dispute was raised through the web interface of the invoicing portal which overrides the current automated dispute process. At any point in time a manual dispute is raised for a particular invoice, the whole set of related invoices is considered to be in MPR and will never be processed by Automatch (see section on Manual Disputes vs. Automatch).

Notes:
1. An outbound COMDIS Dispute Submission EDIFACT message will always be sent to the Biller (and optionally to the Payer) whenever Automatch was able to successfully raise a Dispute.
2. Holding back of outbound IFTFCC Invoice EDIFACT messages does not impact how a web platform for handling invoices presents the invoices online. Invoices will still be presented on the web once it has been successfully processed by the Invoicing Portal, regardless of any Automatch process.

b) Dispute Resolution Period and Check Time Intervals

The purpose of the Dispute Resolution Period is to allow a Biller to recheck the Disputed Invoice and take the necessary corrective action if required. It also allows a Payer to review their accruals, should the Biller reject their Dispute, and correspondingly adjust their Freight Statements, if necessary.

The following rules are used by Automatch during Dispute Resolution Period processing:
1. Dispute Resolution Period wait time duration is configured as a single common wait time for both Import and Export Invoices (see section Configuring Dispute Resolution Period).
2. Dispute Resolution Period starts when Automatch has successfully raised a Dispute as a result of automated invoice validation. The Dispute Resolution Period will be tied uniquely to the Disputed Invoice and any of its subsequent related invoices, should any be sent before Automatch executes again (see section on Relating Invoices for Automatching).
   a. Each group of related invoices will only have 1 Dispute Resolution Period at any given point in time if Automatch has not been executed for this Dispute Resolution Period
   b. Subsequent related invoices sent will never start a Dispute Resolution Period even if one does not exists as Dispute Resolution Period is only started as a result of an automated Dispute being raised
3. A Dispute Resolution Check Time Interval can be configured to enable small repeated interval checking of Biller and Payer completed actions that can potentially execute Automatch even before the Dispute Resolution Period elapses (see section Configuring Dispute Resolution Period).
   a. If Automatch is able to execute at any Dispute Resolution Check Time Interval it will proceed to automatically validate the Latest Active Invoice.
   b. If Automatch is unable to execute at any Dispute Resolution Check Time Interval, it will attempt to check again at the next interval.
   c. The final attempt to execute Automatch will be at the elapsing of the Dispute Resolution Period.
4. At each Dispute Resolution Check Time Interval, Automatch can only proceed to execute if a Dispute Response was received from the Biller and a corresponding updated document was sent as an action to the Dispute Response (see section on Responding to a Dispute).
   a. Biller Accepts Dispute—Biller must send a Full Linked Credit Note to Cancel the previous Invoice, as well as, issue a New related Invoice to correct the previous invoice's discrepancies. This process is collectively called the “Credit-Rebill”. Automatch will execute by comparing the Latest Active Invoice (as a result of the “Credit-Rebill”) against the Latest Active Freight Statement (sent either previously during the Settlement Period or during Dispute Resolution Period).
   b. Biller Rejects Dispute—Payer must send in a corrected Freight Statement either through directly Replacing the previous one or Cancelling and issuing a New one. Automatch will execute by comparing the Latest Active Invoice (sent either previously during the Settlement Period or during Dispute Resolution Period) against the Latest Active Freight Statement (which is the corrected Freight Statement sent during this Dispute Resolution Period).
   c. No Dispute Response—regardless if Biller issued a “Credit-Rebill” or Payer sends in a corrected Freight Statement, Automatch will not execute during the Dispute Resolution Check Time Interval as No Dispute Response was received. In this scenario, Automatch will only execute when the Dispute Resolution Period elapses.
5. At the elapsing of the Dispute Resolution Period, Automatch can only proceed to execute if either the Biller initiates a “Credit-Rebill” or the Payer sends in a corrected Freight Statement. If no responses are received, automatch does not run.
   a. “Assumed” Biller Accepts Dispute—Biller sends a Full Linked Credit Note to Cancel the previous Invoice, as well as, issues a New related Invoice to correct the previous invoice's discrepancies.
      Automatch will execute by comparing the Latest Active Invoice (as a result of the “Credit-Rebill”) against the Latest Active Freight Statement (sent either previously during the Settlement Period or during a preceeding Dispute Resolution Period).
      Notice that although a “Reject” response was sent by the Biller during the Dispute Resolution Period, it is ignored, and Automatch assumed that Biller had actually “Accepted” the dispute from the Payer.
   b. “Assumed” Biller Rejects Dispute—Payer sends in a corrected Freight Statement either through directly Replacing the previous one or Cancelling and issuing a New one.
      Automatch will execute by comparing the Latest Active Invoice (sent either previously during the Settlement Period or during a preceding Dispute Resolution Period) against the Latest Active Freight Statement (which is the corrected Freight Statement sent during this Dispute Resolution Period).
      Notice that although an “Accept” response was sent by the Biller during the Dispute Resolution Period, it is ignored, and Automatch assumed that Biller had separately informed the Payer to recheck as the invoice is correct based on their agreed terms.
   c. “Assumed” Biller-Payer Agreed Offline—both Biller and Payer sends in their corrected documents.
      Automatch will execute by comparing the Latest Active Invoice (as a result of the “Credit-Rebill”) against the Latest Active Freight Statement (which is the corrected Freight Statement sent during this Dispute Resolution Period).
      This special scenario usually happens if no Dispute Response was received by the Invoicing Portal. Automatch assumes that both Biller and Payer had come to some agreement and respectively corrected their own documents.
      Alternatively, dispute responses are always required.
6. Anytime prior to Automatch execution (either at each Dispute Resolution Check Time Interval or the at the elapsing of Dispute Resolution Period):
   a. Billers have the option to correct their Invoice by cancelling it using a Full Linked Credit Note and reissuing a New Invoice.
   b. Payers have the option to correct their Freight Statement either through directly Replacing them or Cancelling and reissuing a New Freight Statement.
7. At any point when Automatch executes, it will always compare the Latest Active Invoice (Invoice State=New or Disputed) against the latest linked Active Freight Statement (Freight Statement State=New, Replaced, Available, or Disputed with Full Linked Credit Note that can set it to Available). This is similar to what is being done during Settlement Period (refer to points 6, 7, and 8, under the Settlement Period section).
8. Once Automatch executes it can result to:
   a. A new Dispute being raised—this is a result of Automatch finding discrepancies between the Invoice and Freight Statement during revalidation. An outbound COMDIS Dispute Submission EDIFACT message will be sent to the Biller (and optionally to the Payer). The outbound IFTFCC Invoice EDIFACT message to the Payer will be held back and not sent in this case (see section on Raising Disputes and Holding Back Invoices).
   b. A “Perfect Match”—this is a result of Automatch not finding any discrepancies between the Invoice and Freight Statement during revalidation. The outbound IFTFCC Invoice EDIFACT message will be sent to the Payer.
   c. Maximum Automatch Dispute Cycles Reached—this is a result of Automatch finding discrepancies between the Invoice and Freight Statement during revalidation; however, previous related invoices were already disputed up to the limit set by the Payer (see section on Limiting Automatch Dispute Cycles). The current Invoice will go into MPR and no outbound COMDIS Dispute Submission EDIFACT message will be sent.
   d. A MPR Invoice—this is a result of Automatch raising an exception due to various reasons preventing it from being able to complete successfully during the revalidation process. The outbound IFTFCC Invoice EDIFACT message will be sent to the Payer indicating that it resulted to MPR. This implies that subsequent related invoices will not be able to execute Automatch as well.
   See also section 2.3.6 on Interpreting Automatch Results.
9. Should Automatch successfully complete the revalidation process and raises a new Dispute, this will again start a new Dispute Resolution Period.

c) Responding to a Dispute

A dispute resolution process involves a two way communication between the Biller and the Payer. The Payer is responsible for checking the invoice issued by the Biller and correspondingly raise a dispute should there be any discrepancies. While the Biller is responsible for responding to the Payer's dispute after looking into all the details. This process can repeat a couple of times until both Biller and Payer finally resolve the dispute

A Biller responds to a dispute by either Accepting or Rejecting it. A Biller Accepts a dispute, if after checking, they realize that the mistake is on their invoice. This would entail the Biller cancelling the invoice being disputed (using a Full Linked Credit Note) and issuing a new one with the appropriate corrections. On the other hand, a Biller

Rejects a dispute, if after checking, they realize that their invoice is correct; and that perhaps the Payer may have either misunderstood their agreement terms or had made some mistake in their own accruals. This would then entail the Payer rechecking their accruals or agreements to readjust their freight statement accordingly (see section on Dispute Resolution Period). It is advisable that a Biller always sends in their dispute responses in order to facilitate the automated dispute resolution process within the Automatch system.

A Biller can respond to a dispute by logging into the web-based interface to the invoicing portal and choose either to “Accept” or “Reject” the dispute for a particular invoice. Billers can also send in their dispute responses using the inbound COMDIS Dispute Response EDIFACT message.

Whenever a Biller sends in an inbound COMDIS Dispute Response EDIFACT message, the Invoicing Portal requires certain information to be populated in the EDIFACT file in order for a Dispute Response to be correctly associated to the appropriate Invoice that has an outstanding Dispute. The Biller can choose to provide either of the following:
Dispute ID—for each dispute raised, the portal will assign a unique ID that will be populated in the outbound COMDIS Dispute Submission EDIFACT message (see section on COMDIS Dispute Submissions). INTTRA will always attempt to use the portal's Dispute ID, if provided.
Biller Company ID+Invoice Number+Invoice Issue Date—If the portal's Dispute ID is not provided, portal's will use this set of keys to retrieve the Invoice and associate the Dispute Response to the last open Dispute (the dispute that was not yet responded to).

Note: The COMDIS Dispute Response EDIFACT message will fail if it was unable to find a matching outstanding dispute.

The following table provides more details on the exact location of these fields (used for associating a Dispute Response) within the inbound COMDIS Dispute Response EDIFACT message.

| | COMDIS |
|---|---|
| | Position-Segment-Element |
| Field | (Qualifier) |
| INTTRA Dispute ID | 0030-RFF-C506-1154 (1153 = ZZZ) |
| Biller Company ID | 0070-NAD-C082-3039 (3035 = RE) |
| Invoice Number | 0110-DOC-C503-1004 (1001 = 380) |
| Invoice Issue Date | 0120-DTM-C507-2380 (2005 = 149) |

The Biller's response to the dispute, whether it is “Accept” or “Reject” is also explicitly indicated on the inbound COMDIS Dispute Response EDIFACT message under the Beginning of Message (BGM) segment. This same response is also sent to the Payer on the outbound COMDIS Dispute Response EDIFACT message in the same segment. The following are examples of inbound and outbound COMDIS Dispute Response EDIFACT messages showing the “Accept” or “Reject” responses.

In addition to providing the actual dispute response (either Accept or Reject), the Biller must also provide a Dispute Response Reason (Code and Description), and optionally a free Text Memo along with their dispute response. The dispute reason and memo text allows the Biller to provide additional details as to why the dispute was accepted or rejected. To maintain consistency when providing dispute reasons, INTTRA maintains a list of standard Dispute Response Reason Code and Description listed under Appendix C Dispute Response Codes. And to further assist downstream automated dispute response processing, INTTRA's standard Dispute Response Codes can also be aliased; a process whereby INTTRA's codes are translated into Biller's or Payer's own internal system codes (or vice versa).

The Biller's Dispute Response Reason Code and Description, as well as, the free Text Memo are indicated on the inbound COMDIS Dispute Response EDIFACT message under the Adjustment Details (AJT) Segment Group—Position 140. The same details are also sent to the Payer on the outbound COMDIS Dispute Response EDIFACT message in the same segment group.

Notes:
1. Billers are also required to send in their own system's Dispute ID in the inbound

COMDIS Dispute Response EDIFACT messages. The Biller's Dispute ID will be sent as part of the outbound COMDIS Dispute Response EDIFACT message to the Payers, and will help in the communication process between Billers and Payers especially when manual dispute handling is required.

d) Limiting Automatch Dispute Cycles

Ideally, a dispute resolution process should not go on forever; somewhere along the lines of a Payer disputing and a Biller responding, both parties need to finally come to a resolution. In the same way, it would not be beneficial for both Billers and Payers should Automatch continue to repeatedly dispute an invoice indefinitely. As such, Automatch provides the capability for the Payer to limit the number of times disputes are raised for a set of related invoices. It is recommended that both Biller and Payer discuss and jointly agree on the appropriate Maximum Automatch Dispute Cycle.

The following rules are used by Automatch when determining whether Automatch has reached the maximum dispute cycles:
1. The Maximum Automatch Dispute Cycles can be configured for each Biller-Payer pair and applies to all Invoices that Automatch processes for the same pair (see section Configuring Max Automatch Dispute Cycles).
2. The Maximum Automatch Dispute Cycles limits the number of times a dispute can be raised for a set of related invoices (see section on Relating Invoices for Automatching). This implies that it also limits the number of times a Dispute Resolution Period can be started for the same group of related invoices.
3. The Maximum Automatch Dispute Cycles does not limit the number of times Automatch can be executed, nor does it limit the number of times a Settlement Period can be started.
4. Whenever Automatch successfully executes and finds discrepancies on the Invoice, it will check to make sure that the current Total Number of Disputes Raised for the group of related invoices has not exceeded the Maximum Automatch Dispute Cycles set for the Biller-Payer combination.
   a. If Total Number of Disputes Raised<Maximum Automatch Dispute Cycles—proceed to raise a Dispute and send the outbound COMDIS Dispute Submission EDIFACT message to the Biller (and optionally to the Payer). The outbound IFTFCC Invoice EDIFACT message to the Payer will be held back and not sent in this case (see section on Raising Disputes and Holding Back Invoices).
   b. If Total Number of Disputes Raised=Maximum Automatch Dispute Cycles—raise an exception and place the Invoice into MPR. The outbound IFTFCC Invoice EDIFACT message will be sent to the Payer, and no outbound COMDIS Dispute Submission EDIFACT message will be sent.
   c. The Total Number of Disputes Raised will never be greater than the Maximum Automatch Dispute Cycles.

e) Manual Disputes vs. Automatch

One of the features of INTTRA's solution suite is that it enables customers to send and receive invoicing related information through various possible channels. Information can flow in and out of the INTTRA system via online web interfaces, Electronic Data Interchange (EDI), and even through e-mails. INTTRA's system ensures consistency of information flow across the different channels.

In relation to Automatch, Disputes and Dispute Responses can come from multiple channel sources. A Dispute can either be raised automatically via Automatch or it can be raised manually by a Payer user logging into the web interface of the invoicing portal. Dispute Responses, on the other hand, can be sent via inbound COMDIS Dispute Response EDIFACT messages or through a Biller user logging into the web interface of the invoicing portal and choosing to “Accept” or “Reject” an open invoice dispute.

The following rules are used by Automatch to ensure consistency between Dispute Responses sent via the inbound COMDIS Dispute Response EDIFACT message and Dispute Responses submitted by a Biller through web-based interface to the invoicing portal:
1. Whenever an inbound COMDIS Dispute Response EDIFACT message is received by INTTRA eInvoice, it will only be processed if the Invoice has an outstanding dispute (either raised by Automatch or raised manually by Payer through INTTRA web portal and no response has been received previously).
2. Whenever a Dispute Response is submitted by a Biller through the INTTRA web portal, it will in the same way, check if the Invoice has an outstanding dispute that has not already been responded. Should a response already exist, the INTTRA web portal will raise an error message stating that the Invoice had already changed its status.
3. Whether a Biller's Dispute Response is sent via inbound COMDIS Dispute Response EDIFACT message, or submitted through the INTTRA web portal, the Biller's dispute response is always sent to the Payer via an outbound COMDIS Dispute Response EDIFACT message.

The following rules are used by Automatch to ensure consistency between Disputes raised by Automatch and Disputes raised manually by a Payer the web interface of the invoicing portal:
1. Whenever Automatch successfully executes and finds discrepancies on the Invoice, it will check to make sure that there are no outstanding disputes for the same Invoice before it proceeds to raise the automated dispute.
   a. Should Automatch finds an outstanding dispute (in this case from the INTTRA web portal and regardless if Biller has responded), it will place the Invoice into MPR and outbound the IFTFCC Invoice EDIFACT message to the Payer, no outbound COMDIS Dispute Submission EDIFACT message will be sent in this case.
   b. If there are no outstanding dispute (in this case from INTTRA web portal), Automatch will proceed with other checks and eventually raise the Dispute and send the outbound COMDIS Dispute Submission EDIFACT message to the Biller (and optionally to the Payer).
2. Whenever a Manual Dispute is raised by the Payer through the INTTRA web portal, Automatch will no longer execute and the Invoice will be place into MPR.
   a. If a Settlement Period or a Dispute Resolution Period is currently active, it will be terminated once the Manual Dispute has been raised by the Payer.
   b. Should Automatch manage to raise the automated dispute successfully just before the Manual Dispute was processed, the INTTRA web portal will raise an error message stating that the Invoice had already changed its status.
   c. A Manual Dispute raised through the INTTRA web portal will in the same way send an outbound COMDIS Dispute Submission EDIFACT message to the Biller (and optionally to the Payer).

Notes:
1. Automatch can process both Dispute Responses sent in via inbound COMDIS Dispute Response EDIFACT message or submitted by a Biller through the INTTRA web portal.
2. Once a Manual Dispute is raised for a particular Invoice, any subsequent related invoices will no longer be processed via Automatch. Other non-related invoices will still continue to be processed via Automatch, if applicable. A Payer raising a dispute manually is equivalent to telling Automatch that they do not want automated disputes to be raised for this particular invoice.

### About ALL-DIFF Comparison

Disputes raised by Automatch, in general, are based on business rules setup by the Payer. When the Biller or Payer receives the outbound COMDIS Dispute Submission EDIFACT message, sometimes just by looking at the invoice fields that contain discrepancies, it may not be sufficient to fully resolve the actual cause for the dispute. This is because invoice fields that may not have actually raised a discrepancy, due to how business rules were setup, could potentially be the actual root cause of the dispute. As such, it is also important for the Biller and Payer to be able to analyze the other set of invoice fields that didn't happen to raise any discrepancies. Automatch enables this capability through the “ALL-DIFF” comparison feature.

ALL-DIFF Comparison performs a sweeping check on all the disputable fields between the Invoice and the linked Freight Statement, and similarly raises a discrepancy much like those raised though a Business Rule. ALL-DIFF Comparison acts as an additional check that attempts to provide more information to support the actual discrepancies found through Business Rules.

The following rules are used by Automatch when performing ALL-DIFF Comparison between an Invoice and a linked Freight Statement:
1. A Biller or a Payer has the option to choose whether or not to perform ALL-DIFF Comparison during Automatch Processing
2. ALL-DIFF Comparison will only take place if Automatch was able to successfully link an Invoice to a Freight Statement
3. ALL-DIFF Comparison on Charge Line Items will only be performed if Automatch was able to successfully collapse the line items on both Invoice and Freight Statement
4. ALL-DIFF Comparison utilizes an “Exact Match” comparison and will skip fields that do not have values provided on either the Invoice, Freight Statement, or both
5. ALL-DIFF Comparison is performed only on Header and Charge Line fields for which a Business Rule can be setup.
6. ALL-DIFF Comparison is performed on all valid Header and Charge Line fields regardless if Business Rules were setup for these fields.
7. The following rules that are used for Business Rules execution also applies to ALL-DIFF Comparison:
   a. Alpha and Numeric Comparison Rules
   b. List Values Comparison Rules
   c. Handling Exchange Rate Comparisons
   d. Matching by Header Fields
   e. Matching Special Header Fields
   f. Matching by Charge Codes
8. ALL-DIFF Comparison does not perform Direction Checking of Export invoice Charges. As such, Prepaid Charges on the Export Invoice will only go through ALL-DIFF Comparison if a matching Prepaid Charge is found on the linked Freight Statement.
9. ALL-DIFF Comparison discrepancies will only be raised if Automatch was able to raise a Dispute as a result of discrepancies from Business Rules executed or Non-Business Rule Checks (i.e. Additional Charge, Missing Charge, Non-Collapsible, and Direction Checking)

Notes
1. The rationale why ALL-DIFF Comparison is performed only when Disputes are raised is because it is meant as additional information to support a Dispute.
2. Interpreting Results

Interpreting Automatch results is equally important as understanding how Automatch validates invoices using linked freight statements. Interpreting the results enables both Billers and Payers to automate their own internal dispute management processes based upon the output of Automatch. It also helps to facilitate manual dispute resolution should the need arises when Automatch is unable to perform automated validation due to insufficient information on either the Invoice or Freight Statement or exceptions arising from Automatch execution.

Whenever disputes are raised, Automatch (through the Invoicing Portal) will send the dispute details to the Biller using the outbound COMDIS Dispute Submission EDIFACT message format. A Payer can also subscribe to receive a similar outbound message. Furthermore, certain Automatch dispute information can also be viewed online when the Biller or Payer logs onto the web interface of the invoicing portal, for sample screen shots refer to Appendix F Sample i-Act Dispute Screens.

Automatch utilizes a set of standard Discrepancy/Dispute Codes to tag reasons for raising a Dispute. These codes are made available as part of the Automatch results and can be used by Billers and Payers to automate downstream dispute processing. To further assist in such automated dispute processing, INTTRA's standard Dispute Codes can also be aliased; a process whereby INTTRA's codes are translated into Biller's or Payer's own internal system codes. These dispute codes are further explained in detail under Appendix B Discrepancy/Dispute Codes.

Whenever an Invoice is sent to the Payer via outbound IFTFCC Invoice EDIFACT message, additional information is also provided by Automatch to facilitate downstream invoice processing should there be a need for manual handling (see section on Handling “Manual Processing Required” (MPR)).

### COMDIS Dispute Submissions

For each Dispute raised by Automatch, Invoicing Portal will send an outbound COMDIS Dispute Submission EDIFACT message to the Biller (and optionally to the Payer). The Dispute Submission message will contain all the discrepancies found by Automatch during the automated invoice validation process (see section on Generating Disputes and Discrepancies). The same Dispute Submission message can also contain ALL-DIFF Comparisons should the Biller or Payer choose to receive them.

a) General Dispute Information

It is important to first understand the general information provided within the outbound COMDIS Dispute Submission EDIFACT message as it relates to a dispute raised by Automatch, before going into the very details of how discrepancies are actually presented on the EDIFACT message file.

One such information is the INTTRA Dispute ID. Each Dispute raised within INTTRA will be assigned a unique ID to help facilitate the association of Disputes to their corresponding Dispute Responses. The INTTRA Dispute ID is indicated in the outbound COMDIS Dispute Submission EDIFACT message under the Beginning of Message (BGM) segment and can be used by the Biller when responding to a particular dispute (see section on Responding to a Dispute).

The outbound COMDIS Dispute Submission EDIFACT message also contains general dispute information such as:
Invoice Number—refers to the invoice being disputed
Invoice Issue Date—refers to the date when the disputed invoice was issued
Invoice Dispute Count—refers to the number of times when a dispute has been raise for the particular invoice (either through Automatch or through INTTRA web portal)
Dispute Creation Method—refers to the source of the dispute submission: either a dispute raised automatically by Automatch, or manually by the Payer through the web interface of the invoicing portal

Note: For other general dispute information (such as parties, references, commodity details, or amounts) that are also provided in the outbound COMDIS Dispute Submission EDIFACT message, kindly consult the Message Implementation Guides available for each of the EDIFACT message types.

b) Overall Dispute Details Whenever a Dispute is raised in INTTRA eInvoice, either automatically through

Automatch or manually through INTTRA web portal, an Overall Dispute Reason Code and Description is sent in the COMDIS Dispute Submission EDIFACT message. The

### Overall

Dispute Reason serves as the main cause as to why the invoice is being disputed. With respect to Automatch, the Overall Dispute Reason is always determined from the most prevalent discrepancy (see section on Generating Disputes and Discrepancies).

The Overall Dispute Reason Code and Description is indicated in the COMDIS Dispute Submission EDIFACT message under the Free Text (FTX) Segment Group—Position 160.

To facilitate smoother dispute processing within the Biller's or Payer's own systems, aliasing can also be setup for the Overall Dispute Reason Code

c) Discrepancy Details

A Dispute can contain more than one Discrepancy (see section on Generating Disputes and Discrepancies), which can either be discrepancies raised through Business Rules and Non-Business Rule Checks (collectively known as Invoice Discrepancies), or as a result of ALL-DIFF Comparison (see 2.3.5 section on About ALL-DIFF Comparison). Invoice Discrepancies and ALL-DIFF Discrepancies can come from either a Header Item or a Charge Line Item.

All types of Discrepancies are indicated in the COMDIS Dispute Submission EDIFACT message under the Document Line Identification (DLI) Segment Group—Position 200, which is composed of:
1 Document Line Identification (DLI) segment, followed by
1 or more Adjustment Details (AJT) Segment Subgroups, with:
   1 Adjustment Details (AJT) segment, followed by
   1 or more Free Text (FTX) segments

The EDIFACT Document Line Identification (DLI) segment is used to distinguish Invoice Discrepancies from ALL-DIFF Discrepancies; while the Adjustment Details (AJT) segment is used to distinguish between Header Item Discrepancies and Charge Line Item Discrepancies. The actual details of any discrepancy will be indicated under the Free Text (FTX) segments

d) Header Item Invoice Discrepancies

Header Item Invoice Discrepancy details are indicated in the COMDIS Dispute

Submission EDIFACT message under the Adjustment Details (AJT) Segment Subgroup—Position 230 (qualified under AJT segment as 58—Header Item Discrepancies). Each Header Item Invoice Discrepancy raised will have one corresponding FTX+ABO line generated; and all the FTX+ABO lines will be contained in one AJT segment (position 240).

To facilitate smoother dispute processing within the Biller's or Payer's own systems, aliasing can also be setup for each of the Discrepancy Reason Codes

e) Charge Line Item Invoice Discrepancies

Charge Line Item Invoice Discrepancy details are indicated in the COMDIS Dispute Submission EDIFACT message under the Adjustment Details (AJT) Segment Subgroup—Position 230 (qualified under AJT segment as 48—Charge Line Item Discrepancies). Each Charge Line Item with at least 1 discrepancy will have one corresponding AJT segment (position 240) to identify the charge line, followed by one FTX+IND to identify the actual charge code and description, followed by one FTX+ABO for each discrepancy raised for the charge line.

To facilitate smoother dispute processing within the Biller's or Payer's own systems, aliasing can also be setup for Charge Codes and Discrepancy Reason Codes

f) ALL-DIFF Discrepancies

ALL-DIFF Discrepancies are only generated in the COMDIS Dispute Submission EDIFACT message if:
Biller or Payer has chosen to receive ALL-DIFF information, and
At least one Invoice Discrepancy has been raised

Similar to Header Item Invoice Discrepancies, ALL-DIFF Header Item Discrepancy details are also indicated in the COMDIS Dispute Submission EDIFACT message under the Adjustment Details (AJT) Segment Subgroup—Position 230 (qualified under AJT segment as 58—Header Item Discrepancies). Each ALL-DIFF Header Item Discrepancy raised will have one corresponding FTX+AEZ (instead of FTX+ABO) line generated; and all the FTX+AEZ lines will be contained in one AJT segment (position 240).

Similar to Charge Line Item Invoice Discrepancies, ALL-DIFF Charge Line Item Discrepancy details are also indicated in the COMDIS Dispute Submission EDIFACT message under the Adjustment Details (AJT) Segment Subgroup—Position 230 (qualified under AJT segment as 48—Charge Line Item Discrepancies). Each Charge Line Item with at least 1 ALL-DIFF discrepancy will have one corresponding AJT segment (position 240) to identify the charge line, followed by one FTX+IND to identify the actual charge code and description, followed by one FTX+AEZ (instead of FTX+ABO) for each ALL-DIFF discrepancy raised for the charge line.

ALL-DIFF Discrepancy details do not contain Discrepancy Reason Codes and Descriptions; this is because ALL-DIFF Discrepancies are meant to support actual discrepancies raised from Business Rules executed or Non-Business Rule Checks (i.e. Additional Charge, Missing Charge, Non-Collapsible, and Direction Checking)

### IFTFCC Invoice Message

Besides providing dispute and discrepancy information through the outbound COMDIS Dispute Submission EDIFACT message, Automatch also provides information through the outbound IFTFCC Invoice EDIFACT message that is sent to the Payer. This information helps Payers in determining how to automatically process the EDIFACT invoice especially when Automatch raises an exception that requires manual handling.

g) Invoice Dispute Count

Similar to the outbound COMDIS Dispute Submission EDIFACT message, the outbound IFTFCC Invoice EDIFACT message also contains the Invoice Dispute Count that refers to the number of times when a dispute has been raise for the particular invoice (either through Automatch or through INTTRA web portal). This information, although not directly related to Automatch processing, can be used by Payers to potentially alert them of invoices that have been repeatedly disputed and thus may require special attention.

### Automatch Status

One of the information provided in the outbound IFTFCC Invoice/Credit Note EDIFACT message is the Automatch Status flag. This flag tells the Payer whether an Invoice or Credit Note was processed by Automatch. The Automatch Status flag is indicated in the outbound IFTFCC Invoice/Credit Note EDIFACT message under the Document/Message Details (DOC) segment—Position 80.

The following table provides details on how to interpret the Automatch Status flag.

| | Automatch | |
|---|---|---|
| IFTFCC Type | Status | Remarks |
| Standard | ISM | One of the following possibilities: |
| Freight | | 1. Invoice has been successfully validated by Automatch without any |
| Invoice | | discrepancies and no dispute was raised (also known as a “Perfect Match”). |
| | | 2. Invoice was processed by Automatch (potentially with MPR) and a previous |
| | | Dispute was raised as a result of past Automatch validations. |
| Standard | ISN | One of the following possibilities: |
| Freight | | 1. Automatch is not enabled for the Biller-Payer combination (see section 3.5.1 |
| Invoice | | on Enabling Automatch Processing). |
| | | 2. A dispute was raised manually by a Payer through the web interface of the |
| | | invoicing portal before Automatch could perform automated invoice validation |
| | | (see section on Manual Disputes vs. Automatch). |
| | | 3. Automatch was unable to find a valid Freight Statement to perform automated |
| | | validation during Settlement Period (see also section 2.1 on Linking Invoices to |
| | | Freight Statements). |
| | | 4. Automatch was unable to find any business rules |
| | | to perform automated validation (see section on A Business Rule Driven |
| | | Automatch) |
| | | 5. Invoice was never processed by Automatch due to exceptions or system error. |
| Standard | ISM | Credit Note has been successfully processed by Automatch to unset charges on the |
| Freight | | Freight Statement that is linked to the Invoice being cancelled by the Full Linked |
| Full Linked | | Credit |
| Credit Note | | |
| Standard | ISN | One of the following possibilities: |
| Freight | | 1. Automatch is not enabled for the Biller-Payer combination |
| Full Linked | | 2. Related Freight Invoice was not processed by eInvoice |
| Credit Note | | Automatch. |
| | | 3. Credit Note was never processed by Automatch due to exceptions or system |
| | | error. |
| All Other | ISN | All other types of invoices and credit notes are not processed through Automatch: |
| Types | | Non-Standard Freight Invoices/Non-Standard Freight |
| | | Credit Notes (i.e. Detention & Demurrage) |
| | | Unlinked Credit Notes (i.e. credit notes not related to any previously issued |
| | | invoices) |
| | | Partial Linked Credit Notes (i.e. non-Full Linked Credit |
| | | Notes) |
| | | Linked Invoices (i.e. child invoices that add-on existing charges to the main |
| | | standard freight invoice) |
| Standard | ISM | One of the following possibilities: |
| Freight | | 1. Invoice has been successfully validated by Automatch without any |
| Invoice | | discrepancies and no dispute was raised (also known as a “Perfect Match”). |
| | | 2. Invoice was processed by Automatch (potentially with MPR) and a previous |
| | | Dispute was raised as a result of past Automatch validations. |
| Standard | ISN | One of the following possibilities: |
| Freight | | 1. Automatch is not enabled for the Biller-Payer combination (see section 3.5.1 |
| Invoice | | on Enabling Automatch Processing). |
| | | 2. A dispute was raised manually by a Payer through the web interface of the |
| | | invoicing portal before Automatch could perform automated invoice validation |
| | | (see section on Manual Disputes vs. Automatch). |
| | | 3. Automatch was unable to find a valid Freight Statement to perform |
| | | automated validation during Settlement Period (see also section 2.1 on Linking |
| | | Invoices to Freight Statements). |
| | | 4. Automatch was unable to find any business rules to perform automated |
| | | validation (see section on A Business Rule Driven Automatch) |
| | | 5. Invoice was never processed by Automatch due to exceptions or system |
| | | error. |
| Standard | ISN | Credit Note has been successfully processed by Automatch to unset charges on |
| Freight | | the Freight Statement that is linked to the Invoice being cancelled by the Full |
| Full Linked | | Linked Credit |
| Credit Note | | |
| Standard | ISN | One of the following possibilities: |
| Freight | | 1. Automatch is not enabled for the Biller-Payer combination (see section 3.5.1 |
| Full Linked | | on Enabling Automatch Processing). |
| Credit Note | | 2. Related Freight Invoice was not processed by eInvoice Automatch. |
| | | 3. Credit Note was never processed by Automatch due to exceptions or system |
| | | error. |
| All Other | ISN | All other types of invoices and credit notes are not processed through |
| Types | | Automatch: |
| | | Non-Standard Freight Invoices/Non-Standard Freight |
| | | Credit Notes (i.e. Detention & Demurrage) |
| | | Unlinked Credit Notes (i.e. credit notes not related to any previously issued |
| | | invoices) |
| | | Partial Linked Credit Notes (i.e. non-Full Linked Credit |
| | | Notes) |
| | | Linked Invoices (i.e. child invoices that add-on existing charges to the main |
| | | standard freight invoice) |

### Automatch Exceptions

The Automatch engine goes through a complex process when attempting to automatically validate an invoice from the Biller. This complex process also heavily relies on the information provided on the invoice and the freight statement, as well as, the appropriate actions taken by Billers and Payers during the dispute resolution process. As such, there can be occasions when exceptions occur, either due to data, processes, or unlikely system errors, which prevent Automatch from being able to successfully validate an invoice.

In most cases, exceptions occur not because of Automatch system errors; but because of the information provided on the invoice or freight statement, or in more extreme cases, failure of providing such information at the appropriate time for Automatch execution. In the unlikely event that Automatch raises an exception due to system errors, the following are some of the possible reasons:
Invoice or Freight Statement field validation failures
Critical collapsing exceptions
No Business Rule was setup for the Biller and Payer combination
Other internal Automatch processing errors

Whenever Automatch exceptions are raised, no Business Rules will be executed and no comparison takes place between invoice and linked freight statement. The invoice that encountered the exception will be sent to the Payer (via outbound IFTFCC Invoice EDIFACT message) indicating that an exception has occurred and the reason behind such exception.

Automatch provides a Reason Code and Description for the type of exception that was encountered in the outbound IFTFCC Invoice EDIFACT message to assist Payers in deciding how best to process the invoice. A Manual Resolution Required flag is also provided to inform Payers that they need to start manual processing for the invoice (see section on Handling “Manual Processing Required” (MPR)).

The following table provides a list of the Automatch Exception Reason Codes and Descriptions along with a brief explanation on why such exceptions were encountered.

| Reason | | |
|---|---|---|
| Code | Description | Explanation |
| 1 | Freight Statement | Automatch was not able to find a valid Freight Statement to link the |
| | does not exist for | Invoice for automated invoice validation upon elapsing of Settlement |
| | Invoice | Period. |
| 2 | More than 1 Freight | Automatch found more than one valid Freight Statement that can be |
| | Statement exists for | linked to the Invoice and is unable to proceed with automated invoice |
| | this Invoice | validation. This exception can occur when Automatch executes upon |
| | | elapsing of the Settlement Period or the Dispute Resolution Period. |
| 3 | No Business Rules | Automatch was unable to find Business Rules for the Biller-Payer |
| | Found | combination in order to perform automated invoice validation. This |
| | | exception can occur when Automatch executes upon elapsing of the |
| | | Settlement Period or the Dispute Resolution Period. |
| 4 | Invoice already | A manual dispute for the Invoice was raised by the Payer using the web |
| | disputed prior to | interface of the invoicing portal prior to Automatch execution. This |
| | Automatch | exception can occur anytime within the Settlement Period or the |
| | | Dispute Resolution Period when Automatch has not been executed. |
| 5 | Payer did not respond | <reserved for future implementations> |
| | to carrier's dispute | |
| | response | |
| 6 | Biller has not | Upon elapsing of the Dispute Resolution Period, Automatch did not |
| | responded to dispute | receive a dispute response from the Biller, nor any corrected |
| | generated from | documents either from Biller (“Credit-Rebill”) or Payer (corrected |
| | Automatch | Freight Statement) in order to proceed with automated invoice re- |
| | | validation. |
| 7 | Corrected Freight | During the Dispute Resolution Period, Biller sent a Reject dispute |
| | Statement was not | response; however, upon elapsing of the Dispute Resolution Period, |
| | submitted in time | Payer did not send a corrected Freight Statement in order for |
| | | Automatch to proceed with automated invoice re-validation. |
| 8 | Credit Rebill to cancel | During the Dispute Resolution Period, Biller sent an Accept |
| | the disputed Invoice was | dispute response; however, upon elapsing of the Dispute Resolution |
| | not submitted in time | Period, Biller did not send a Full Linked Credit Note to Cancel the |
| | | previous Disputed Invoice and issue a New related Invoice to |
| | | correct the discrepancies (“Credit-Rebill”) in order for Automatch |
| | | to proceed with automated invoice re-validation. |
| 9 | Dispute has been rejected | <reserved for future implementations> |
| | by payer | |
| 10 | Invoice/Freight Statement | Automatch found discrepancies on the Invoice but was unable to |
| | automatched more than | raise a dispute as the configured Maximum Automatch Dispute |
| | the set limit | Cycle has already been reached. This exception generally occurs |
| | | when Automatch executes upon elapsing of the Dispute Resolution |
| | | Period. On certain special scenarios, this exception may also occur |
| | | during Settlement Period. |
| 11 | Only Standard Freight | This reason code and description will be sent if Automatch is |
| | Invoices are processed | enabled for a Biller-Payer combination, and any of the following |
| | viaAutomatch | documents was sent for the same Biller-Payer combination: |
| | | Non-Standard Freight Invoices (i.e. Detention & Demurrage) |
| | | Linked Invoices (i.e. child invoices that add-on existing charges |
| | | to the main standard freight invoice)Automatch does not support |
| | | automated validation for such invoices. |
| 12 | Only Linked Credit Notes | This reason code and description will be sent if Automatch is |
| | to Automatched Freight | enabled for a Biller-Payer combination, and any of the following |
| | Invoices are processed | documents was sent for the same Biller-Payer combination: |
| | via Automatch | Non-Standard Freight Credit Notes (i.e. Detention & Demurrage) |
| | | Unlinked Credit Notes (i.e. credit notes not related to any |
| | | previously issued invoices) |
| | | Partial Linked Credit Notes (i.e. non-Full Linked Credit Notes) |
| | | Full Linked Credit Notes linked to Standard Freight Invoices that |
| | | were never processed by Automatch (for various reasons such as |
| | | system error or other exceptions) |
| | | Automatch does not support automated validation for such credit |
| | | notes. |
| 13 | Payer is not | This reason code and description will be sent if Automatch was not |
| | subscribed to | enabled for a Biller-Payer combination, regardless of the type of |
| | Automatch | document (i.e. Freight or non-Freight Invoices/Credit Notes) that was |
| | | sent for the same Biller-Payer combination (see section 3.5.1 on |
| | | Enabling Automatch Processing). |
| 14 | System encountered | Automatch was unable to execute successfully due to unexpected |
| | unexpected error | system error. This exception can occur when Automatch executes |
| | | upon elapsing of the Settlement Period or the Dispute Resolution |
| | | Period. |
| | | Note: INTTRA Support Centre should be contacted whenever such |
| | | exception has occurred. This will not only help in identifying and |
| | | eventually resolving the problem, but would also assist in future |
| | | process enhancements for Automatch. |
| 15 | No Business Rules | Automatch was unable to execute all the defined Business Rules due |
| | executed due to | to insufficient data. This only happens if all the defined Business Rules |
| | insufficient data | are validating fields that do not have a value on either the Invoice, |
| | | Freight Statement, or both. This exception can occur when Automatch |
| | | executes upon elapsing of the Settlement Period or the Dispute |
| | | Resolution Period. |
| | | See also section on A Business Rule Driven Automatch. |
| 16 | Manual Processing | This reason code and description will be sent if Automatch is enabled |
| | has started for this | for a Biller-Payer combination, and a Standard Freight Invoice was |
| | Invoice set. | sent for the same Biller-Payer combination but previous related |
| | | invoices were already set to MPR. |
| | | See also sections on Relating Invoices for Automatching and |
| | | Handling |
| | | “Manual Processing Required” (MPR). |
| 17 | Automatch unable to | This reason code and description will be sent if Automatch is enabled |
| | execute due to | for a Biller-Payer combination, and upon elapsing of the Settlement |
| | insufficient | Period or Dispute Resolution Period, Automatch executes and |
| | documentation | encounters the following: |
| | | More than 1 Active Invoice (New or Disputed) |
| | | Active Invoice is not the Latest Invoice (New or Disputed) |
| | | See also section on Handling “Manual Processing Required” (MPR). |

3. Applying Full Linked Credit Notes

Linked Credit Notes (or credit memos) are documents that a Biller sends to their

Payer either to partially adjust an incorrect charge on an Invoice or in some occasions to cancel an Invoice completely. Automatch supports the latter, which is a Full Link Credit Note that a Biller sends to cancel a previous Invoice.

A Biller must always provide the related invoice number and invoice issue date when sending Full Linked Credit Notes to the Invoicing Portal. This provides a means for Automatch to properly identify the Invoice that is being corrected by the credit note, and thereby apply (or “unset”) Freight Statement Charges that were previously used to matched against the same Invoice to raise the dispute.

The following rules are used when unsetting a linked Freight Statement's Charges for a corresponding Full Linked Credit Note:
Unsetting Charges on a Freight Statement simply means updating the Charges from “Disputed” to “Available” (see section on F ht Statement States)
A Full Linked Credit Note can only be used to unset a Freight Statement's Charges if the related Invoice was recently linked to the same Freight Statement for automated validation and dispute generation.
Only Freight Statement Charges belonging to the same direction of trade as the related Invoice (being cancelled by the Full Linked Credit Note) will be unset:
   Export Freight Statement Prepaid Charges are only unset if the related Invoice is an Export Invoice
   Export Freight Statement Collect Charges are only unset if the related Invoice is an Import Invoice
   Import Freight Statement Collect Charges are always unset since the related Invoice will always be an Import Invoice
All Freight Statement Charges belonging to the same trade direction as the related Invoice (being cancelled by the Full Linked Credit Note) will be unset:
   Even if the Freight Statement Charge Line appears on the related Invoice but not on the Full Linked Credit Note—it is assumed that a Full Linked Credit Note contains all Charge Lines from the related Invoice
   Even if the Freight Statement Charge Line does not appear on the related Invoice nor the Full Linked Credit Note—these are charge lines that were raised as missing charges (see section on Detecting Missing & Additional Charges)
   Even if the Freight Statement Charge Line does not have the same charge code, container size/type, quantity, rate, currency, or amounts as the related Invoice and Full Linked Credit Note—this allows the Freight Statement to go through another round of invoice revalidation where all Charges are rechecked (see section 2.3.3 on Automatching Charge Line Items)
Freight Statement Charges that has been “unset” (or made Available) can be reused by Automatch in a subsequent invoice validation process.

The following table provides some scenarios on unsetting Freight Statement Charges. For simplicity, charge line examples are indicated using the following format:
For Linked Credit Note: <Prepaid/Collect Indicator>, <Charge Code>,

### <Invoicing Amount>

For Freight Statement: <Prepaid/Collect Indicator>, <Charge Code>, <Invoicing Amount>, <Disputed/Available>

| Linked Credit | | | | | | | | | |
|---|---|---|---|---|---|---|---|---|---|
| Note | | Freight Statement Charge | | | | Result | | | |
| Charge Line | | Line (Before Unsetting) | | | | (After Unsetting) | | | Remarks |
| Export FLCN: | | Export FS: | | | | Export FS: | | | Only Charges belonging to the same |
| P | 101000 | P | 101000 | 100.00 | | P | 101000 | | direction of trade will be unset. |
| | 100.00 | | D C | 101000 | | | 100.00 | A C | |
| | | | 100.00 | D | | | 101000 | | |
| | | | | | | | 100.00 | D | |
| Import FLCN: | | Export FS: | | | | Export FS: | | | Only Charges belonging to the same |
| C | 101000 | P | 101000 | 100.00 | | P | 101000 | | direction of trade will be unset. |
| | 100.00 | | D C | 101000 | | | 100.00 | D C | |
| | | | 100.00 | D | | | 101000 | | |
| | | | | | | | 100.00 | A | |
| Import FLCN: | | Export FS: | | | | Export FS: | | | All Charges belonging to the same |
| C | 101000 | P | 101000 | 100.00 | | P | 101000 | | direction of trade will be unset even if |
| | 200.00 | | D C | 101000 | | | 100.00 | D C | they are having a different charge |
| | | | 100.00 | D | | | 101000 | | code, container size/type, quantity, |
| | | | | | | | 100.00 | A | rate, currency, or amounts. |
| Import FLCN: | | Export FS: | | | | Export FS: | | | All Charges belonging to the same |
| C | 101000 | P | 101000 | 100.00 | D C | P | 101000 | 100.00 | direction of trade will be unset even if |
| | 100.00 | | 101000 | 100.00 | D C | D C | 101000 | 100.00 | they do not appear on the Full Link |
| | | | 101021 | 100.00 | D | A C | 101021 | 100.00 | Credit Note. |
| | | | | | | A | | | |

| Import FLCN: | | Import FS: | | | Import FS: | | | Import Freight Statement Charges |
|---|---|---|---|---|---|---|---|---|
| P | 101000 | P | 101000 | 100.00 | P | 101000 | | will all be unset since it can only |
| | 100.00 | | D P | 101000 | | 100.00 | A P | contain Prepaid Charges and will |
| | | | 100.00 | D | | 101000 | | always be only linked to an Import |
| | | | | | | 100.00 | A | Invoice and Import FLCN that only |
| | | | | | | | | contains Prepaid Charges. |

### IV. Other Considerations

The following types of codes are specifically used by Automatch Engine in the invoice validation process:
Company IDs—INTTRA established unique identifiers used to represent Carriers, Billers, and Payers (see section 2.1.1 on Invoice to Freight Statement Linking Keys).
Charge Codes—derived from a subset of the UN/ECE CEFACT Trade Facilitation Recommendation N^{o}. 23—Freight Cost Codes, and used to represent charge items on the invoice. See Appendix A for a full list of Automatch Charge Codes (also refer to section 2.2.1 on Resolving to INTTRA Standard Charge Codes).
Container Size/Types—utilizes standard 4-character ISO container size and type codes (see ISO 6346) to represent the size and type of a shipping container.
Currency Codes—utilizes standard 3-character ISO currency codes (see ISO 4217) to represent international currencies.
Location Codes—utilizes standard 5-character UN/ECE LOCODE to represent locations used in trade and transport with functions such as seaports, rail and road terminals, airports, post offices and border crossing points. See UN/LOCODE for a full list.
HS Code—INTTRA currently does not maintain a set of commodity codes; however, it is recommended that the Harmonized Commodity Description and Coding System (HS) developed by World Customs Organization (WCO) be used as a standard. For a full list of these codes refer to HS Nomenclature 2007 Edition.
Discrepancy/Dispute Codes—INTTRA created codes used to represent various discrepancy and dispute reasons.
Dispute Response Codes—INTTRA created codes used to represent various dispute responses.

Billers and Payers can choose to use the INTTRA standard codes in the inbound EDIFACT messages or send in their own system codes that are aliased to these standard codes. The key is to ensure that every Biller or Payer system codes are correctly aliased to the INTTRA standard codes to ensure accurate matching and validation of invoices against freight statements.

### A. Setting up Biller/Payer Companies

Before a Carrier, Biller, or Payer (Main Issuing Payer for Freight Statement, Prepaid Payer, or Collect Payer) can be recognized in the Automatch system, they need to be setup as companies in the Invoicing Portal.

Furthermore, Payer companies (Prepaid Payer or Collect Payer) need to be partnered with the Biller company in order to create a Payer-Biller combination that enables the creation of Business Rules.

### B. Enabling EDI Subscriptions

In order for Automatch to function and execute Business Rules, Billers need to be able to send in EDI Invoices and Payers need to be able to send in EDI Freight Statements into the Invoicing Portal. A Biller and a Payer needs to be subscribed for INTTRA EDIFACT messages in order for the system to process both inbound and outbound EDI files successfully.

With respect to Automatch, Billers are required to subscribe to Inbound IFTFCC Invoice/Debit Note/Credit Note EDIFACT message. Billers can also optionally subscribe to Inbound COMDIS Dispute Response, as well as, Outbound COMDIS Dispute Submission EDIFACT messages should they use EDI messages in their dispute resolution process.

Payers, on the other hand, are required to subscribe to Inbound IFTCCA Freight Statement EDIFACT message should Automatch be activated for any of their Billers. Payers can also optionally subscribe to the Outbound COMDIS Dispute Response, as well as, Outbound COMDIS Dispute Submission EDIFACT messages should they use EDI messages in their dispute resolution process.

In addition, it is recommended for Payers to also subscribe to the Outbound IFTFCC Invoice/Credit Note EDIFACT message should they use Automatch for automated invoice validation. The outbound EDI Invoice contains information related to Automatch processing results that may help Payers in deciding how to best further process the invoice in their own internal systems especially when manual processing may be required

### C. Subscribing to Email Notifications

The invoicing system is an event driven system. Each process, from Invoice or

Freight Statement message loading, to Automatch execution, to Dispute Handling, is triggered by some events occurring within the system. Events can occur as a result of either external (i.e. EDI message being sent) or internal (i.e. dispute being raised by Automatch) actions; and these actions can either be caused by an actual human user (i.e. clicking Dispute button from web portal) or by some other system events (i.e. Settlement Period elapsed).

The system provides a means for Billers and Payers to be alerted when certain events occur through Email Notifications.

### D. Configuring Preferences and Business Rules Options

Automatch provides various settings in the form of preferences that enables a Payer to have the flexibility of modifying how the engine processes invoices or freight statements when performing automatch

### Configuring Settlement Period

It is important to decide on the appropriate Settlement Period duration as this affects the very first Automatch execution for any particular invoice. The Settlement Period duration must be configured to allow sufficient time for Payers to send in Freight Statements for any particular Invoice in order to allow automated validation to take place; yet at the same time, it should not be set too long such that it affects the remaining time available to resolve any outstanding disputes before the Invoice is due for payment

Automatch provides a means to configure Settlement Period durations (or Wait Time) separately for Import and Export Invoices. This allows for even greater flexibility should the time needed in preparing for Freight Statements vary between trade directions.

Default Export Invoice Wait Time is 5 days, while default Import Invoice Wait Time is 2 days. Wait times are calculated by minutes regardless of weekends or public holidays and may have a +/−one minute difference due to machine processing cycles.

### Configuring Dispute Resolution Period

Equally important to deciding on the appropriate Settlement Period duration, deciding on the appropriate Dispute Resolution Period duration will in turn affect how Automatch re-executes to perform automated invoice re-validation. The Dispute Resolution Period duration must be configured to allow sufficient time for both Biller and Payer to take appropriate action on the outstanding dispute that was previously raised; yet at the same time, it should not be set too long such that it becomes a long drawn process

In addition, Automatch provides a means to configure Dispute Resolution Check Time Interval that enables small repeated interval checking of Biller and Payer completed actions that can potentially execute Automatch even before the actual Dispute Resolution Period elapses. Both Import and Export Invoices utilize one common Dispute Resolution Period duration (or Wait Time) and one common Dispute Resolution Check Time Interval Default Dispute Resolution Wait Time is 1 day, while default Dispute Resolution Check Time Interval is 6 hours. Wait times and intervals are calculated by minutes regardless of weekends or public holidays and may have a +/−one minute difference due to machine processing cycles.

### Configuring Max Automatch Dispute Cycles

Automatch also provides the flexibility to configure the number of times automated disputes are raised for a set of related invoices as a result of automated invoice validation (see section on Limiting Automatch Dispute Cycles). This is called the Maximum Automatch Dispute Cycle (or Max Automatch Iterations). It is important for Billers and Payers to discuss and agree on an optimum Maximum Automatch Dispute Cycle to facilitate subsequent manual invoice handling should the automated process fail to resolve any outstanding dispute.

Default Max Automatch Iterations is 2.

### Choosing Collapsing Methods

Payers can choose the method of collapsing similar Charge Lines. This is to allow flexibility for the Payers when representing line item charges in their freight statements. Collapsing methods are also known as “Freight Statement Charge Option” in the Automatch system. The two collapsing methods (or Freight Statement Charge Options) are:
Charge Code—all container Size/Types are ignored and are not required to be provided by the Payer when specifying charge lines in the Freight Statement.
Charge Code and Container Size Type—container Size/Types are required to be provided by the Payer when specifying charge lines in the Freight Statement.

### Setting Up Business Rules

Business Rules are the core of the Automatch Engine. Payers can configure both

Header (or invoice) level and Charge Line level Business Rules. As Business Rules are defined by Payer-Biller combination, this means that a set of unique Business Rules can be defined for each Biller that is enabled for Automatch with the Payer.

### 1. Defining Header Rules

Header level Business Rules can be defined. By default, when comparing items on the invoice, the “Condition” is always set to Exact Match. However, Automatch has the option of setting up Business Rules that allow for Threshold Comparisons on numeric fields.

Threshold Conditions can be:
Greater than x of original value—the value on the invoice field being compared cannot be greater than the original value on the freight statement plus the provided x value threshold. The x value is added to the freight statement's value before comparison.
Greater than x % of original value—the value on the invoice field being compared cannot be greater than the original value on the freight statement plus the provided x percent threshold. The x percentage is calculated off the freight statement's value and the result rounded to 8 decimal places before comparison.
Less than x of original value—the value on the invoice field being compared cannot be less than the original value on the freight statement minus the provided x value threshold. The x value is subtracted from the freight statement's value before comparison.
Less than x % of original value—the value on the invoice field being compared cannot be less than the original value on the freight statement minus the provided x percent threshold. The x percentage is calculated off the freight statement's value and the result rounded to 8 decimal places before comparison.

If a Threshold “Condition” has been selected, the value for the threshold can be entered through a “Threshold Percent/Amount” edit box.

### 2. Defining Charge Line Rules

Charge Line level Business Rules can be defined for specific charges on the invoice; furthermore, they can also be defined for any (or all) type of charges that come through the same invoice

### a) Business Rules for a Specific Charge

Charge Line level Business Rules that are defined for a specific charge can be done by selecting the “Rule Type” as Charge Line and then choosing the appropriate “INTTRA Charge Codes” from the Configuration section.

### b) Business Rules for All Charges

Charge Line level Business Rules that are defined for any (or all) types of charges can also be modified.

### Copying Business Rules

Automatch allows copying of Business Rules from one set of Payer-Biller combination to another set of Payer-Biller combination. This enables an organization to quickly duplicate an existing set of Payer Business Rules across different Payers within the same organization. Business Rules can only be copied if the following conditions are satisfied:
The Source Payer-Biller combination being copied from must have Active Business Rules
The Destination Payer-Biller combination being copied to must not have any

### Active Business Rules

The following tables describe various scenarios when Automatch executes upon the elapsing of Settlement Period or Dispute Resolution Period. It also provides information on which documents (Invoice, Credit Note, and Freight Statement) are used should Automatch executes, as well as, the different possible Automatch Exceptions that can be encountered.

Scenario Assumptions:
For Settlement Periods: An Export Invoice or an Import Invoice has been received that started Settlement Period
For Dispute Resolution Periods: A dispute was raised by Automatch that started the Dispute Resolution Period
Multiple Active Invoices upon Automatch execution are excluded from the scenarios
Multiple Active Freight Statements are excluded from the scenarios
Actual results once Automatch successfully completes are excluded from the scenarios
Automatch execution failures due to system unexpected errors are excluded from the scenarios
Credit-Rebill Received implies that a Full Linked Credit Note (cancelling a previous wrong invoice) was received and a subsequent corrected Invoice was sent by the Biller. This can happen multiple times but must always result to one Latest Active Invoice upon Automatch Execution.
Import or Export Freight Statement Received implies that a valid Freight Statement was received (New or Replaced). This can happen multiple times but must always result to one Latest Active Freight Statement that can be linked to the corresponding Invoice.
Blank entries imply that no Documents or Dispute Responses were received.

### E.1 Settlement Period Elapsed—Export Invoice

This section explains the various scenarios when Automatch executes upon elapsing of a Settlement Period that was started by an Export Invoice.

| | Biller | Credit- | | | | |
|---|---|---|---|---|---|---|
| | Dispute | Rebill | Import FS | Export FS | Possible Automatch | |
| Seq | Response | Received | Received | Received | Action | Comments |
| 1. | | | | | MPR - Freight | Automatch was not able to |
| | | | | | Statement does not | find a valid Export Freight |
| | | | | | exist for Invoice. | Statement to link the |
| | | | | | | Export Invoice. |
| 2. | | | Yes | | MPR - Freight | Automatch was not able to |
| | | | | | Statement does not | find a valid Export Freight |
| | | | | | exist for Invoice. | Statement to link the |
| | | | | | | Export Invoice. |
| 3. | | | | Yes | Automatch Executes - | Should dispute be raised, |
| | | | | | Links First Export | refer to E.2 and E.3. |
| | | | | | Invoice to Latest | |
| | | | | | Export FS | |
| 4. | | | Yes | Yes | Automatch Executes - | Should dispute be raised, |
| | | | | | Links First Export | refer to E.2 and E.3. |
| | | | | | Invoice to Latest | |
| | | | | | Export FS | |
| 5. | | Yes | | | MPR - Freight | Automatch was not able to |
| | | | | | Statement does not | find a valid Export Freight |
| | | | | | exist for Invoice | Statement to link the Latest |
| | | | | | | Export Invoice. |
| 6. | | Yes | Yes | | MPR - Freight | Automatch was not able to |
| | | | | | Statement does not | find a valid Export Freight |
| | | | | | exist for Invoice | Statement to link the Latest |
| | | | | | | Export Invoice. |
| 7. | | Yes | | Yes | Automatch Executes - | Should dispute be raised, |
| | | | | | Links Latest Export | refer to E.2 and E.3. |
| | | | | | Invoice to Latest | |
| | | | | | Export FS | |
| 8. | | Yes | Yes | Yes | Automatch Executes - | Should dispute be raised, |
| | | | | | Links Latest Export | refer to E.2 and E.3. |
| | | | | | Invoice to Latest | |
| | | | | | Export FS | |

Note: During Settlement Period, Biller Dispute Responses are not expected and will most likely fail as there is no outstanding dispute that can be matched to the dispute response

### E.2 Dispute Resolution Check Time Interval—Export Invoice

This section explains the various scenarios when Automatch can potentially execute during a Dispute Resolution Check Time Interval. The Dispute Resolution Period was started by a Dispute raised for an Export Invoice that was linked to an Export Freight Statement.

| | Biller | Credit- | | | | |
|---|---|---|---|---|---|---|
| | Dispute | Rebill | Import FS | Export FS | Possible Automatch | |
| Seq | Response | Received | Received | Received | Action | Comments |
| 1. | | | | | Wait for next Check Time | |
| | | | | | Interval or Period Elapsed | |
| 2. | Reject | | | | Wait for next Check Time | |
| | | | | | Interval or Period Elapsed | |
| 3. | Reject | | Yes | | Wait for next Check Time | |
| | | | | | Interval or Period Elapsed | |
| 4. | Reject | | | Yes | Automatch Executes - | Should dispute be |
| | | | | | Links Previous Export | raised, refer to E.2 |
| | | | | | Invoice to Latest Export | and E.3. |
| | | | | | FS | |
| 5. | Reject | | Yes | Yes | Automatch Executes - | Should dispute be |
| | | | | | Links Previous Export | raised, refer to E.2 |
| | | | | | Invoice to Latest Export | and E.3. |
| | | | | | FS | |
| 6. | Reject | Yes | | | Wait for next Check Time | |
| | | | | | Interval or Period Elapsed | |
| 7. | Reject | Yes | Yes | | Wait for next Check Time | |
| | | | | | Interval or Period Elapsed | |
| 8. | Reject | Yes | | Yes | Automatch Executes - | Should dispute be |
| | | | | | Links Latest Export | raised, refer to E.2 |
| | | | | | Invoice to Latest Export | and E.3. |
| | | | | | FS | |
| 9. | Reject | Yes | Yes | Yes | Automatch Executes - | Should dispute be |
| | | | | | Links Latest Export | raised, refer to E.2 |
| | | | | | Invoice to Latest Export | and E.3. |
| | | | | | FS | |
| 10. | Accept | | | | Wait for next Check Time | |
| | | | | | Interval or Period Elapsed | |
| 11. | Accept | | Yes | | Wait for next Check Time | |
| | | | | | Interval or Period Elapsed | |
| 12. | Accept | | | Yes | Wait for next Check Time | |
| | | | | | Interval or Period Elapsed | |
| 13. | Accept | | Yes | Yes | Wait for next Check Time | |
| | | | | | Interval or Period Elapsed | |
| 14. | Accept | Yes | | | Automatch Executes - | Should dispute be |
| | | | | | Links Latest Export | raised, refer to E.2 |
| | | | | | Invoice to Previous Export | and E.3. |
| | | | | | FS | |
| 15. | Accept | Yes | Yes | | Automatch Executes - | Should dispute be |
| | | | | | Links Latest Export | raised, refer to E.2 |
| | | | | | Invoice to Previous Export | and E.3. |
| | | | | | FS | |
| 16. | Accept | Yes | | Yes | Automatch Executes - | Should dispute be |
| | | | | | Links Latest Export | raised, refer to E.2 |
| | | | | | Invoice to Latest Export | and E.3. |
| | | | | | FS | |
| 17. | Accept | Yes | Yes | Yes | Automatch Executes - | Should dispute be |
| | | | | | Links Latest Export | raised, refer to E.2 |
| | | | | | Invoice to Latest Export | and E.3. |
| | | | | | FS | |

Note: During Dispute Resolution Check Time Interval, Automatch will only execute if a Dispute Response was received and a corresponding updated document (Invoice or Freight Statement) was received as an action to the Dispute Response

### E.3 Dispute Resolution Period Elapsed—Export Invoice

This section explains the various scenarios when Automatch executes upon elapsing of a Dispute Resolution Period that was started as a result of a Dispute being raised for an Export Invoice that was linked to an Export Freight Statement.

| | | | | | Possible | |
|---|---|---|---|---|---|---|
| | Biller Dispute | Credit-Rebill | Import FS | Export FS | Automatch | |
| Seq | Response | Received | Received | Received | Action | Comments |
| 1. | Reject | | | | MPR - | As Biller has Rejected |
| | | | | | Corrected | the Dispute, |
| | | | | | Freight | Automatch was not |
| | | | | | Statement | able to find a valid |
| | | | | | was not | corrected Export |
| | | | | | submitted in | Freight Statement to |
| | | | | | time | link the disputed |
| | | | | | | Export Invoice. |
| 2. | Reject | | Yes | | MPR - | As Biller has Rejected |
| | | | | | Corrected | the Dispute, |
| | | | | | Freight | Automatch was not |
| | | | | | Statement | able to find a valid |
| | | | | | was not | corrected Export |
| | | | | | submitted in | Freight Statement to |
| | | | | | time | link the disputed |
| | | | | | | Export Invoice. |
| 3. | Reject | | | Yes | Automatch | Should dispute be |
| | | | | | Executes - | raised, refer to E.2 and |
| | | | | | Links | E.3. |
| | | | | | Previous | |
| | | | | | Export | |
| | | | | | Invoice to | |
| | | | | | Latest Export | |
| | | | | | FS | |
| 4. | Reject | | Yes | Yes | Automatch | Should dispute be |
| | | | | | Executes - | raised, refer to E.2 and |
| | | | | | Links | E.3. |
| | | | | | Previous | |
| | | | | | Export | |
| | | | | | Invoice to | |
| | | | | | Latest Export | |
| | | | | | FS | |
| 5. | Reject | Yes | | | Automatch | Automatch assumes |
| | | | | | Executes - | Biller rejected by |
| | | | | | Links Latest | mistake. |
| | | | | | Export | Should dispute be |
| | | | | | Invoice to | raised, refer to E.2 and |
| | | | | | Previous | E.3. |
| | | | | | Export FS | |
| 6. | Reject | Yes | Yes | | Automatch | Automatch assumes |
| | | | | | Executes - | Biller rejected by |
| | | | | | Links Latest | mistake. |
| | | | | | Export | Should dispute be |
| | | | | | Invoice to | raised, refer to E.2 and |
| | | | | | Previous | E.3. |
| | | | | | Export FS | |
| 7. | Reject | Yes | | Yes | Automatch | Automatch assumes |
| | | | | | Executes - | both Biller and Payer |
| | | | | | Links Latest | agreed on corrections |
| | | | | | Export | for both sides. |
| | | | | | Invoice to | Should dispute be |
| | | | | | Latest Export | raised, refer to E.2 and |
| | | | | | FS | E.3. |
| 8. | Reject | Yes | Yes | Yes | Automatch | Automatch assumes both Biller |
| | | | | | Executes - Links | and Payer agreed on |
| | | | | | Latest Export | corrections for both sides. |
| | | | | | Invoice to Latest | Should dispute be raised, refer |
| | | | | | Export FS | to E.2 and E.3. |
| 9. | Accept | | | | MPR - Credit | As Biller has Accepted the |
| | | | | | Rebill to cancel the | Dispute, Automatch was not |
| | | | | | disputed | able to find a valid corrected |
| | | | | | Invoice was not | Export Invoice to link the |
| | | | | | submitted in time | previous Export Freight |
| | | | | | | Statement |
| 10. | Accept | | Yes | | MPR - Credit | As Biller has Accepted the |
| | | | | | Rebill to cancel the | Dispute, Automatch was not |
| | | | | | disputed | able to find a valid corrected |
| | | | | | Invoice was not | Export Invoice to link the |
| | | | | | submitted in time | previous Export Freight |
| | | | | | | Statement |
| 11. | Accept | | | Yes | Automatch | Automatch assumes Biller |
| | | | | | Executes - Links | accepted by mistake. |
| | | | | | Previous | Should dispute be raised, refer |
| | | | | | Export Invoice to | to E.2 and E.3. |
| | | | | | Latest Export FS | |
| 12. | Accept | | Yes | Yes | Automatch | Automatch assumes Biller |
| | | | | | Executes - Links | accepted by mistake. |
| | | | | | Previous | Should dispute be raised, refer |
| | | | | | Export Invoice to | to E.2 and E.3. |
| | | | | | Latest Export FS | |
| 13. | Accept | Yes | | | Automatch | Should dispute be raised, refer |
| | | | | | Executes - Links | to E.2 and E.3. |
| | | | | | Latest Export | |
| | | | | | Invoice to Previous | |
| | | | | | Export FS | |
| 14. | Accept | Yes | Yes | | Automatch | Should dispute be raised, refer |
| | | | | | Executes - Links | to E.2 and E.3. |
| | | | | | Latest Export | |
| | | | | | Invoice to Previous | |
| | | | | | Export FS | |
| 15. | Accept | Yes | | Yes | Automatch | Automatch assumes both Biller |
| | | | | | Executes - Links | and Payer agreed on |
| | | | | | Latest Export | corrections for both sides. |
| | | | | | Invoice to Latest | Should dispute be raised, refer |
| | | | | | Export FS | to E.2 and E.3. |
| 16. | Accept | Yes | Yes | Yes | Automatch Executes - Links | Automatch assumes both |
| | | | | | Latest Export | Biller and Payer agreed on |
| | | | | | Invoice to Latest Export FS | corrections for both sides. |
| | | | | | | Should dispute be raised, |
| | | | | | | refer to E.2 and E.3. |
| 17. | | | | | MPR - Biller has not | |
| | | | | | responded to dispute | |
| | | | | | generated from Automatch | |
| 18. | | | Yes | | MPR - Biller has not | |
| | | | | | responded to dispute | |
| | | | | | generated from Automatch | |
| 19. | | | | Yes | Automatch Executes - Links | Automatch assumes Payer |
| | | | | | Previous | realizes own mistake. |
| | | | | | Export Invoice to Latest | Should dispute be raised, |
| | | | | | Export FS | refer to E.2 and E.3. |
| 20. | | | Yes | Yes | Automatch Executes - Links | Automatch assumes Payer |
| | | | | | Previous | realizes own mistake. |
| | | | | | Export Invoice to Latest | Should dispute be raised, |
| | | | | | Export FS | refer to E.2 and E.3. |
| 21. | | Yes | | | Automatch Executes - Links | Automatch assumes Biller |
| | | | | | Latest Export | forgot to send dispute |
| | | | | | Invoice to Previous Export | acceptance. |
| | | | | | FS | Should dispute be raised, |
| | | | | | | refer to E.2 and E.3. |
| 22. | | Yes | Yes | | Automatch Executes - Links | Automatch assumes Biller |
| | | | | | Latest Export | forgot to send dispute |
| | | | | | Invoice to Previous Export | acceptance. |
| | | | | | FS | Should dispute be raised, |
| | | | | | | refer to E.2 and E.3. |
| 23. | | Yes | | Yes | Automatch Executes - Links | Automatch assumes both |
| | | | | | Latest Export | Biller and Payer agreed on |
| | | | | | Invoice to Latest Export FS | corrections for both sides. |
| | | | | | | Should dispute be raised, |
| | | | | | | refer to E.2 and E.3. |
| 24. | | Yes | Yes | Yes | Automatch | Automatch assumes both |
| | | | | | Executes - Links | Biller and Payer agreed on |
| | | | | | Latest Export | corrections for both sides. |
| | | | | | Invoice to Latest | Should dispute be raised, |
| | | | | | Export FS | refer to E.2 and E.3. |

Note: Upon elapsing of Dispute Resolution Period, Automatch will only execute if an updated document (Invoice or Freight Statement) was received regardless of the Dispute Response.

### E.4 Settlement Period Elapsed—Import Invoice

This section explains the various scenarios when Automatch executes upon elapsing of a Settlement Period that was started by an Import Invoice.

| | Biller | Credit- | Import | Export | | |
|---|---|---|---|---|---|---|
| | Dispute | Rebill | FS | FS | | |
| Seq | Response | Received | Received | Received | Possible Automatch Action | Comments |
| 1. | | | | | MPR - Freight Statement | Automatch was not able to |
| | | | | | does not exist for Invoice | find a valid Import Freight |
| | | | | | | Statement or an Export |
| | | | | | | Freight Statement (with |
| | | | | | | Collect Charges) to link the |
| | | | | | | Import Invoice. |
| 2. | | | Yes | | Automatch Executes - Links | Should dispute be raised, |
| | | | | | First Import Invoice to Latest | refer to E.7 and E.8. |
| | | | | | Import FS | |
| 3. | | | | Yes | Automatch Executes - Links | Should dispute be raised, |
| | | | | | First Import Invoice to Latest | refer to E.5 and E.6. |
| | | | | | Export FS (with Collect | |
| | | | | | Charges) | |
| 4. | | | Yes | Yes | Automatch Executes - Links | Import Freight Statement |
| | | | | | First Import Invoice to Latest | always takes precedence over |
| | | | | | Import FS | Export Freight Statement |
| | | | | | | when linking to an Import |
| | | | | | | Invoice. |
| | | | | | | Should dispute be raised, |
| | | | | | | refer to E.7 and E.8. |
| 5. | | Yes | | | MPR - Freight Statement | Automatch was not able to |
| | | | | | does not exist for Invoice | find a valid Import Freight |
| | | | | | | Statement or an Export |
| | | | | | | Freight Statement (with |
| | | | | | | Collect Charges) to link the |
| | | | | | | Latest Import Invoice. |
| 6. | | Yes | Yes | | Automatch Executes - Links | Should dispute be raised, |
| | | | | | Latest Import Invoice to | refer to E.7 and E.8. |
| | | | | | Latest Import FS | |
| 7. | | Yes | | Yes | Automatch Executes - Links | Should dispute be raised, |
| | | | | | Latest Import Invoice to | refer to E.5 and E.6. |
| | | | | | Latest Export FS (with | |
| | | | | | Collect Charges) | |
| 8. | | Yes | Yes | Yes | Automatch | Import |
| | | | | | Executes - | Freight |
| | | | | | Links Latest | Statement |
| | | | | | Import | always takes |
| | | | | | Invoice to | precedence |
| | | | | | Latest Import | over Export |
| | | | | | FS | Freight |
| | | | | | | Statement |
| | | | | | | when linking |
| | | | | | | to an Import |
| | | | | | | Invoice. |
| | | | | | | Should dispute |
| | | | | | | be raised, refer |
| | | | | | | to E.7 and E.8. |

Note: During Settlement Period, Biller Dispute Responses are not expected and will most likely fail as there is no outstanding dispute that can be matched to the dispute response.

### E.5 Dispute Resolution Check Time Interval—Import Invoice (Linked to Export FS)

This section explains the various scenarios when Automatch can potentially execute during a Dispute Resolution Check Time Interval. The Dispute Resolution Period was started by a Dispute raised for an Import Invoice that was linked to an Export Freight Statement.

| | Biller | Credit- | Import | Export | | |
|---|---|---|---|---|---|---|
| | Dispute | Rebill | FS | FS | | |
| Seq | Response | Received | Received | Received | Possible Automatch Action | Comments |
| 1. | | | | | Wait for next Check Time | |
| | | | | | Interval or Period Elapsed | |
| 2. | Reject | | | | Wait for next Check Time | |
| | | | | | Interval or Period Elapsed | |
| 3. | Reject | | Yes | | Automatch Executes - Links | Should dispute be raised, |
| | | | | | Previous Import Invoice to | refer to E.7 and E.8. |
| | | | | | Latest Import FS | |
| 4. | Reject | | | Yes | Wait for next Check Time | |
| | | | | | Interval or Period Elapsed | |
| 5. | Reject | | Yes | Yes | Automatch Executes - Links | Import Freight Statement |
| | | | | | Previous Import Invoice to | always takes precedence over |
| | | | | | Latest Import FS | Export Freight Statement |
| | | | | | | when linking to an Import |
| | | | | | | Invoice. |
| | | | | | | Should dispute be raised, |
| | | | | | | refer to E.7 and E.8. |
| 6. | Reject | Yes | | | Wait for next Check Time | |
| | | | | | Interval or Period Elapsed | |
| 7. | Reject | Yes | Yes | | Automatch Executes - Links | Should dispute be raised, |
| | | | | | Latest Import Invoice to | refer to E.7 and E.8. |
| | | | | | Latest Import FS | |
| 8. | Reject | Yes | | Yes | Wait for next Check Time | |
| | | | | | Interval or Period Elapsed | |
| 9. | Reject | Yes | Yes | Yes | Automatch Executes - Links | Import Freight Statement |
| | | | | | Latest Import Invoice to | always takes precedence over |
| | | | | | Latest Import FS | Export Freight Statement |
| | | | | | | when linking to an Import |
| | | | | | | Invoice. |
| | | | | | | Should dispute be raised, |
| | | | | | | refer to E.7 and E.8. |
| 10. | Accept | | | | Wait for next Check Time | |
| | | | | | Interval or Period Elapsed | |
| 11. | Accept | | Yes | | Wait for next Check Time | |
| | | | | | Interval or Period Elapsed | |
| 12. | Accept | | | Yes | Wait for next Check Time | |
| | | | | | Interval or Period Elapsed | |
| 13. | Accept | | Yes | Yes | Wait for next Check Time | |
| | | | | | Interval or Period Elapsed | |
| 14. | Accept | Yes | | | Automatch Executes - Links | Should dispute be raised, |
| | | | | | Latest Import Invoice to | refer to E.5 and E.6. |
| | | | | | Previous Export FS | |
| 15. | Accept | Yes | Yes | | Automatch Executes - Links | Should dispute be raised, |
| | | | | | Latest Import Invoice to | refer to E.7 and E.8. |
| | | | | | Latest Import FS | |
| 16. | Accept | Yes | | Yes | Automatch Executes - Links | Should dispute be raised, |
| | | | | | Latest Import Invoice to | refer to E.5 and E.6. |
| | | | | | Latest Export FS | |
| 17. | Accept | Yes | Yes | Yes | Automatch Executes - Links | Import Freight Statement |
| | | | | | Latest Import Invoice to | always takes precedence over |
| | | | | | Latest Import FS | Export Freight Statement |
| | | | | | | when linking to an Import |
| | | | | | | Invoice. |
| | | | | | | Should dispute be raised, |
| | | | | | | refer to E.7 and E.8. |

Note: During Dispute Resolution Check Time Interval, Automatch will only execute if a Dispute Response was received and a corresponding updated document (Invoice or Freight Statement) was received as an action to the Dispute Response.

### E.6 Dispute Resolution Period Elapsed—Import Invoice (Linked to Export FS)

This section explains the various scenarios when Automatch executes upon elapsing of a Dispute Resolution Period that was started as a result of a Dispute being raised for an Import Invoice that was linked to an Export Freight Statement.

| | Biller | Credit- | Import | Export | | |
|---|---|---|---|---|---|---|
| | Dispute | Rebill | FS | FS | | |
| Seq | Response | Received | Received | Received | Possible Automatch Action | Comments |
| 1. | Reject | | | | MPR - Corrected Freight | As Biller has Rejected the |
| | | | | | Statement was not submitted | Dispute, Automatch was not |
| | | | | | in time | able to find a valid corrected |
| | | | | | | Import Freight Statement to |
| | | | | | | link the disputed Import |
| | | | | | | Invoice. |
| 2. | Reject | | Yes | | Automatch Executes - Links | Should dispute be raised, |
| | | | | | Previous Import Invoice to | refer to E.7 and E.8. |
| | | | | | Latest Import FS | |
| 3. | Reject | | | Yes | MPR - Corrected Freight | As Biller has Rejected the |
| | | | | | Statement was not submitted | Dispute, Automatch was not |
| | | | | | in time | able to find a valid corrected |
| | | | | | | Import Freight Statement to |
| | | | | | | link the disputed Import |
| | | | | | | Invoice. |
| 4. | Reject | | Yes | Yes | Automatch Executes - Links | Should dispute be raised, |
| | | | | | Previous Import Invoice to | refer to E.7 and E.8. |
| | | | | | Latest Import FS | |
| 5. | Reject | Yes | | | Automatch Executes - Links | Automatch assumes Biller |
| | | | | | Latest Import Invoice to | rejected by mistake. |
| | | | | | Previous Export FS | Should dispute be raised, |
| | | | | | | refer to E.5 and E.6. |
| 6. | Reject | Yes | Yes | | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 7. | Reject | Yes | | Yes | Automatch Executes - Links | Automatch assumes Biller |
| | | | | | Latest Import Invoice to | rejected by mistake and |
| | | | | | Latest Export FS | Payer had sent an updated |
| | | | | | | Export FS to correct both |
| | | | | | | Prepaid/Collect charges. |
| | | | | | | Should dispute be raised, |
| | | | | | | refer to E.5 and E.6. |
| 8. | Reject | Yes | Yes | Yes | Automatch | Automatch assumes both |
| | | | | | Executes - Links | Biller and Payer agreed on |
| | | | | | Latest Export | corrections for both sides. |
| | | | | | Invoice to Latest | Should dispute be raised, |
| | | | | | Export FS | refer to E.7 and E.8. |
| 9. | Accept | | | | MPR - Credit | As Biller has Accepted the |
| | | | | | Rebill to cancel | Dispute, Automatch was |
| | | | | | the disputed | not able to find a valid |
| | | | | | Invoice was not | corrected Import Invoice |
| | | | | | submitted in time | to link the previous Export |
| | | | | | | Freight Statement |
| 10. | Accept | | Yes | | Automatch | Automatch assumes Biller |
| | | | | | Executes - Links | accepted by mistake. |
| | | | | | Previous Import | Should dispute be raised, |
| | | | | | Invoice to Latest | refer to E.7 and E.8. |
| | | | | | Import FS | |
| 11. | Accept | | | Yes | MPR - Credit | As Biller has Accepted the |
| | | | | | Rebill to cancel | Dispute, Automatch was |
| | | | | | the disputed | not able to find a valid |
| | | | | | Invoice was not | corrected Import Invoice |
| | | | | | submitted in time | to link the previous Export |
| | | | | | | Freight Statement |
| 12. | Accept | | Yes | Yes | Automatch | Automatch assumes Biller |
| | | | | | Executes - Links | accepted by mistake. |
| | | | | | Previous Import | Should dispute be raised, |
| | | | | | Invoice to Latest | refer to E.7 and E.8. |
| | | | | | Import FS | |
| 13. | Accept | Yes | | | Automatch | Should dispute be raised, |
| | | | | | Executes - Links | refer to E.5 and E.6. |
| | | | | | Latest Import | |
| | | | | | Invoice to | |
| | | | | | Previous Export | |
| | | | | | FS | |
| 14. | Accept | Yes | Yes | | Automatch | Automatch assumes both |
| | | | | | Executes - Links | Biller and Payer agreed on |
| | | | | | Latest Import | corrections for both sides. |
| | | | | | Invoice to Latest | Should dispute be raised, |
| | | | | | Import FS | refer to E.7 and E.8. |
| 15. | Accept | Yes | | Yes | Automatch | Automatch assumes Payer |
| | | | | | Executes - Links | had sent an updated |
| | | | | | Latest Import | Export FS to correct both |
| | | | | | Invoice to Latest | Prepaid/Collect charges. |
| | | | | | Export FS | Should dispute be raised, |
| | | | | | | refer to E.5 and E.6. |
| 16. | Accept | Yes | Yes | Yes | Automatch | Automatch assumes both |
| | | | | | Executes - Links | Biller and Payer agreed on |
| | | | | | Latest Import | corrections for both sides. |
| | | | | | Invoice to Latest | Should dispute be raised, |
| | | | | | Import FS | refer to E.7 and E.8. |
| 17. | | | | | MPR - Biller has | |
| | | | | | not responded to | |
| | | | | | dispute generated | |
| | | | | | from Automatch | |
| 18. | | | Yes | | Automatch | Automatch assumes Payer |
| | | | | | Executes - Links | realizes own mistake. |
| | | | | | Previous Import | Should dispute be raised, |
| | | | | | Invoice to Latest | refer to E.7 and E.8. |
| | | | | | Import FS | |
| 19. | | | | Yes | MPR - Biller has | |
| | | | | | not responded to | |
| | | | | | dispute generated | |
| | | | | | from Automatch | |
| 20. | | | Yes | Yes | Automatch | Automatch assumes Payer |
| | | | | | Executes - Links | realizes own mistake. |
| | | | | | Previous Import | Should dispute be raised, |
| | | | | | Invoice to Latest | refer to E.7 and E.8. |
| | | | | | Import FS | |
| 21. | | Yes | | | Automatch | Automatch assumes Biller |
| | | | | | Executes - Links | forgot to send dispute |
| | | | | | Latest Import | acceptance. |
| | | | | | Invoice to | Should dispute be raised, |
| | | | | | Previous Export | refer to E.5 and E.6. |
| | | | | | FS | |
| 22. | | Yes | Yes | | Automatch | Automatch assumes both |
| | | | | | Executes - Links | Biller and Payer agreed on |
| | | | | | Latest Import | corrections for both sides. |
| | | | | | Invoice to Latest | Should dispute be raised, |
| | | | | | Import FS | refer to E.7 and E.8. |
| 23. | | Yes | | Yes | Automatch | Automatch assumes Biller |
| | | | | | Executes - Links | forgot to send dispute |
| | | | | | Latest Import | acceptance and Payer had |
| | | | | | Invoice to Latest | sent an updated Export FS |
| | | | | | Export FS | to correct both Prepaid/ |
| | | | | | | Collect charges. |
| | | | | | | Should dispute be raised, |
| | | | | | | refer to E.5 and E.6. |
| 24. | | Yes | Yes | Yes | Automatch | Automatch assumes both |
| | | | | | Executes - Links | Biller and Payer agreed on |
| | | | | | Latest Import | corrections for both sides. |
| | | | | | Invoice to Latest | Should dispute be raised, |
| | | | | | Import FS | refer to E.7 and E.8. |

Note: Upon elapsing of Dispute Resolution Period, Automatch will only execute if an updated document (Invoice or Freight Statement) was received regardless of the Dispute Response.

### E.7 Dispute Resolution Check Time Interval—Import Invoice (Linked to Import FS)

This section explains the various scenarios when Automatch can potentially execute during a Dispute Resolution Check Time Interval. The Dispute Resolution Period was started by a Dispute raised for an Import Invoice that was linked to an Import Freight Statement.

| | Biller | Credit- | Import | Export | | |
|---|---|---|---|---|---|---|
| | Dispute | Rebill | FS | FS | | |
| Seq | Response | Received | Received | Received | Possible Automatch Action | Comments |
| 1. | | | | | Wait for next Check Time | |
| | | | | | Interval or Period Elapsed | |
| 2. | Reject | | | | Wait for next Check Time | |
| | | | | | Interval or Period Elapsed | |
| 3. | Reject | | Yes | | Automatch Executes - Links | Should dispute be raised, |
| | | | | | Previous Import Invoice to | refer to E.7 and E.8. |
| | | | | | Latest Import FS | |
| 4. | Reject | | | Yes | Wait for next Check Time | |
| | | | | | Interval or Period Elapsed | |
| 5. | Reject | | Yes | Yes | Automatch Executes - Links | Once Import Invoice has |
| | | | | | Previous Import Invoice to | been linked to Import Freight |
| | | | | | Latest Import FS | Statement, it will never be |
| | | | | | | linked to Export Freight |
| | | | | | | Statement. |
| | | | | | | Should dispute be raised, |
| | | | | | | refer to E.7 and E.8. |
| 6. | Reject | Yes | | | Wait for next Check Time | |
| | | | | | Interval or Period Elapsed | |
| 7. | Reject | Yes | Yes | | Automatch Executes - Links | Should dispute be raised, |
| | | | | | Latest Import Invoice to | refer to E.7 and E.8. |
| | | | | | Latest Import FS | |
| 8. | Reject | Yes | | Yes | Wait for next Check Time | |
| | | | | | Interval or Period Elapsed | |
| 9. | Reject | Yes | Yes | Yes | Automatch Executes - Links | Once Import Invoice has |
| | | | | | Latest Import Invoice to | been linked to Import Freight |
| | | | | | Latest Import FS | Statement, it will never be |
| | | | | | | linked to Export Freight |
| | | | | | | Statement. |
| | | | | | | Should dispute be raised, |
| | | | | | | refer to E.7 and |
| | | | | | | E.8. |
| 10. | Accept | | | | Wait for next Check Time | |
| | | | | | Interval or Period Elapsed | |
| 11. | Accept | | Yes | | Wait for next Check Time | |
| | | | | | Interval or Period Elapsed | |
| 12. | Accept | | | Yes | Wait for next Check Time | |
| | | | | | Interval or Period Elapsed | |
| 13. | Accept | | Yes | Yes | Wait for next Check Time | |
| | | | | | Interval or Period Elapsed | |
| 14. | Accept | Yes | | | Automatch Executes - Links | Should dispute be raised, |
| | | | | | Latest Import Invoice to | refer to E.7 and E.8. |
| | | | | | Previous Import FS | |
| 15. | Accept | Yes | Yes | | Automatch Executes - Links | Should dispute be raised, |
| | | | | | Latest Import Invoice to | refer to E.7 and E.8. |
| | | | | | Latest Import FS | |
| 16. | Accept | Yes | | Yes | Automatch Executes - Links | Once Import Invoice has |
| | | | | | Latest Import Invoice to | been linked to Import Freight |
| | | | | | Previous Import FS | Statement, it will never be |
| | | | | | | linked to Export Freight |
| | | | | | | Statement. |
| | | | | | | Should dispute be raised, |
| | | | | | | refer to E.7 and E.8. |
| 17. | Accept | Yes | Yes | Yes | Automatch Executes - Links | Once Import Invoice has |
| | | | | | Latest Import Invoice to | been linked to Import Freight |
| | | | | | Latest Import FS | Statement, it will never be |
| | | | | | | linked to Export Freight |
| | | | | | | Statement. |
| | | | | | | Should dispute be raised, |
| | | | | | | refer to E.7 and E.8. |

Note: During Dispute Resolution Check Time Interval, Automatch will only execute if a Dispute Response was received and a corresponding updated document (Invoice or Freight Statement) was received as an action to the Dispute Response.

### E.8 Dispute Resolution Period Elapsed—Import Invoice (Linked to Import FS)

This section explains the various scenarios when Automatch executes upon elapsing of a Dispute Resolution Period that was started as a result of a Dispute being raised for an Import Invoice that was linked to an Import Freight Statement.

| | Biller | Credit- | Import | Export | | |
|---|---|---|---|---|---|---|
| | Dispute | Rebill | FS | FS | | |
| Seq | Response | Received | Received | Received | Possible Automatch Action | Comments |
| 1. | Reject | | | | MPR - Corrected Freight | As Biller has Rejected the |
| | | | | | Statement was not submitted | Dispute, Automatch was not |
| | | | | | in time | able to find a valid corrected |
| | | | | | | Import Freight Statement to |
| | | | | | | link the disputed Import |
| | | | | | | Invoice. |
| 2. | Reject | | Yes | | Automatch Executes - Links | Should dispute be raised, |
| | | | | | Previous Import Invoice to | refer to E.7 and E.8. |
| | | | | | Latest Import FS | |
| 3. | Reject | | | Yes | MPR - Corrected Freight | As Biller has Rejected the |
| | | | | | Statement was not submitted | Dispute, Automatch was not |
| | | | | | in time | able to find a valid corrected |
| | | | | | | Import Freight Statement to |
| | | | | | | link the disputed Import |
| | | | | | | Invoice. |
| 4. | Reject | | Yes | Yes | Automatch Executes - Links | Once Import Invoice has |
| | | | | | Previous Import Invoice to | been linked to Import Freight |
| | | | | | Latest Import FS | Statement, it will never be |
| | | | | | | linked to Export Freight |
| | | | | | | Statement. |
| | | | | | | Should dispute be raised, |
| | | | | | | refer to E.7 and E.8. |
| 5. | Reject | Yes | | | Automatch Executes - Links | Automatch assumes Biller |
| | | | | | Latest Import Invoice to | rejected by mistake. |
| | | | | | Previous Import FS | Should dispute be raised, |
| | | | | | | refer to E.7 and E.8. |
| 6. | Reject | Yes | Yes | | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 7. | Reject | Yes | | Yes | Automatch Executes - Links | Automatch assumes Biller |
| | | | | | Latest Import Invoice to | rejected by mistake. In |
| | | | | | Previous Import FS | addition, once Import Invoice |
| | | | | | | has been linked to Import |
| | | | | | | Freight Statement, it will |
| | | | | | | never be linked to Export |
| | | | | | | Freight Statement. |
| | | | | | | Should dispute be raised, |
| | | | | | | refer to E.7 and E.8. |
| 8. | Reject | Yes | Yes | Yes | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 9. | Accept | | | | MPR - Credit Rebill to | As Biller has Accepted the |
| | | | | | cancel the disputed | Dispute, Automatch was not |
| | | | | | Invoice was not submitted in | able to find a valid corrected |
| | | | | | time | Import Invoice to link the |
| | | | | | | previous Import Freight |
| | | | | | | Statement |
| 10. | Accept | | Yes | | Automatch Executes - Links | Automatch assumes Biller |
| | | | | | Previous Import Invoice to | accepted by mistake. |
| | | | | | Latest Import FS | Should dispute be raised, |
| | | | | | | refer to E.7 and E.8. |
| 11. | Accept | | | Yes | MPR - Credit Rebill to | As Biller has Accepted the |
| | | | | | cancel the disputed | Dispute, Automatch was not |
| | | | | | Invoice was not submitted in | able to find a valid corrected |
| | | | | | time | Import Invoice to link the |
| | | | | | | previous Import Freight |
| | | | | | | Statement |
| 12. | Accept | | Yes | Yes | Automatch Executes - Links | Automatch assumes Biller |
| | | | | | Previous Import Invoice to | accepted by mistake. |
| | | | | | Latest Import FS | Should dispute be raised, |
| | | | | | | refer to E.7 and E.8. |
| 13. | Accept | Yes | | | Automatch Executes - Links | Should dispute be raised, |
| | | | | | Latest Import Invoice to | refer to E.7 and E.8. |
| | | | | | Previous Import FS | |
| 14. | Accept | Yes | Yes | | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 15. | Accept | Yes | | Yes | Automatch Executes - Links | Once Import Invoice has |
| | | | | | Latest Import Invoice to | been linked to Import Freight |
| | | | | | Previous Import FS | Statement, it will never be |
| | | | | | | linked to Export Freight |
| | | | | | | Statement. |
| | | | | | | Should dispute be raised, |
| | | | | | | refer to E.7 and E.8. |
| 16. | Accept | Yes | Yes | Yes | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 17. | | | | | MPR - Biller has not | |
| | | | | | responded to dispute | |
| | | | | | generated from Automatch | |
| 18. | | | Yes | | Automatch Executes - Links | Automatch assumes Payer |
| | | | | | Previous Import Invoice to | realizes own mistake. |
| | | | | | Latest Import FS | Should dispute be raised, |
| | | | | | | refer to E.7 and E.8. |
| 19. | | | | Yes | MPR - Biller has not | |
| | | | | | responded to dispute | |
| | | | | | generated from Automatch | |
| 20. | | | Yes | Yes | Automatch Executes - Links | Automatch assumes Payer |
| | | | | | Previous Import Invoice to | realizes own mistake. |
| | | | | | Latest Import FS | Should dispute be raised, |
| | | | | | | refer to E.7 and E.8. |
| 21. | | Yes | | | Automatch Executes - Links | Automatch assumes Biller |
| | | | | | Latest Import Invoice to | forgot to send dispute |
| | | | | | Previous Import FS | acceptance. |
| | | | | | | Should dispute be raised, |
| | | | | | | refer to E.7 and E.8. |
| 22. | | Yes | Yes | | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |
| 23. | | Yes | | Yes | Automatch Executes - Links | Automatch assumes Biller |
| | | | | | Latest Import Invoice to | forgot to send dispute |
| | | | | | Previous Import FS | acceptance. In addition, once |
| | | | | | | Import Invoice has been |
| | | | | | | linked to Import Freight |
| | | | | | | Statement, it will never be |
| | | | | | | linked to Export Freight |
| | | | | | | Statement. |
| | | | | | | Should dispute be raised, |
| | | | | | | refer to E.7 and E.8. |
| 24. | | Yes | Yes | Yes | Automatch Executes - Links | Automatch assumes both |
| | | | | | Latest Import Invoice to | Biller and Payer agreed on |
| | | | | | Latest Import FS | corrections for both sides. |
| | | | | | | Should dispute be raised, |
| | | | | | | refer to E.7 and E.8. |

Note: Upon elapsing of Dispute Resolution Period, Automatch will only execute if an updated document (Invoice or Freight Statement) was received regardless of the Dispute Response.

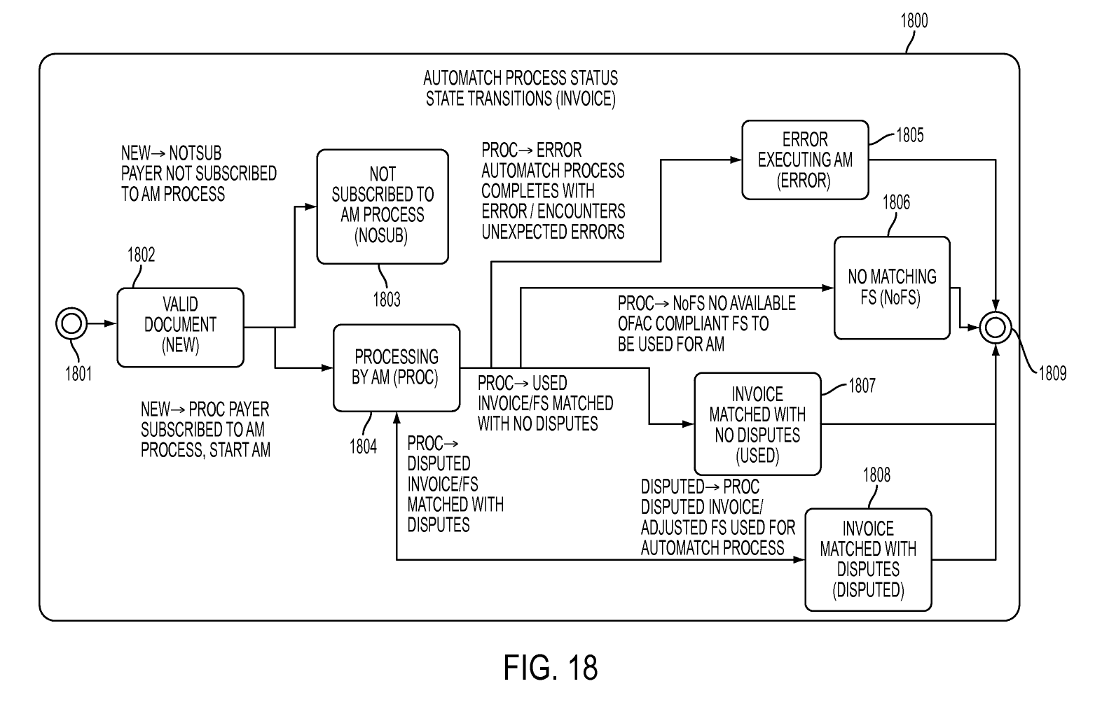

The following relates to FIGS. 18-44.

FIG. 18 shows a state diagram for the automatching process.

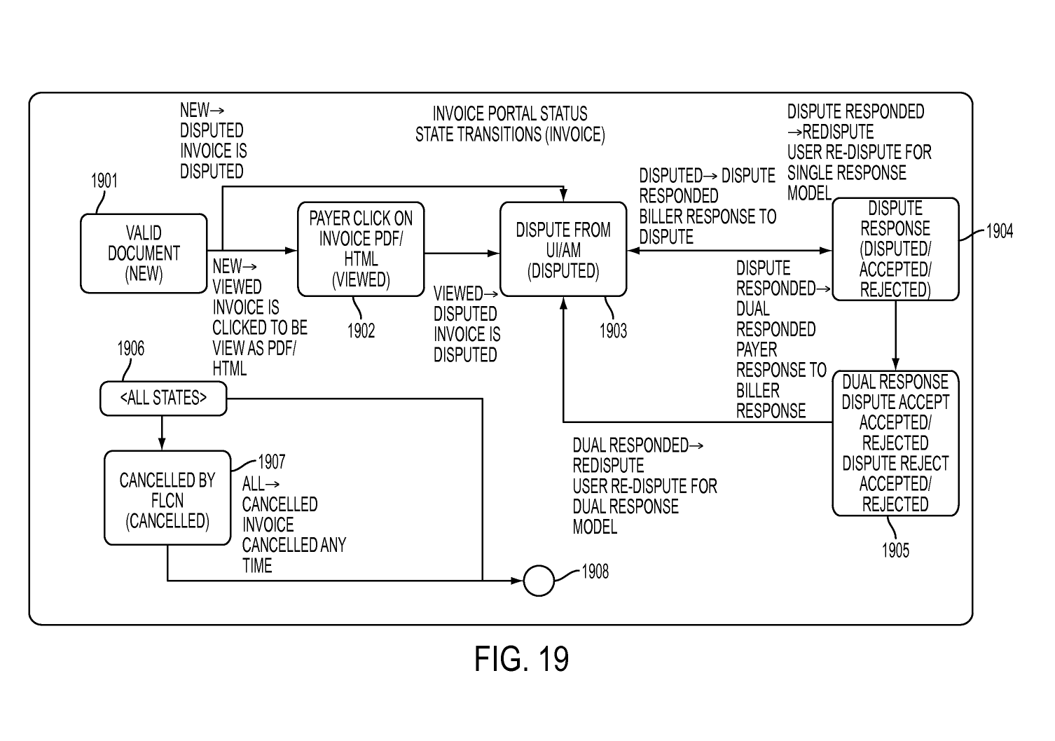

FIG. 19 shows a state diagram for the handling of invoices in an invoice matching portal.

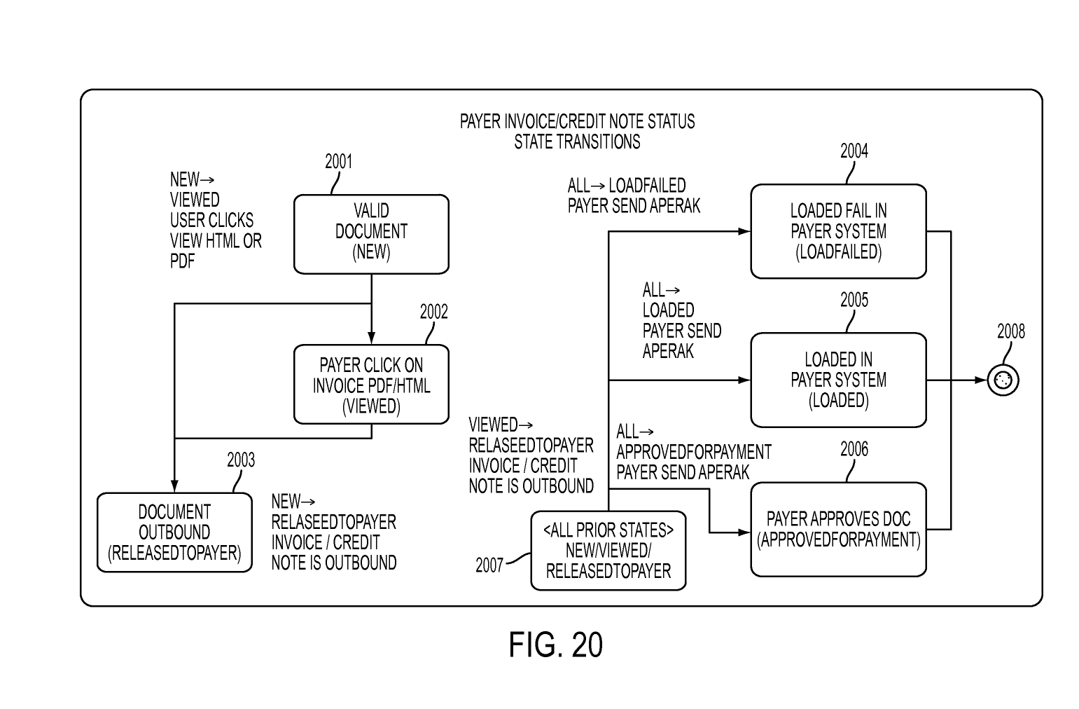

FIG. 20 shows a state diagram for payer invoice/credit note processing.

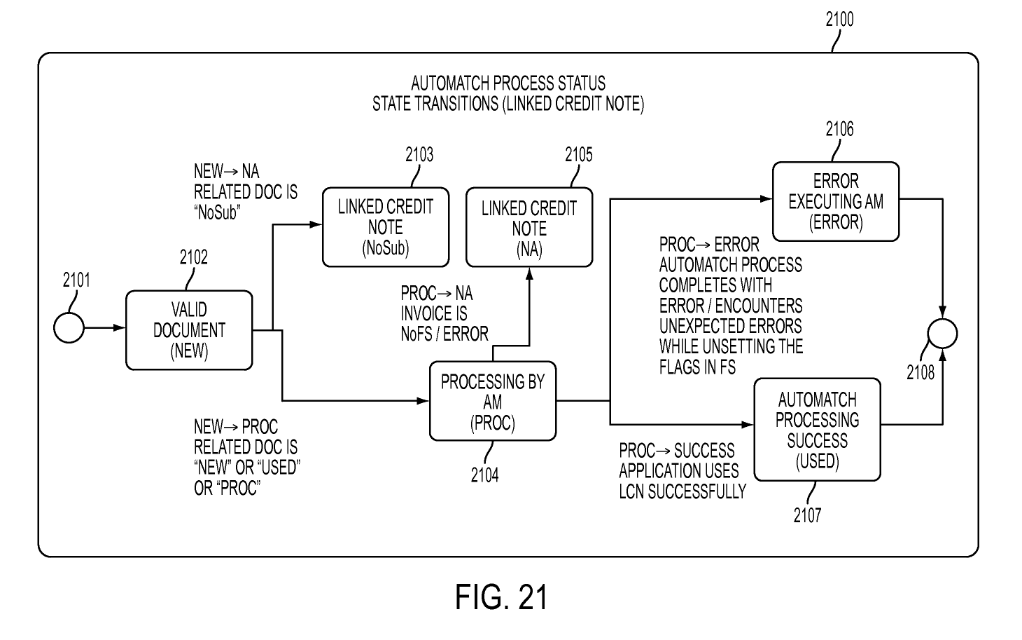

FIG. 21 shows a state diagram for the automatching process with linked credit notes.

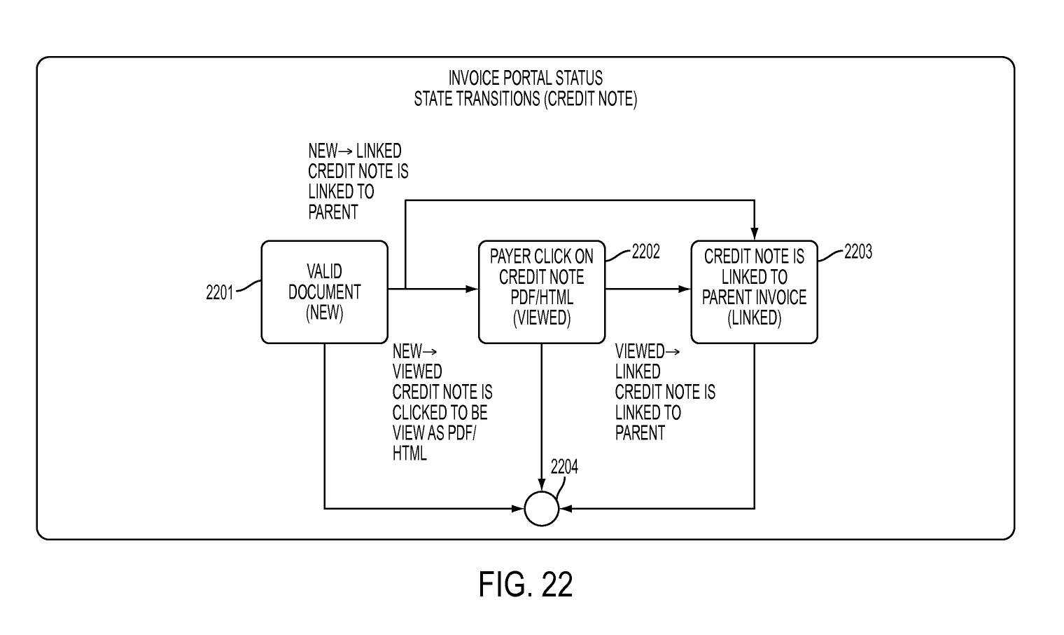

FIG. 22 shows a state diagram for an invoice portal.

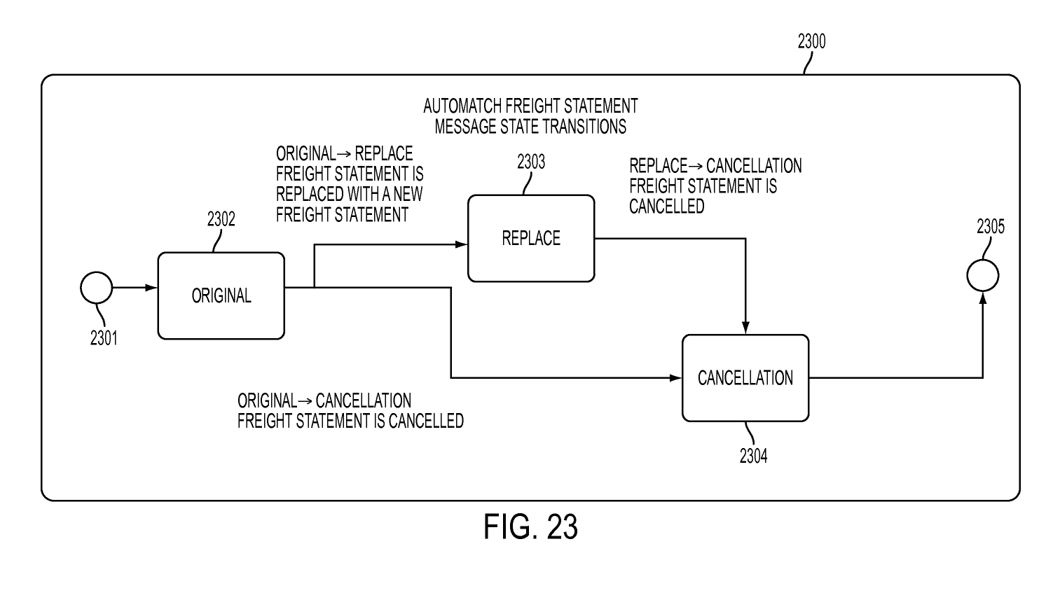

FIG. 23 shows a message state diagram for the automatch process for freight statements.

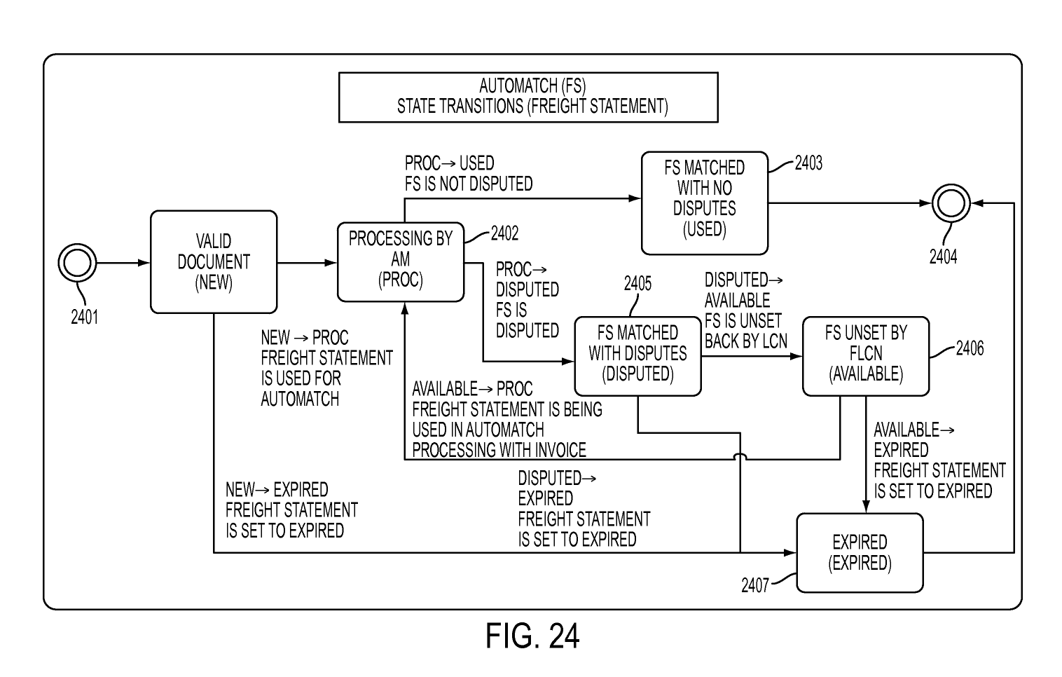

FIG. 24 shows a state diagram for the automatch process for freight statements.

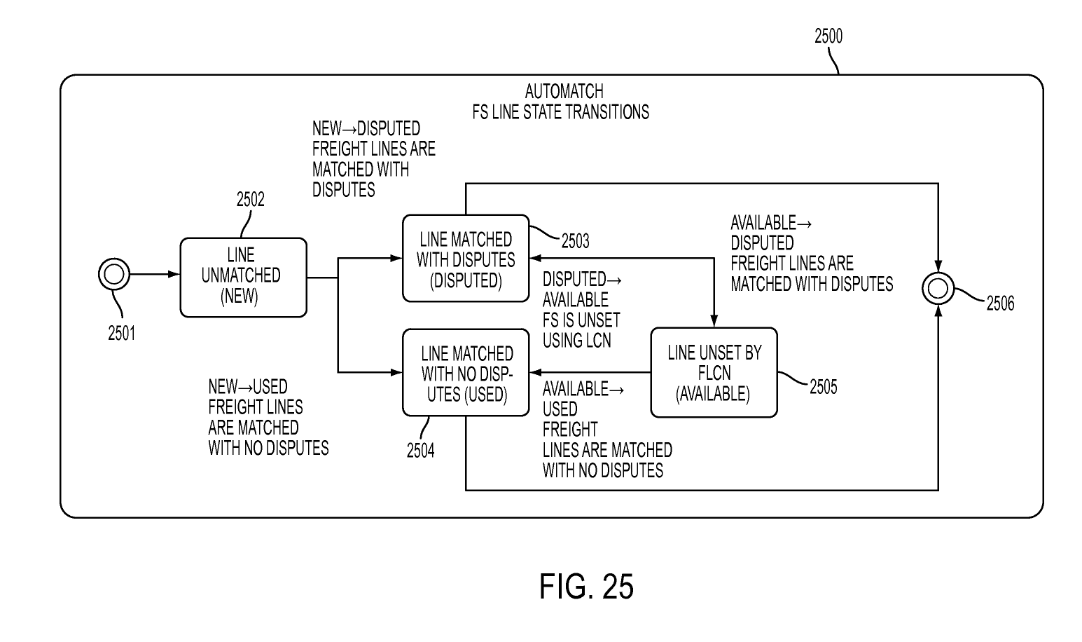

FIG. 25 shows a state diagram for the automatch process for freight statement line transitions.

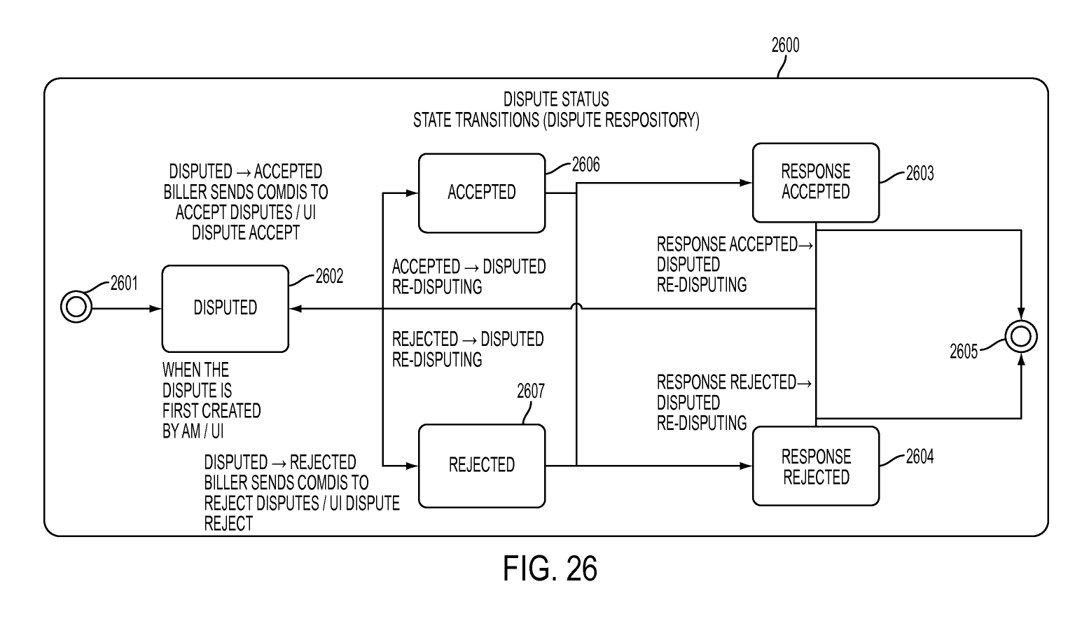

FIG. 26 shows a state diagram for dispute status state transitions.

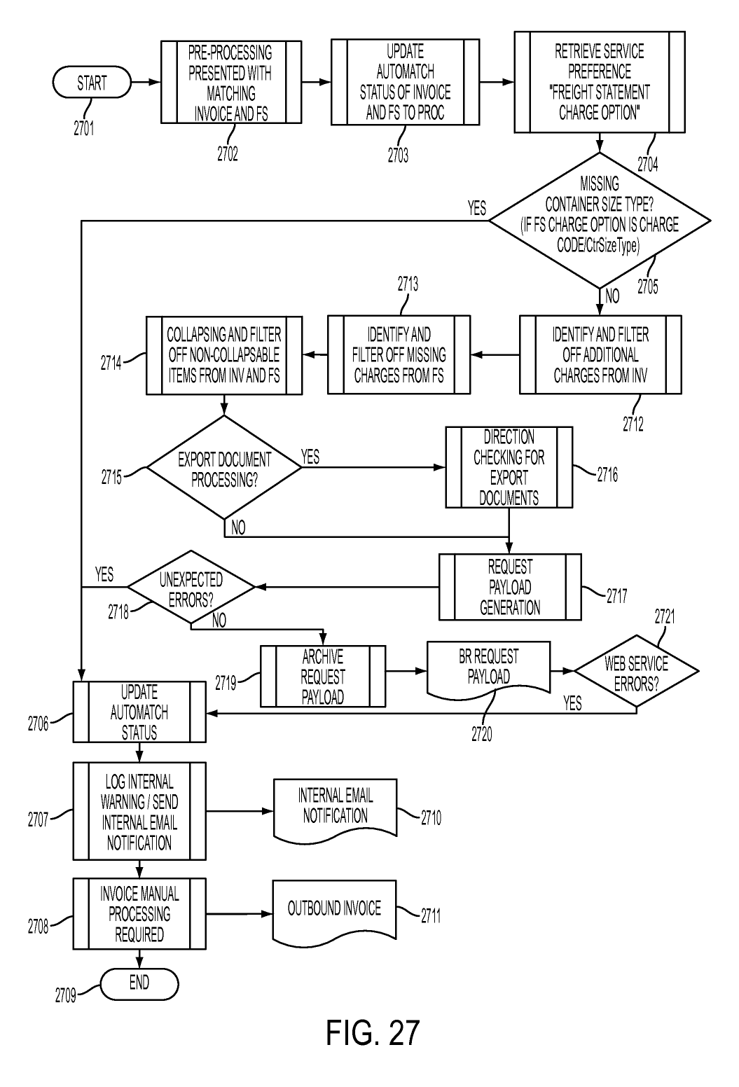

FIG. 27 shows a process for initial processing of invoices and freight statements.

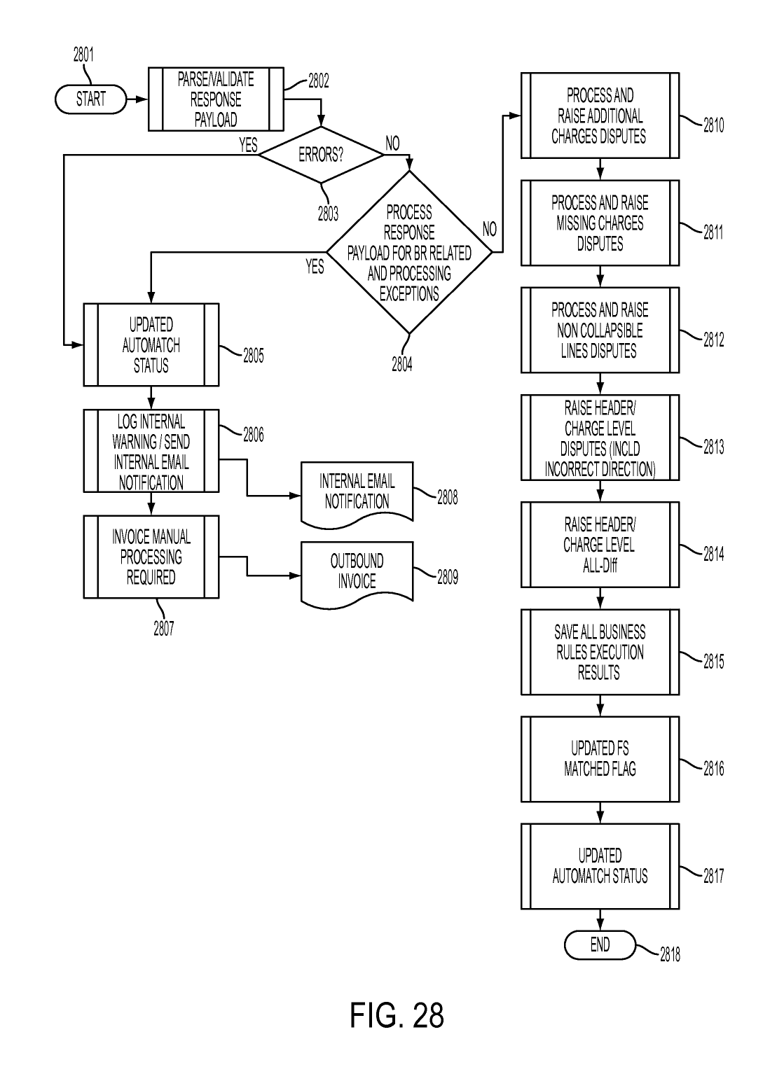

FIG. 28 shows a process for handling business rules and saving execution results.

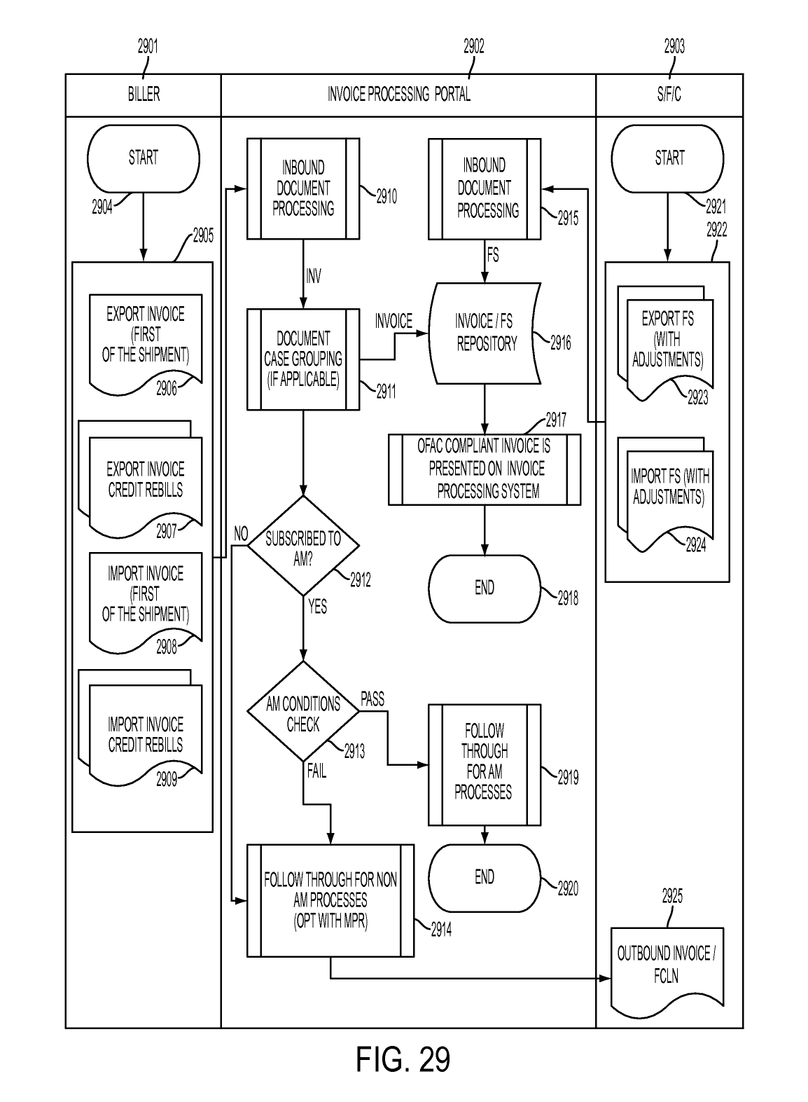

FIG. 29 shows a process for receiving and processing invoices and other documents.

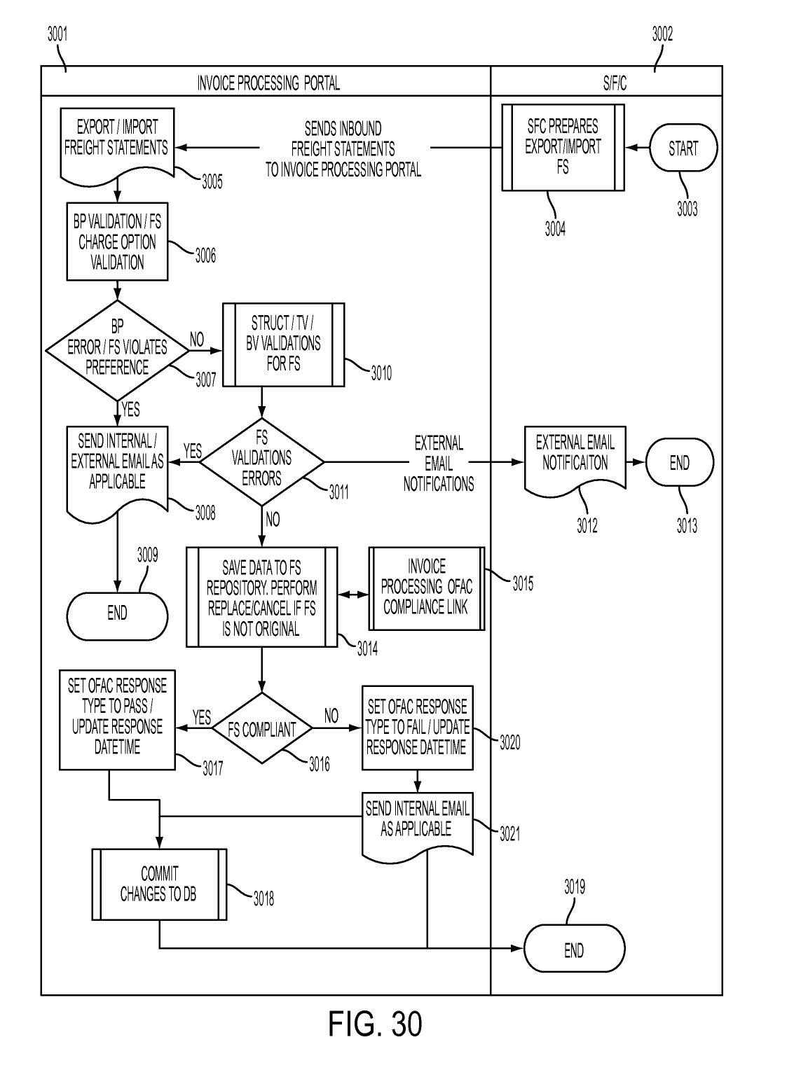

FIG. 30 shows a process for handling freight statements.

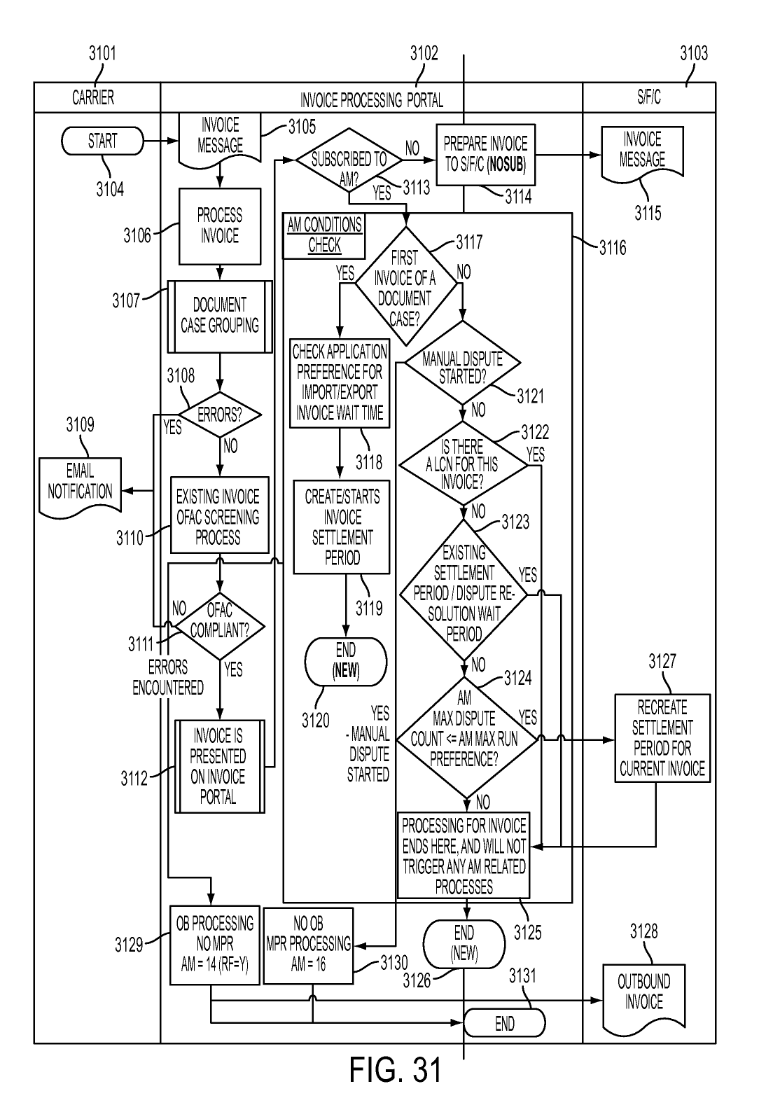

FIG. 31 shows a process for checking and presenting invoices on the invoice portal.

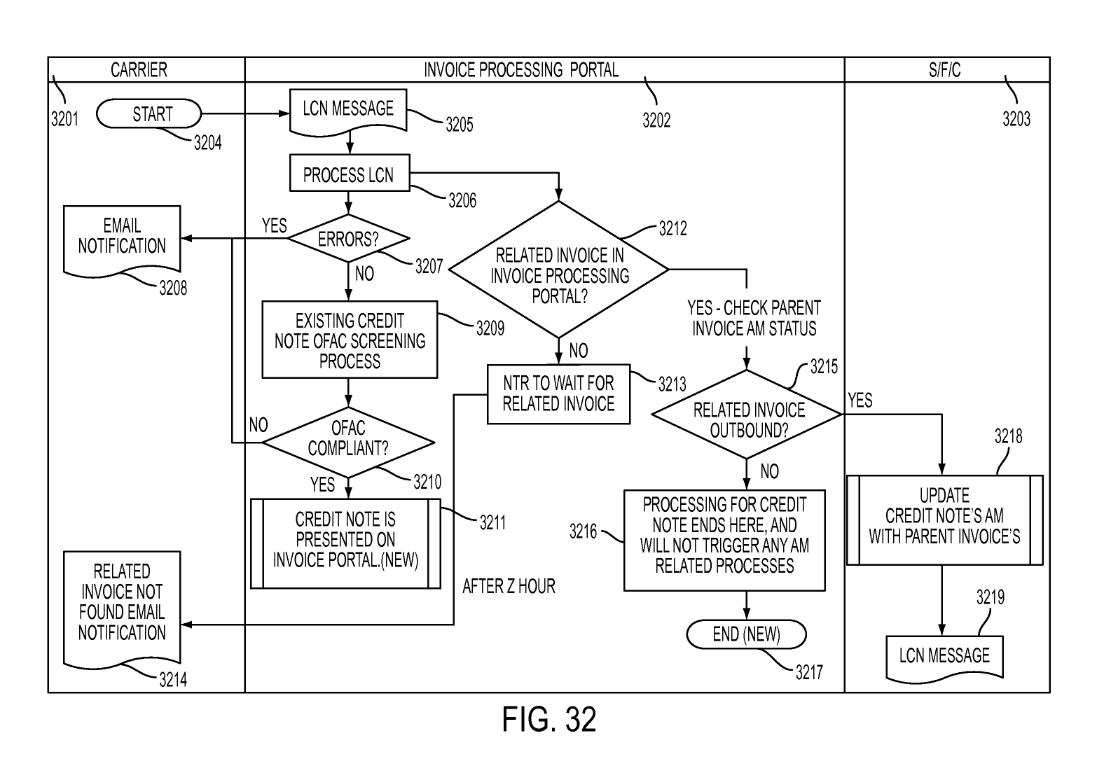

FIG. 32 shows a process for handling duplicate invoices.

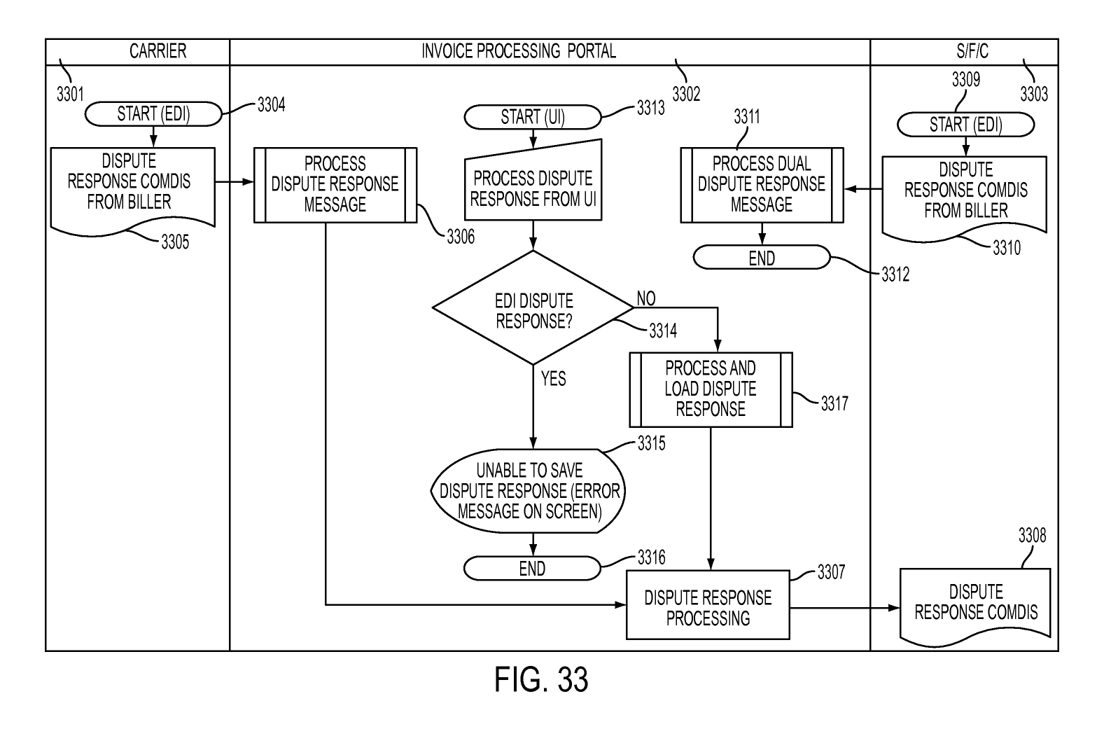

FIG. 33 shows a process for handling disputes.

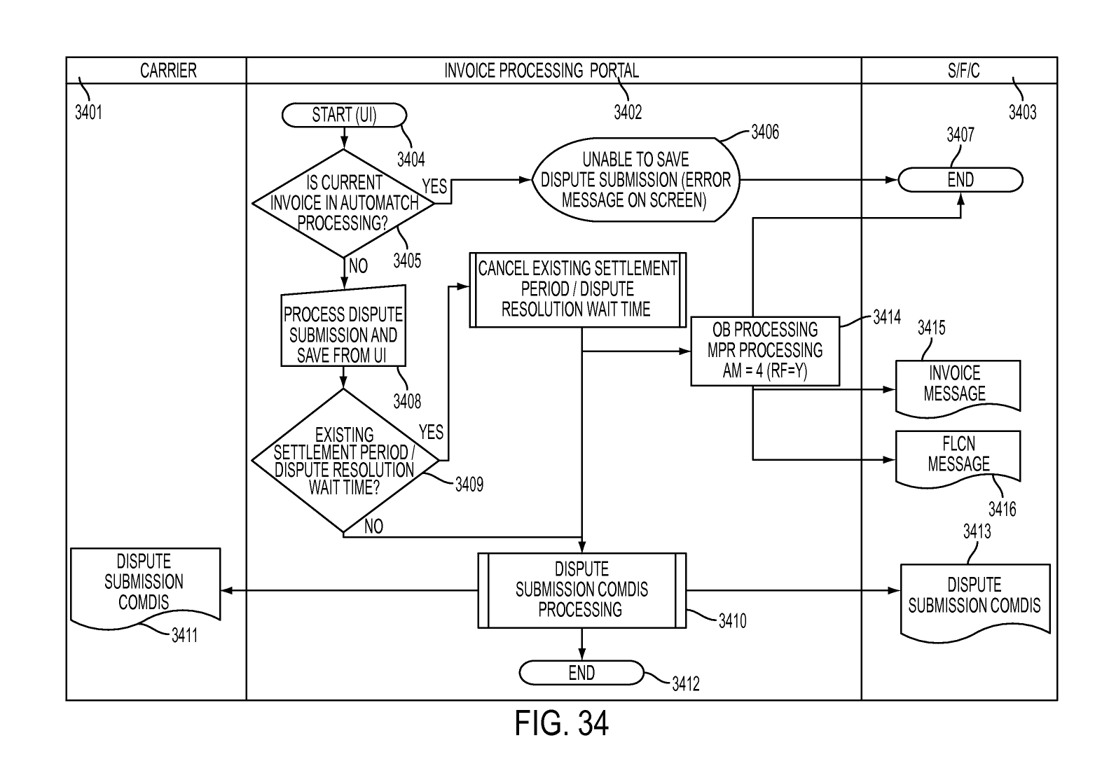

FIG. 34 shows an additional process for handling disputes.

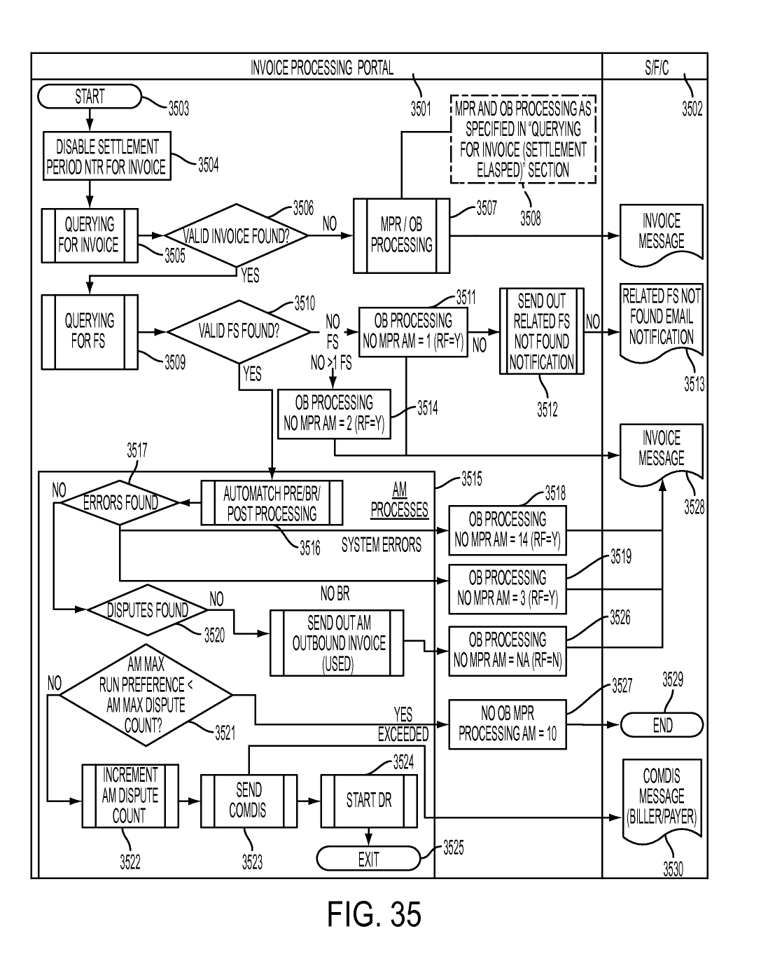

FIG. 35 shows a process for matching invoices and freight statements.

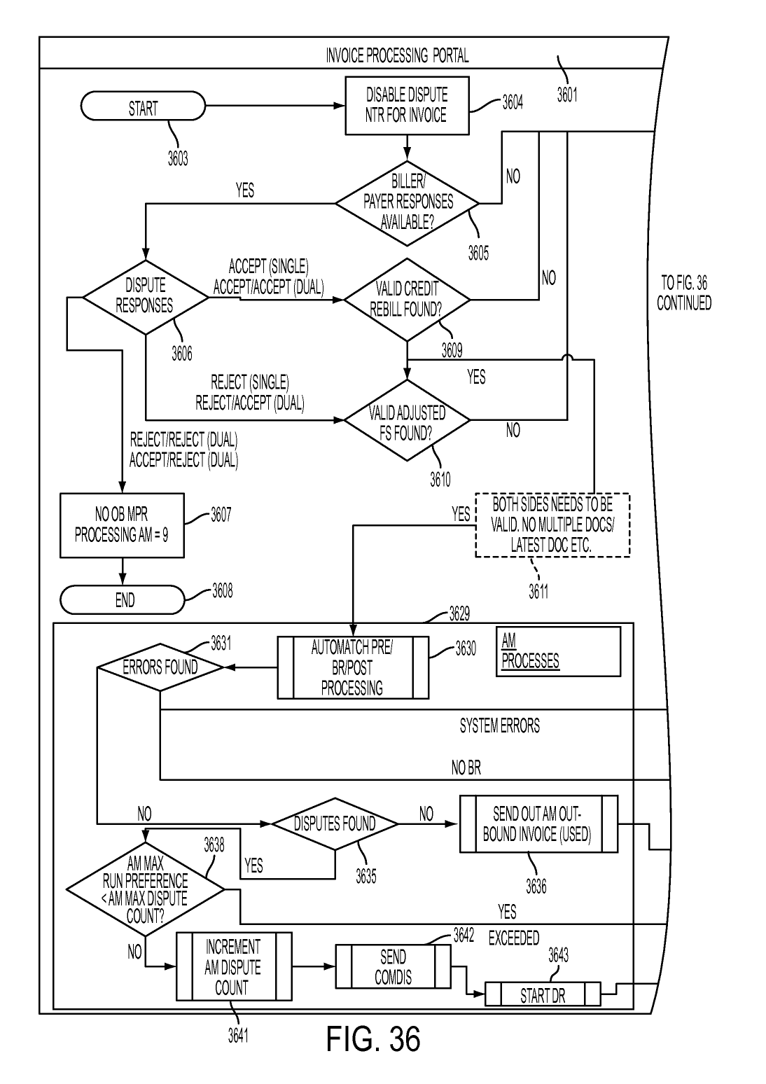

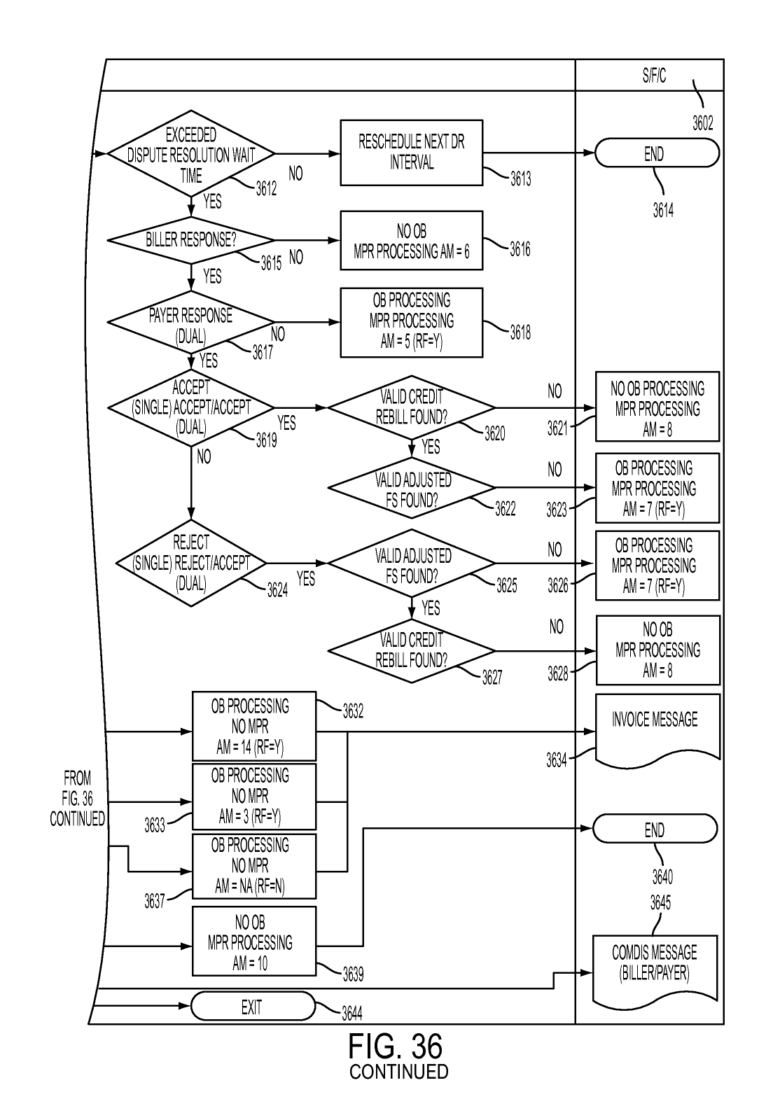

FIG. 36 shows a process for managing dispute responses.

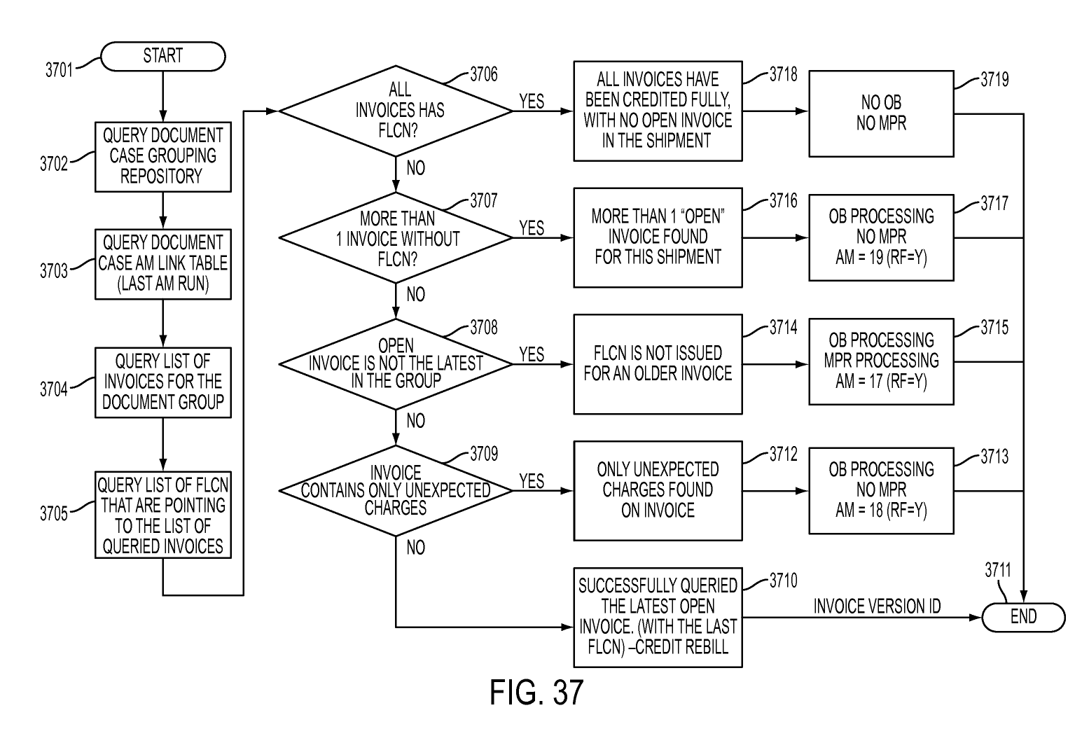

FIG. 37 shows a process for addressing remaining issues on invoices.

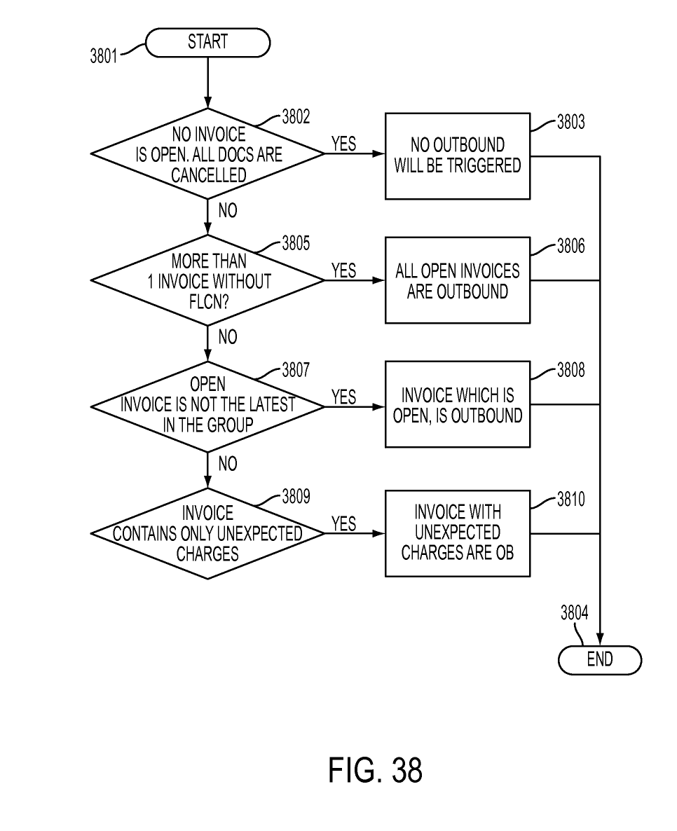

FIG. 38 shows another process for addressing remaining issues on invoices.

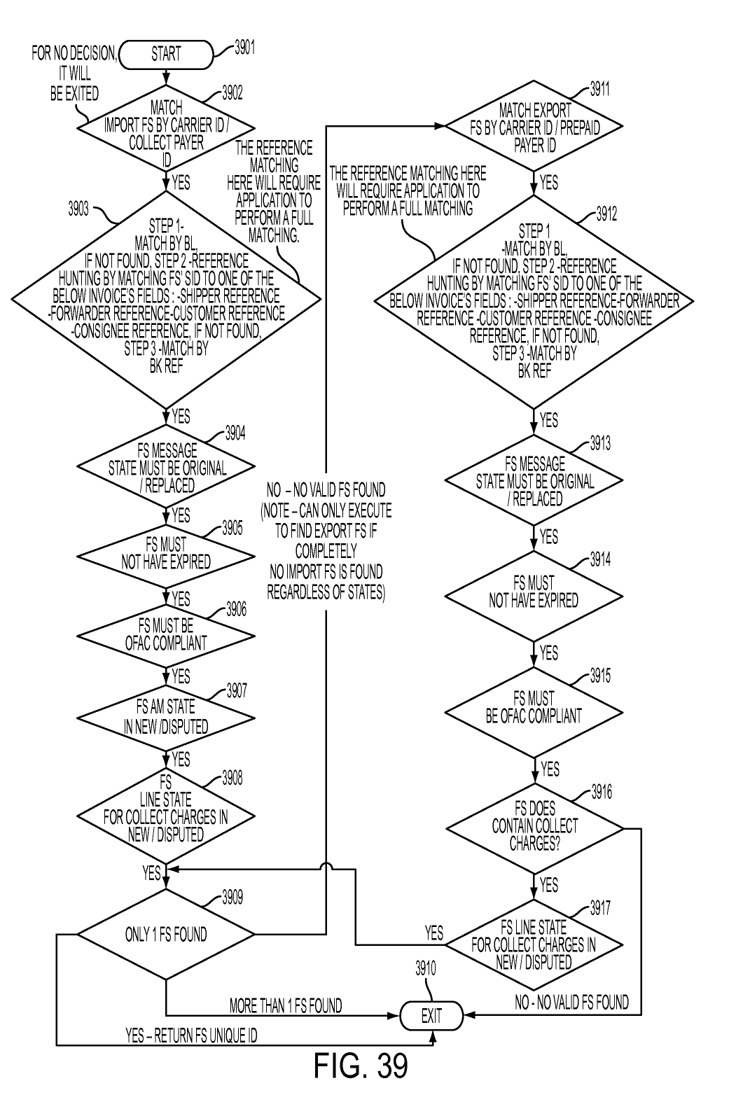

FIG. 39 shows another process for processing a freight statement.

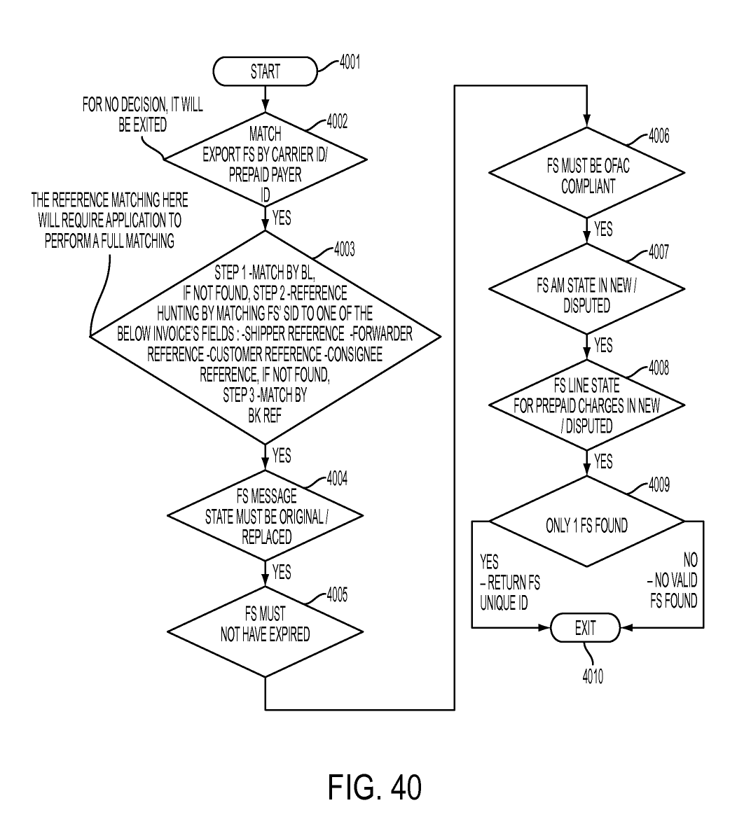

FIG. 40 shows a process for matching an export freight statement.

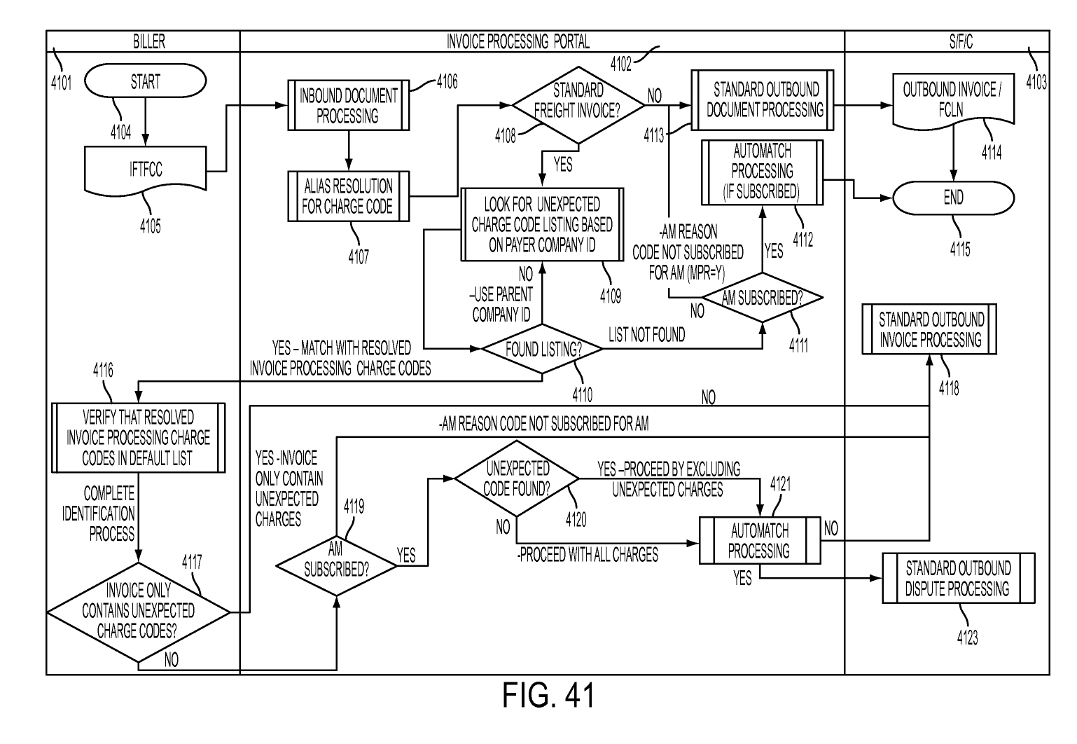

FIG. 41 shows a process relating to processing of invoices and credit statements.

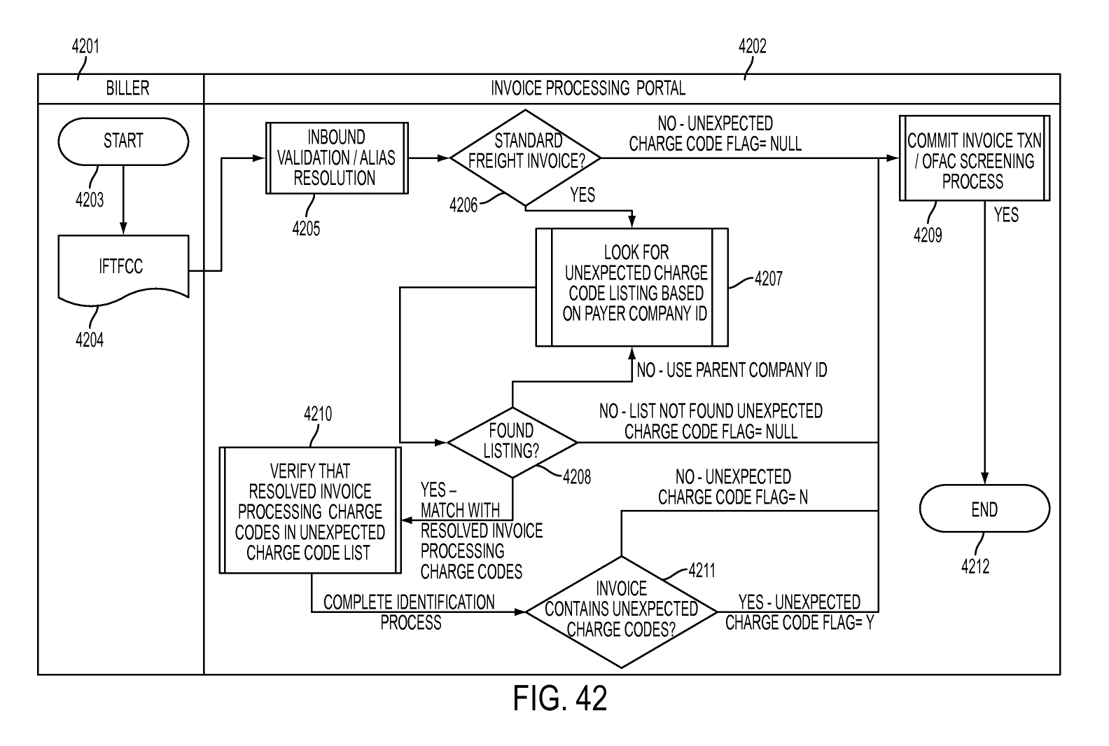

FIG. 42 shows another process relating to processing of invoices and credit statements.

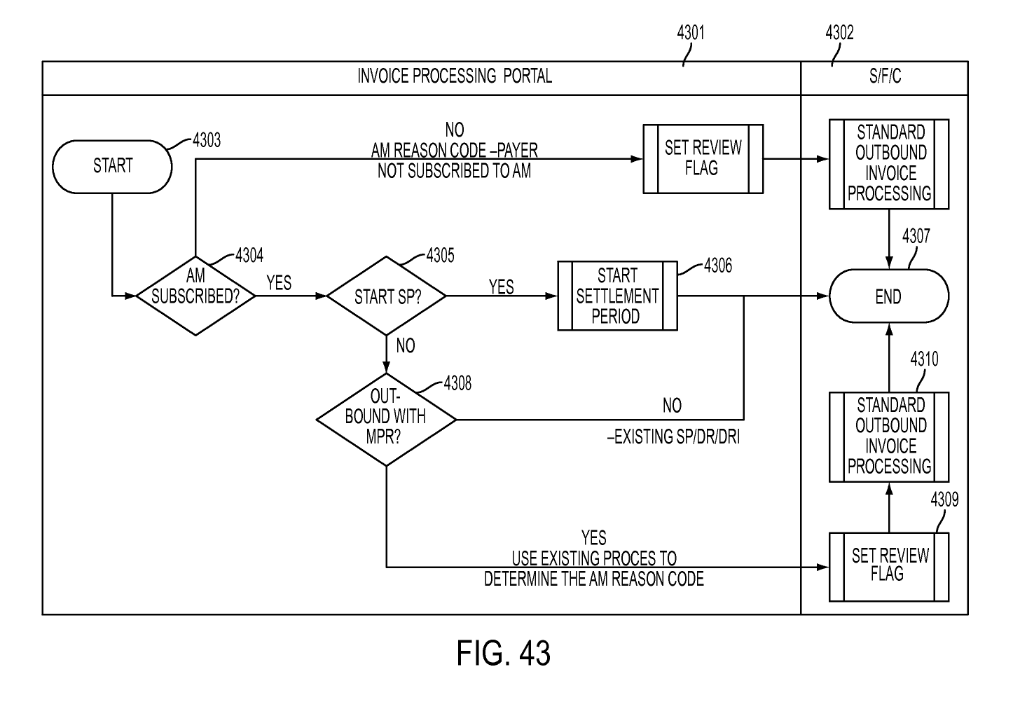

FIG. 43 shows a process relating to automatching.

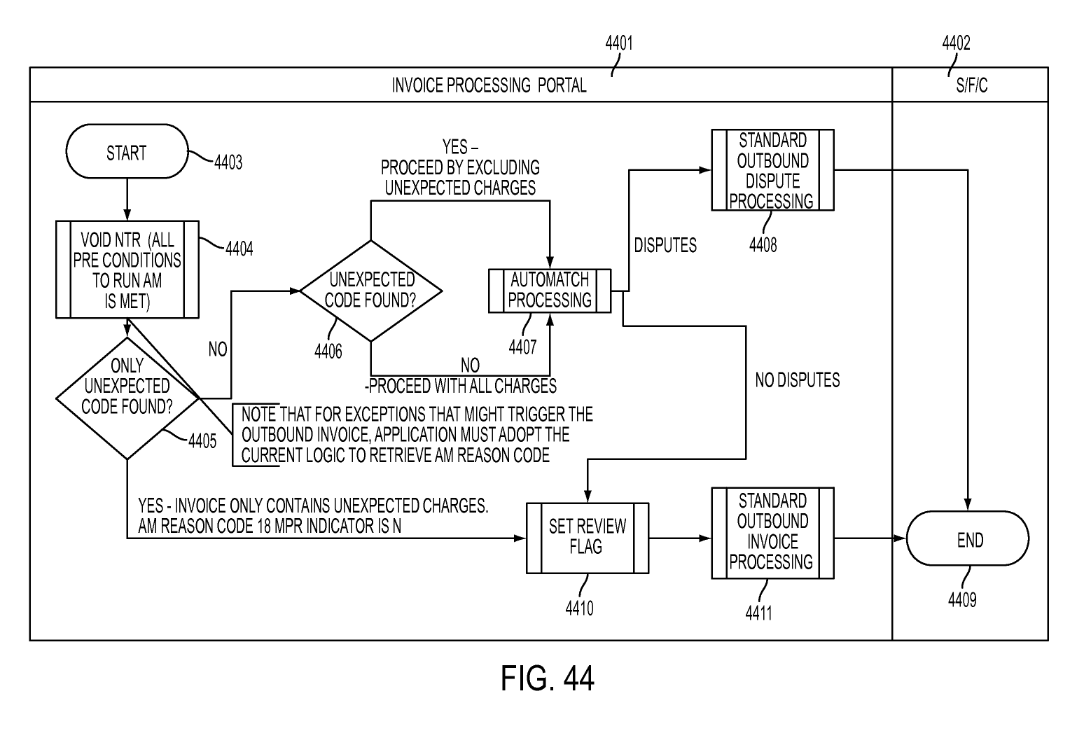

FIG. 44 shows a process relating to automatching invoices and freight statements.

While the present invention has been described with reference to preferred and exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention include all embodiments falling within the scope of the appended claims.

1. A method of a dispute resolution processing using electronic data exchange, comprising:
linking an electronic invoice to an electronic freight statement;
comparing the invoice to the freight statement;
determining a dispute of the values associated with the invoice to the values associated with the freight statement;
transmitting an EDI dispute message; and
receiving an EDI dispute response message.

2. The method according to claim 1, further comprising a step of requiring an exact match otherwise sending a dispute message.

3. The method according to claim 1, wherein the dispute is only triggered if outside a tolerance range.

4. A system comprising:
an invoice portal receiving an invoice from a biller and a freight statement from a payer;
an invoice handling system configured to:
link the invoice to the electronic freight statement;
an automatching system configured to compare the invoice to the freight statement and determine a dispute of the values associated with the invoice to the values associated with the freight statement;
wherein the invoice portal transmits a dispute message to both the biller and the payer if when a dispute is found.
